(19) United States
(12) Patent Application Publication
(10) Pub. No.: US 2026/0269527 A1
(43) Pub. Date: Sep. 10, 2026

(54) Pin rotation structure for power converter and the power converter

(71) Applicant: GUANGDONG WORLDPLUG TECHNOLOGY CO.,LTD, Huizhou City (CN)

(72) Inventor: Guangli Zeng, Huizhou City (CN)

(21) Appl. No.: 19/328,665

(22) Filed: Sep. 15, 2025

(30) Foreign Application Priority Data
Mar. 7, 2025 (CN) 202520401346.6
Mar. 27, 2025 (CN) 202510370350.5
Aug. 28, 2025 (CN) 202511218660.1

(51) Int. Cl. H01R 13/631; H01R 13/04; H01R 13/10; H01R 13/35; H01R 13/502; H01R 13/66; H01R 31/06

(52) U.S. Cl. CPC H01R 13/6315; H01R 13/04; H01R 13/10; H01R 13/35; H01R 13/502; H01R 13/6675; H01R 31/065

(57) ABSTRACT

A pin rotation structure for a power converter, including an upper cap, a lower cap covered to the upper cap, a support disposed between the upper cap and the lower cap, and a plug assembly rotatably disposed on the lower cap, wherein the plug assembly includes a rotary base rotatably disposed on the lower cap, and a plug body disposed on the rotary base; at least one feel limit portion is formed on the rotary base; a rotation avoidance hole for placing the rotary base in rotation is disposed on the lower cap; wherein the pin rotation structure further includes a feel limit mechanism disposed on the support; and the feel limit mechanism and the at least one feel limit portion interfere with each other and are matched with each other when the rotary base rotates.

### CROSS-REFERENCE TO RELATED APPLICATIONS

This application claims priority benefits to Chinese Patent Application No. 202510370350.5, filed on Mar. 27, 2025, Chinese Patent Application No. 202511218660.1, filed on Aug. 28, 2025, and Chinese Patent Application No. 202520401346.6, filed on Mar. 7, 2025. The contents of Chinese Patent Application No. 202510370350.5, Chinese Patent Application No. 202511218660.1, and Chinese Patent Application No. 202520401346.6 are incorporated herein by reference.

### TECHNICAL FIELD

The present invention relates to the technical field of power converters, and more particularly, to a pin rotation structure for a power converter and the power converter.

### BACKGROUND ART

At present, the target converted standard pins are generally fixed on the shell in the common power converters in the market. When the power socket is disposed in a relatively narrow place, the power converter with fixed pins cannot be inserted into the power socket in a narrow place because of the problem of its own size, or cover most of the power socket because the power converter is too large, so that other electrical appliances cannot be simultaneously inserted into the power socket for use, which is not conducive to people's travel and reduces people's experience of use.

### SUMMARY OF THE INVENTION

In view of the above-mentioned deficiencies, it is an object of the present invention to provide a pin rotation structure for a power converter and the power converter. A standard pin of the power converter can be rotated on the power converter by the pin rotation structure for the power converter, so that the power converter can be applied to power sockets at different positions without excessively obstructing other outlets of the power socket, so as to improve the practicability of the power converter, facilitate people's travel and effectively improve people's use experience.

The technical solution adopted by the present invention to achieve the above-mentioned object is as follows.

A pin rotation structure for a power converter includes an upper cap, a lower cap covered to the upper cap, and a support disposed between the upper cap and the lower cap. The pin rotation structure further includes a plug assembly rotatably disposed on the lower cap, wherein the plug assembly includes a rotary base rotatably disposed on the lower cap, and a plug body disposed on the rotary base; at least one feel limit portion is formed on the rotary base; a rotation avoidance hole for placing the rotary base in rotation is disposed on the lower cap; wherein the pin rotation structure further includes a feel limit mechanism disposed on the support or the lower cap or the upper cap; and the feel limit mechanism and the feel limit portion interfere with each other and are matched with each other when the rotary base rotates.

As a further improvement of the present invention, the feel limit portion is a groove; and the feel limit mechanism is an elastic limit bump matched with the groove.

As a further improvement of the present invention, the feel limit portion is an elastic limit bump; and the feel limit mechanism is a groove matched with the elastic limit bump.

As a further improvement of the present invention, the invention further includes a rotation limit assembly disposed between the upper cap and the lower cap, wherein the rotation limit assembly includes a rotation limit step and a rotation limit block; the rotation limit step is provided at an outer edge of the rotary base; the rotation limit block is disposed at an edge of the rotation avoidance hole; and after the rotation limit step rotates to the rotation limit block, the rotation limit block prevents the rotation limit step from continuing to rotate.

As a further improvement of the present invention, the rotation limit step includes a first rotation limit step and/or a second rotation limit step disposed on the rotary base.

As a further improvement of the present invention, the plug body is any one of a European standard plug, a United Kingdom standard plug, an Australian standard plug, an American standard plug, an Italian standard plug, a Swiss standard plug or an Indian standard plug.

As a further improvement of the present invention, the feel limit mechanism is disposed on the support; a first step protrudes from the rotary base in a direction towards the support; a first fixing portion with an opening facing in the direction of the first step is disposed on the support; the feel limit mechanism includes a first feel limit block disposed in the first fixing portion and having a top end extending in the direction of the inner circumference of the first step; the feel limit portion includes at least one first feel limit portion formed on the inner circumference of the first step and matched with the first feel limit block; and the first feel limit block and the first feel limit portion interfere with each other and are matched with each other when the rotary base rotates.

As a further improvement of the present invention, the feel limit mechanism is disposed on the support; a second fixing portion with an opening facing in the direction of the rotary base is disposed on the support; the feel limit mechanism includes a second feel limit block disposed on the second fixing portion and having a top end extending towards the direction of the rotary base; the feel limit portion includes a second feel limit portion disposed on the rotary base and directly opposite to the support, and the second feel limit block and the second feel limit portion interfere with each other and are matched with each other when the rotary base rotates.

As a further improvement of the present invention, the feel limit mechanism is disposed on the lower cap; the feel limit portion includes a plurality of third feel limit portions which are disposed on an outer ring of the rotary base and are inwardly recessed; the feel limit mechanism includes a third feel limit block which is disposed on the lower cap and is in the shape of a hook; and the top end of the hook of the third feel limit block and the third feel limit portion interfere with each other when the rotary base rotates.

As a further improvement of the present invention, the feel limit mechanism is disposed on the upper cap; a twentieth step is disposed on the upper ring of the periphery of the rotary base; the feel limit portion includes a plurality of twentieth feel limit portions disposed on a circular ring surface of the twentieth step facing the direction of the upper cap; a twentieth boss protruding towards the direction of the rotary base is formed on the upper cap; the feel limit mechanism includes a twentieth feel limit block disposed on the twentieth boss and protruding towards the twentieth feel limit portion; and the twentieth feel limit block and the twentieth feel limit portion interfere with each other and are matched with each other when the rotary base rotates.

A pin rotation structure for a power converter includes an upper cap, a lower cap covered to the upper cap, and a support disposed between the upper cap and the lower cap. The pin rotation structure further includes a plug assembly rotatably disposed on the lower cap, and a feel limit fixing plate disposed between the upper cap and the lower cap, wherein the plug assembly includes a rotary base rotatably disposed on the lower cap, and a plug body disposed on the rotary base; at least one feel limit portion is formed on the rotary base; a rotation avoidance hole for placing the rotary base in rotation is arranged on the lower cap; and the pin rotation structure further includes a feel limit mechanism disposed on the feel limit fixing plate, wherein the feel limit mechanism and the feel limit portion interfere with each other and are matched with each other when the rotary base rotates.

As a further improvement of the present invention, a fourth step protrudes in the direction of the rotary base towards the support; the feel limit portion includes a plurality of fourth feel limit portions disposed on an annular surface of the fourth step towards the support; a fourth fixing portion is disposed on the feel limit fixing plate; the feel limit mechanism includes a fourth feel limit block disposed on the fourth fixing portion and protruding in the direction of the fourth feel limit portion; and the fourth feel limit block and the fourth feel limit portion interfere with each other and are matched with each other when the rotary base rotates.

As a further improvement of the present invention, a fifth step protrudes in the direction of the rotary base towards the support; the feel limit portion includes a plurality of fifth feel limit portions disposed on the outer edge of the fifth step towards the feel limit fixing plate; the feel limit fixing plate is provided with a fifth fixing portion which is recessed away from the direction of the rotary base; the feel limit mechanism includes a fifth feel limit block disposed on the fifth fixing portion and protruding towards the direction of the fifth feel limit portion; and the fifth feel limit block and the fifth feel limit portion interfere with each other and are matched with each other when the rotary base rotates.

As a further improvement of the present invention, a sixth step protrudes in the direction of the rotary base towards the support; the feel limit portion includes a plurality of sixth feel limit portions disposed on an annular surface of the sixth step towards the support; a sixth fixing plate as a whole in the shape of a rail is formed on the feel limit fixing plate; the feel limit mechanism includes a sixth feel limit block disposed on the sixth fixing plate and protruding towards the sixth feel limit portion; and the sixth feel limit block and the sixth feel limit portion interfere with each other and are matched with each other when the rotary base rotates.

As a further improvement of the present invention, the feel limit portion includes a plurality of seventh feel limit portions disposed on the outer ring of the rotary base and recessed inwards; the feel limit mechanism includes a seventh feel limit mechanism disposed on the feel limit fixing plate; the seventh feel limit mechanism includes a seventh mounting seat disposed on the lower cap, a seventh elastic member disposed in the mounting seat and having a z-shape as a whole, and a seventh feel limit block formed on the seventh elastic member and protruding towards the seventh feel limit portion; and the seventh feel limit block and the seventh feel limit portion interfere with each other and are matched with each other when the rotary base rotates.

As a further improvement of the present invention, the feel limit portion includes a plurality of eighth feel limit portions disposed on the outer ring of the rotary base and recessed inwards; the feel limit mechanism includes an eighth feel limit block which is formed on the feel limit fixing plate and has a [symbol] -shaped character as a whole; and a middle raised portion in the eighth feel limit block and the eighth feel limit portion interfere with each other and are matched with each other when the rotary base rotates.

As a further improvement of the present invention, the feel limit portion includes a plurality of ninth feel limit portions disposed on the outer ring of the rotary base and recessed inwards; the feel limit mechanism includes a ninth feel limit mechanism disposed on the feel limit fixing plate; the ninth feel limit mechanism includes a ninth mounting seat disposed on the feel limit fixing plate, a ninth elastic member integrally formed on the ninth mounting seat and being M-shaped at two sides, and a ninth feel limit block formed on the ninth elastic member and protruding towards the ninth feel limit portion; and the ninth feel limit block and the ninth feel limit portion interfere with each other and are matched with each other when the rotary base rotates.

As a further improvement of the present invention, the feel limit portion includes a plurality of tenth feel limit portions disposed on the outer ring of the rotary base and recessed inwards; the feel limit mechanism includes a tenth feel limit mechanism disposed on the feel limit fixing plate; the tenth feel limit mechanism includes a tenth mounting seat disposed on the feel limit fixing plate, a tenth feel limit member disposed in the tenth mounting seat, a tenth elastic member disposed between the tenth mounting seat and the tenth feel limit member, and a tenth feel limit block which is formed on the tenth feel limit member and protrudes towards the tenth feel limit portion; and the tenth feel limit block and the tenth feel limit portion interfere with each other when the rotary base rotates.

A pin rotation structure for a power converter includes an upper cap, a lower cap covered to the upper cap, and a support disposed between the upper cap and the lower cap. The pin rotation structure further includes a plug assembly rotatably disposed on the lower cap, and a feel limit fixing plate disposed between the upper cap and the lower cap, wherein the plug assembly includes a rotary base rotatably disposed on the lower cap, and a plug body disposed on the rotary base; at least one feel limit portion is formed on the feel limit fixing plate; a rotation avoidance hole for placing the rotary base in rotation is disposed on the lower cap; the pin rotation structure further includes a feel limit mechanism disposed on the rotary base; and the feel limit mechanism and the feel limit portion interfere with each other and are matched with each other when the rotary base rotates.

As a further improvement of the present invention, a thirteenth step protruding towards the direction of the support and matched with the rotary base is formed on the feel limit fixing plate; the feel limit portion includes a plurality of thirteenth feel limit portions disposed on the inner circumference of the thirteenth step in the direction of the rotary base and recessed inwards; a thirteenth fixing portion recessed inwards is formed on the rotary base; the feel limit mechanism includes a thirteenth feel limit block disposed on the thirteenth fixing portion and having a top end extending towards the thirteenth feel limit portion; and the thirteenth feel limit block and the thirteenth feel limit portion interfere with each other and are matched with each other when the rotary base rotates.

As a further improvement of the present invention, a fourteenth ring terminal for covering the outer circumference of the lower end of the rotary base is formed on the feel limit fixing plate; the feel limit portion includes a plurality of fourteenth feel limit portions which are annularly disposed on the fourteenth ring terminal in sequence; the feel limit mechanism includes a fourteenth feel limit block which is disposed on the rotary base and the top end of which protrudes in the direction of the fourteenth feel limit portion; and the fourteenth feel limit block and the fourteenth feel limit portion interfere with each other and are matched with each other when the rotary base rotates.

As a further improvement of the present invention, a fifteenth step protruding towards the direction of the support and matched with the rotary base is formed on the feel limit fixing plate; the feel limit portion includes a plurality of fifteenth feel limit portions disposed on the inner circumference of the fifteenth step in the direction towards the rotary base and recessed inwards; the feel limit mechanism includes a fifteenth feel limit block disposed on the outer ring of the rotary base and protruding towards the fifteenth feel limit portion; and the fifteenth feel limit block and the fifteenth feel limit portion interfere with each other and are matched with each other when the rotary base rotates.

As a further improvement of the present invention, a sixteenth ring terminal for covering the outer circumference of the lower end of the rotary base is formed on the feel limit fixing plate; the feel limit portion includes a plurality of sixteenth feel limit portions which are annularly disposed on the sixteenth ring terminal in sequence; the feel limit mechanism includes a sixteenth feel limit block which is integrally formed on the rotary base and protrudes towards the direction of the sixteenth feel limit portion; and the sixteenth feel limit block and the sixteenth feel limit portion interfere with each other and are matched with each other when the rotary base rotates.

As a further improvement of the present invention, the feel limit portion includes a plurality of seventeenth feel limit blocks disposed on the outer ring of the rotary base and protruding towards the feel limit fixing plate; the feel limit mechanism includes a seventeenth feel limit mechanism disposed on the feel limit fixing plate; the seventeenth feel limit mechanism includes a seventeenth mounting seat formed on the feel limit fixing plate, a seventeenth feel limit member disposed in the seventeenth mounting seat, a seventeenth elastic member disposed between the seventeenth mounting seat and the seventeenth feel limit member, and a seventeenth feel limit groove formed on the seventeenth feel limit member and inwardly recessed to match with the seventeenth feel limit block; and the seventeenth feel limit groove and the seventeenth feel limit block interfere with each other when the rotary base rotates.

A pin rotation structure for a power converter includes an upper cap, a lower cap covered to the upper cap, and a support disposed between the upper cap and the lower cap. The pin rotation structure further includes a plug assembly rotatably disposed on the lower cap, wherein the plug assembly includes a rotary base rotatably disposed on the lower cap, and a plug body disposed on the rotary base; the lower cap is provided with a rotation avoidance hole for placing the rotary base in rotation; the rotary base is provided with a feel limit mechanism, and further includes a feel limit portion disposed on the support or the lower cap or the upper cap; and the feel limit mechanism and the feel limit portion interfere with each other and are matched with each other when the rotary base rotates.

As a further improvement of the present invention, the feel limit portion is disposed on the support; a sector plate matched with the rotary base is formed on the bracket; the feel limit portion includes a plurality of eleventh feel limit portions formed inside the sector plate and arranged around the sector plate; the feel limit mechanism includes an eleventh feel limit block disposed on the rotary base and with the top end thereof protruding towards the eleventh feel limit portion; and the eleventh feel limit block and the eleventh feel limit portion interfere with each other and are matched with each other when the rotary base rotates.

As a further improvement of the present invention, the feel limit portion is disposed on the support; a sector plate matched with the rotary base is formed on the support; the feel limit portion includes a plurality of twelfth feel limit portions formed on an arc-shaped outer edge of the sector plate; a twelfth fixing portion protruding upwards and opening towards the sector plate is formed on the rotary base; the feel limit mechanism includes a twelfth feel limit block disposed on the twelfth fixing portion and protruding towards the twelfth feel limit portion; and the twelfth feel limit block and the twelfth feel limit portion interfere with each other and are matched with each other when the rotary base rotates.

As a further improvement of the present invention, the feel limit portion is disposed on the lower cap; the lower cap is formed with an eighteenth step protruding towards the direction of the support and matched with the rotary base; the feel limit portion includes a plurality of eighteenth feel limit portions disposed on the eighteenth step towards the inner circumference in the direction of the rotary base and recessed inwards; the rotary base is formed with an eighteenth fixing portion recessed inwards; the feel limit mechanism includes an eighteenth feel limit block disposed on the eighteenth fixing portion and having a top end extending towards the eighteenth feel limit portion; and the eighteenth feel limit block and the eighteenth feel limit portion interfere with each other and are matched with each other when the rotary base rotates.

As a further improvement of the present invention, the feel limit portion is disposed on the upper cap; a nineteenth boss protruding towards the direction of the rotary base and matched with the rotary base is formed in the upper cap; the feel limit portion includes a plurality of nineteenth feel limit portions disposed on one end of the nineteenth boss facing towards the rotary base; the feel limit mechanism includes a nineteenth feel limit block disposed on the rotary base and protruding towards the nineteenth feel limit portion; and the nineteenth feel limit block and the nineteenth feel limit portion interfere with each other and are matched with each other when the rotary base rotates.

The invention has the following beneficial effects.

(1) By arranging the pin rotation structure to include an upper cap, a lower cap covered to the upper cap, and a support disposed between the upper cap and the lower cap, the pin rotation structure further includes a plug assembly rotatably disposed on the lower cap, wherein the plug assembly includes a rotary base rotatably disposed on the lower cap, and a plug body disposed on the rotary base; at least one feel limit portion is formed on the rotary base; a rotation avoidance hole for placing the rotary base in rotation is disposed on the lower cap; wherein the pin rotation structure further includes a feel limit mechanism disposed on the support or the lower cap or the upper cap; and the feel limit mechanism and the feel limit portion interfere with each other and are matched with each other when the rotary base rotates.

The plug assembly is disposed in the rotary base, and the rotary base is rotated on the rotation avoidance hole, so that the plug assembly can rotate on the lower cap, thereby achieving the change of the position of the plug assembly. A user can change the position of the plug assembly, so that the whole power converter can be applied to power sockets at different positions, and the other outlets on the power sockets are not covered too much, so as to improve the practicability of the power converter, facilitate people's travel, and effectively improve people's experience of use.

By arranging the feel limit mechanism to be matched with the feel limit portion, when the rotary base rotates, the feel limit mechanism rotates relative to the feel limit portion and passes through the recessed feel limit portion, and the other mechanisms on the power converter are not recessed, so that when the feel limit mechanism contacts the feel limit portion, a different sense of detent is generated from when the feel limit mechanism rotates to the rest, thereby providing a user with a good user experience, improving the feeling of using the power converter, and prompting the user that the feel limit mechanism has been rotated to a specific position. It is also possible to limit the rotary base and stop at this position without external force, so as to facilitate the use by the user.

(2) By providing a rotation limit assembly between the upper cap and the lower cap, the rotation limit assembly includes a rotation limit step and a rotation limit block. The rotation limit step is disposed at the outer edge of the rotary base. The rotation limit block is provided at the edge of the rotation avoidance hole. After the rotation limit step is rotated until pressed against the rotation limit block, the rotation limit block prevents the rotation limit step from continuing to rotate, so as to prevent the plug assembly disposed on the rotary base from rotating excessively, resulting in the problem of the internal connection structure being knotted or broken, etc., thus ensuring the safety of the present pin rotation structure.

(3) The rotation limit step is provided as a first rotation limit step and a second rotation limit step respectively disposed on the rotary base, and the symmetrically provided structure thereof is more consistent with the structure of a circular rotary base, so that during rotation of the rotary base, whether the first rotation limit step or the second rotation limit step thereon presses against the rotation limit block, the rotary base can be limited, thereby better limiting the rotation stroke of the plug assembly, so as to prevent the plug assembly disposed on the rotary base from rotating excessively, resulting in the problem of the internal connection structure being knotted or broken, etc. This guarantees the safety of the pin rotation structure.

The above is an overview of the technical solutions of the invention, and the invention is further explained in combination with the accompanying drawings and the detailed description.

### BRIEF DESCRIPTION OF THE DRAWINGS

FIG. 1 is an overall schematic view of the present invention;

FIG. 2 shows a Swiss-type socket panel;

FIG. 3 shows an Indian-type socket panel;

FIG. 4 shows an Italian-type socket panel;

FIG. 5 shows a Chinese-type or Australian-type socket panel;

FIG. 6 shows a European-type socket panel;

FIG. 7 shows a Japanese-type socket panel;

FIG. 8 shows a United Kingdom-type socket panel;

FIG. 9 shows a Chinese-type or Australian-type plug;

FIG. 10 shows a Swiss-type plug;

FIG. 11 shows a German-type plug;

FIG. 12 shows a European-type plug;

FIG. 13 shows an Indian-type plug;

FIG. 14 is an Italian-type plug;

FIG. 15 is an American-type plug;

FIG. 16 is a United Kingdom-type plug;

FIG. 17 is an exploded view of a first embodiment;

FIG. 18 is a structurally schematic view of a feel limit mechanism and a feel limit portion according to the first embodiment;

FIG. 19 is a structurally schematic view of a support and a feel limit mechanism according to the first embodiment;

FIG. 20 is a structurally schematic view of a rotary base according to the first embodiment;

FIG. 21 is a structurally schematic view of a feel limit mechanism and a feel limit portion according to a second embodiment;

FIG. 22 is a structurally schematic view of the support and the feel limit mechanism according to the second embodiment;

FIG. 23 is a structurally schematic view of a rotary base according to the second embodiment;

FIG. 24 is an exploded view of FIG. 1;

FIG. 25 is a structurally schematic view of a lower cap of FIG. 1;

FIG. 26 is a schematic view of the connection of a plug assembly and a socket assembly of FIG. 1;

FIG. 27 is a front view of the connection of the plug assembly and the socket assembly of FIG. 1;

FIG. 28 is an exploded view of the connection of the plug assembly and the socket assembly of FIG. 1;

FIG. 29 is an overall schematic view of a fourth embodiment;

FIG. 30 is an exploded view of the fourth embodiment;

FIG. 31 is a structurally schematic view of a feel limit mechanism and a feel limit portion according to the fourth embodiment;

FIG. 32 is a structurally schematic view of a rotary base according to the fourth embodiment;

FIG. 33 is a structurally schematic view of a lower cap according to the fourth embodiment;

FIG. 34 is a schematic view showing the connection of the plug assembly and the socket assembly according to the fifth embodiment;

FIG. 35 is a front view showing the connection of the plug assembly and the socket assembly according to the fifth embodiment;

FIG. 36 is an exploded view of the plug assembly and the socket assembly according to the fifth embodiment;

FIG. 37 is an overall schematic view of a sixth embodiment;

FIG. 38 is an exploded view of the sixth embodiment;

FIG. 39 is a structurally schematic view of a feel limit mechanism and a feel limit portion according to the sixth embodiment;

FIG. 40 is a structurally schematic view of a feel limit fixing plate and a feel limit mechanism according to the sixth embodiment;

FIG. 41 is a structurally schematic view of a rotary base according to the sixth embodiment;

FIG. 42 is a structurally schematic view of a feel limit mechanism and a feel limit portion according to the seventh embodiment;

FIG. 43 is a structurally schematic view of a feel limit fixing plate and the feel limit mechanism according to the seventh embodiment;

FIG. 44 is a structurally schematic view of a rotary base according to the seventh embodiment;

FIG. 45 is a structurally schematic view of the feel limit mechanism and the feel limit portion according to an eighth embodiment;

FIG. 46 is a structurally schematic view of a feel limit fixing plate and a feel limit mechanism according to the eighth embodiment;

FIG. 47 is a structurally schematic view of a rotary base according to the eighth embodiment;

FIG. 48 is a structurally schematic view of the lower cap and a feel limit fixing plate according to a ninth embodiment;

FIG. 49 is a structurally schematic view of a feel limit mechanism and a feel limit portion according to the ninth embodiment;

FIG. 50 is an exploded view of a rotary base and a feel limit mechanism according to the ninth embodiment;

FIG. 51 is an exploded view of a feel limit mechanism according to the ninth embodiment;

FIG. 52 is a schematic rear view of a feel limit fixing plate according to the ninth embodiment;

FIG. 53 is a structurally schematic view of a feel limit mechanism and a feel limit portion according to the tenth embodiment;

FIG. 54 is a structurally schematic view of the feel limit fixing plate and the feel limit mechanism according to the tenth embodiment;

FIG. 55 is a structurally schematic view of the rotary base according to the tenth embodiment;

FIG. 56 is a structurally schematic view of a lower cap and a feel limit fixing plate according to an eleventh embodiment;

FIG. 57 is a structurally schematic view of a feel limit mechanism and a feel limit portion according to the eleventh embodiment;

FIG. 58 is an exploded view of a rotary base and a feel limit mechanism according to the eleventh embodiment;

FIG. 59 is a schematic rear view of a feel limit fixing plate according to the eleventh embodiment;

FIG. 60 is a structurally schematic view of a feel limit mechanism and a feel limit portion according to a twelfth embodiment;

FIG. 61 is a structurally schematic view of a feel limit fixing plate and a feel limit mechanism according to the twelfth embodiment;

FIG. 62 is an exploded view of the feel limit fixing plate and the feel limit mechanism according to the twelfth embodiment;

FIG. 63 is a schematic view of a rotary base according to the twelfth embodiment;

FIG. 64 is an overall schematic view of the thirteenth embodiment;

FIG. 65 is an exploded view of the thirteenth embodiment;

FIG. 66 is a schematic view showing the connection of the plug assembly and the socket assembly according to the thirteenth embodiment;

FIG. 67 is a front view showing the connection of the plug assembly and the socket assembly according to the thirteenth embodiment;

FIG. 68 is an exploded view of the plug assembly and the socket assembly according to the thirteenth embodiment;

FIG. 69 is an overall view of a fourteenth embodiment;

FIG. 70 is an exploded view of the fourteenth embodiment;

FIG. 71 is a structurally schematic view of a support and a rotary base according to the fourteenth embodiment;

FIG. 72 is a structurally schematic view of the rotary base and a feel limit mechanism according to the fourteenth embodiment;

FIG. 73 is a schematic side view of the rotary base and the feel limit mechanism according to the fourteenth embodiment;

FIG. 74 is a structurally schematic view of the support according to the fourteenth embodiment;

FIG. 75 is a structurally schematic view of the support and the rotary base according to a fifteenth embodiment;

FIG. 76 is a structurally schematic view of a rotary base and a feel limit mechanism according to the fifteenth embodiment;

FIG. 77 is a structurally schematic view of the support according to the fifteenth embodiment;

FIG. 78 is an exploded view of a sixteenth embodiment;

FIG. 79 is an exploded view of a plug assembly and a socket assembly according to the sixteenth embodiment;

FIG. 80 is an overall schematic view of a seventeenth embodiment;

FIG. 81 is an exploded view of the seventeenth embodiment;

FIG. 82 is a structurally schematic view of a feel limit mechanism and a feel limit portion according to the seventeenth embodiment;

FIG. 83 is a structurally schematic view of a feel limit fixing plate and the feel limit mechanism according to the seventeenth embodiment;

FIG. 84 is a structurally schematic view of a rotary base and the feel limit mechanism according to the seventeenth embodiment;

FIG. 85 is a structurally schematic view of a feel limit mechanism and a feel limit portion according to an eighteenth embodiment;

FIG. 86 is an exploded view of a rotary base and a feel limit mechanism according to the eighteenth embodiment;

FIG. 87 is a structurally schematic view of a feel limit fixing plate and the feel limit mechanism according to the eighteenth embodiment;

FIG. 88 is a structurally schematic view of a feel limit mechanism and a feel limit portion according to a nineteenth embodiment;

FIG. 89 is a structurally schematic view of a rotary base and the feel limit mechanism according to the nineteenth embodiment;

FIG. 90 is a structurally schematic view of a feel limit fixing plate and a feel limit mechanism according to a nineteenth embodiment;

FIG. 91 is a structurally schematic view of a feel limit mechanism and a feel limit portion according to a twentieth embodiment;

FIG. 92 is a structurally schematic view of a rotary base and the feel limit mechanism according to the twentieth embodiment;

FIG. 93 is a structurally schematic view of a feel limit fixing plate and the feel limit mechanism according to the twentieth embodiment;

FIG. 94 is a structurally schematic view of a feel limit mechanism and a feel limit portion according to a twenty-first embodiment;

FIG. 95 is an exploded view of a feel limit fixing plate and the feel limit mechanism according to the twenty-first embodiment;

FIG. 96 is a structurally schematic view of a rotary base according to the twenty-first embodiment;

FIG. 97 is an exploded view of a twenty-second embodiment;

FIG. 98 is an exploded view of a plug assembly and a socket assembly according to twenty-second embodiment;

FIG. 99 is an overall schematic view of a twenty-third embodiment;

FIG. 100 is an exploded view of the twenty-third embodiment;

FIG. 101 is a structurally schematic view of a feel limit mechanism and a feel limit portion according to the twenty-third embodiment;

FIG. 102 is a structurally schematic view of a rotary base and the feel limit mechanism according to the twenty-third embodiment;

FIG. 103 is a structurally schematic view of a lower cap and a feel limit portion according to the twenty-third embodiment;

FIG. 104 is an exploded view of a plug assembly and a socket assembly according to a twenty-fourth embodiment;

FIG. 105 is an overall schematic view of a twenty-fifth embodiment;

FIG. 106 is an exploded view of a twenty-fifth embodiment;

FIG. 107 is a structurally schematic view of a feel limit mechanism and a feel limit portion according to the twenty-fifth embodiment;

FIG. 108 is a structurally schematic view of an upper cap and a feel limit portion according to the twenty-fifth embodiment;

FIG. 109 is a structurally schematic view of a rotary base and a feel limit mechanism according to the twenty-fifth embodiment;

FIG. 110 is an exploded view of a twenty-sixth embodiment;

FIG. 111 is an exploded view of a plug assembly and a socket assembly according to the twenty-sixth embodiment;

FIG. 112 is an overall schematic view of a twenty-seventh embodiment;

FIG. 113 is an exploded view of a twenty-seventh embodiment;

FIG. 114 is a structurally schematic view of a feel limit mechanism and a feel limit portion according to the twenty-seventh embodiment;

FIG. 115 is a structurally schematic view of an upper cap and the feel limit mechanism according to the twenty-seventh embodiment;

FIG. 116 is a structurally schematic view of a rotary base according to the twenty-seventh embodiment;

FIG. 117 is an exploded view of a twenty-eighth embodiment;

FIG. 118 is an exploded view of a plug assembly and a socket assembly according to the twenty-eighth embodiment;

In the drawings,
01, upper cap; 011, nineteenth boss; 012, twentieth boss;
02, lower cap; 021, rotation avoidance hole; 022, eighteenth step;
03, support; 031, first fixing portion; 032, second fixing portion; 033, sector plate;
04, plug assembly; 041, rotary base; 0411, first step; 0412, fourth step; 0413, fifth step; 0414, sixth step; 0415, twelfth fixing portion; 0416, thirteenth fixing portion; 0417, eighteenth fixing portion; 0418, twentieth step; 042, plug body; 043, live wire pin; 044, neutral wire pin; 045, ground wire pin;
05, feel limit fixing plate; 051, fourth fixing portion; 052, fifth fixing portion; 053, sixth fixing plate; 054, thirteenth step; 055, fourteenth ring terminal; 056, fifteenth step; 057, sixteenth ring terminal; 058, seventh mounting groove; 059, ninth mounting groove;
06, feel limit portion; 0601, first feel limit portion; 0602, second feel limit portion; 0603, third feel limit portion; 0604, fourth feel limit portion; 0605, fifth feel limit portion; 0606, sixth feel limit portion; 0607, seventh feel limit portion; 0608, eighth feel limit portion; 0609, ninth feel limit portion; 0610, tenth feel limit portion; 0611, eleventh feel limit portion; 0612, twelfth feel limit portion; 0613, thirteenth feel limit portion; 0614, fourteenth feel limit portion; 0615, fifteenth feel limit portion; 0616, sixteenth feel limit portion; 0617, seventeenth feel limit block; 0618, eighteenth feel limit portion; 0619, nineteenth feel limit portion; 0620, twentieth feel limit portion;
07, feel limit mechanism; 0701, first feel limit block; 0702, second feel limit block; 0703, third feel limit block; 0704, fourth feel limit block; 0705, fifth feel limit block; 0706, sixth feel limit block; 0707, seventh feel limit mechanism; 07071, seventh mounting seat; 07072, seventh elastic member; 07073, seventh feel limit block; 0708, eighth feel limit block; 0709, ninth feel limit mechanism; 07091, ninth mounting seat; 07092, ninth elastic member; 07093, ninth feel limit block; 0710, tenth feel limit mechanism; 07101, tenth mounting seat; 07102, tenth feel limit member; 07103, tenth elastic member; 07104, tenth feel limit block; 0711, eleventh feel limit block; 0712, twelfth feel limit block; 0713, thirteenth feel limit block; 0714, fourteenth feel limit block; 0715, fifteenth feel limit block; 0716, sixteenth feel limit block; 0717, seventeenth feel limit mechanism; 07171, seventeenth mounting seat; 07172, seventeenth feel limit member; 07173, seventeenth elastic member; 07174, seventeenth feel limit groove; 0718, eighteenth feel limit block; 0719, nineteenth feel limit block; 0720, twentieth feel limit block;
08, rotation limit assembly; 081, rotation limit step; 0811, first rotation limit step; 0812, second rotation limit step;
09, socket panel;
10, socket assembly; 101, socket live wire conductive clip; 102, socket ground wire conductive clip; 103, socket neutral wire conductive clip;
11, flexible neutral-wire connecting line;
12, flexible live-wire connecting line; and
13, ground wire connector.

### DETAILED DESCRIPTION

In order to further clarify the technical means and effects adopted by the present invention to achieve the intended purpose, a detailed description of specific embodiments of the present invention will be given below with reference to the accompanying drawings and preferred embodiments.

In the description of the present invention, it should be understood that the directional or positional relationships indicated by the terms “length”, “width”, “up”, “down”, “front”, “back”, “left”, “right” and “vertical”, “level”, “top”, “bottom”, “inside”, “outside”, “side” and the like are based on the directional or positional relationships shown in the drawings. It is merely for the purpose of describing the present application and simplifying the description, and is not intended to indicate or imply that a particular orientation, configuration and operation of the referenced device or element is required and should not be construed as limiting the scope of the present invention.

Furthermore, the terms “first” and “second” are used for descriptive purposes only and are not to be construed as indicating or implying relative importance or implicitly indicating the number of technical features indicated. Thus, a feature defined by “first” and “second” and so on may explicitly or implicitly include one or more such features. In the description of the present invention, the meaning of “a plurality” is two or more, unless specifically limited otherwise.

In the present invention, unless expressly stated or limited otherwise, the terms “mounted”, “connected”, “connecting”, “fixed”, and the like are to be interpreted broadly, e.g., either fixedly or removably, or integrally modularization. It may be a mechanical connection or an electrical connection. It may be a direct connection or indirect connection by an intermediary. It may be a communication between two elements, or may be in an interactive relationship between two elements. For those of ordinary skill in the art, the specific meanings of the above terms in the present invention can be understood according to specific circumstances.

### Embodiment 1

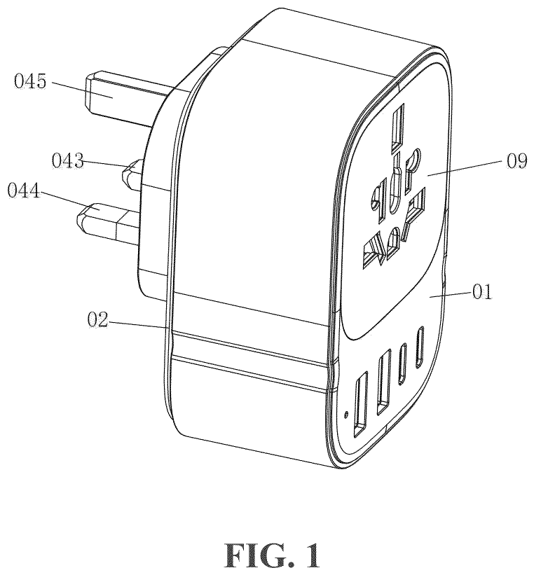

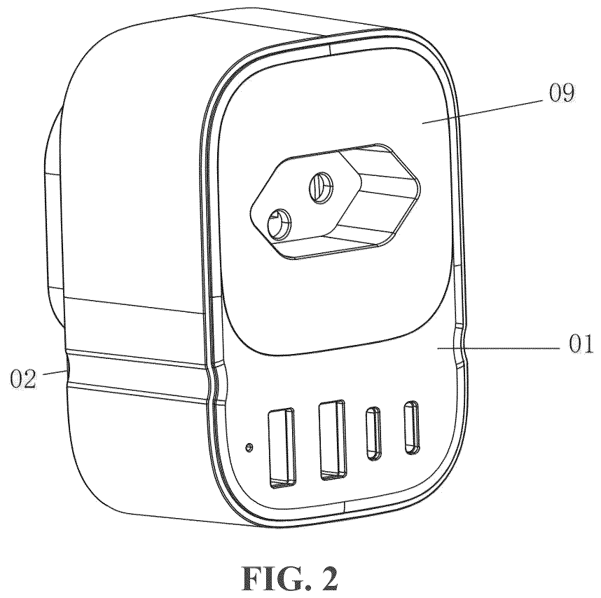

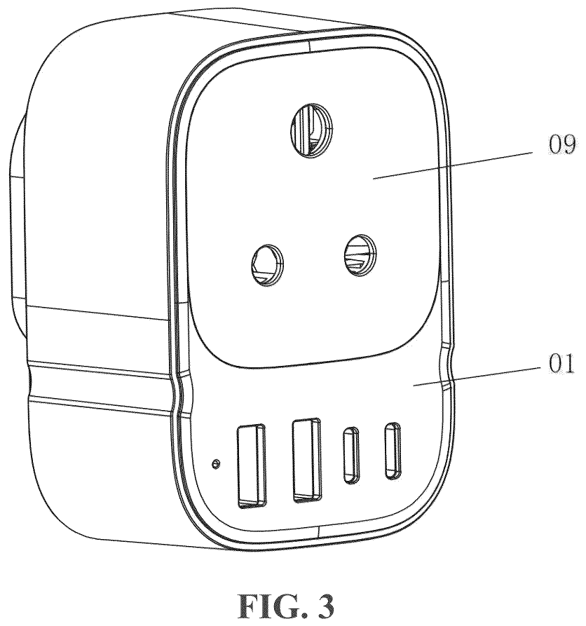

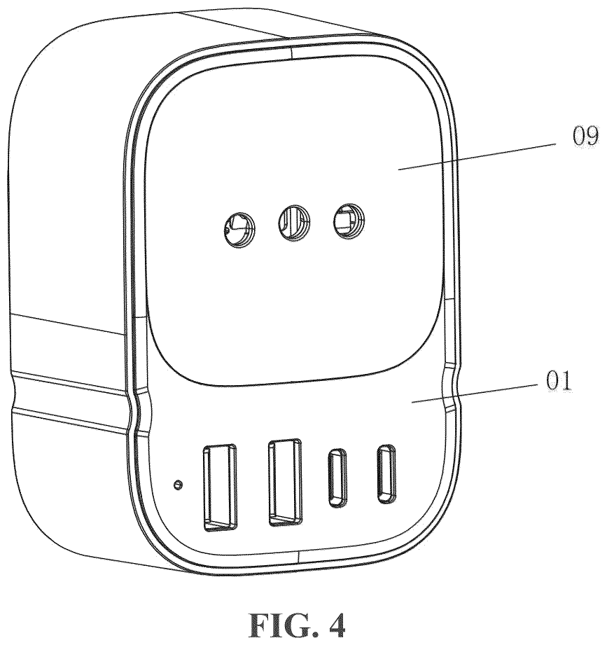

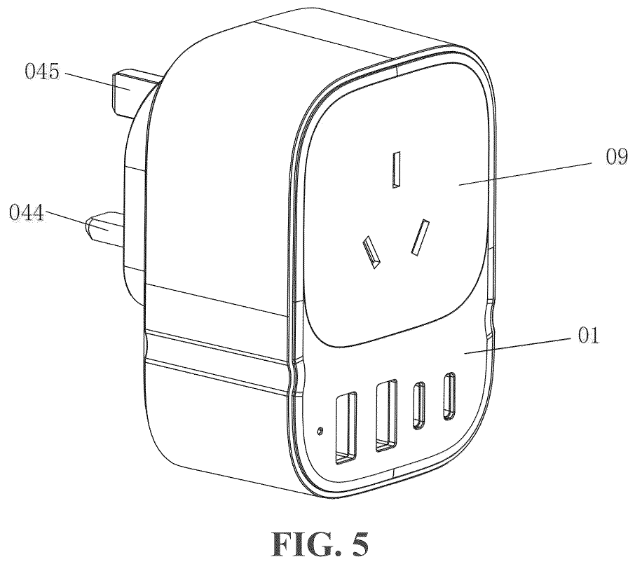

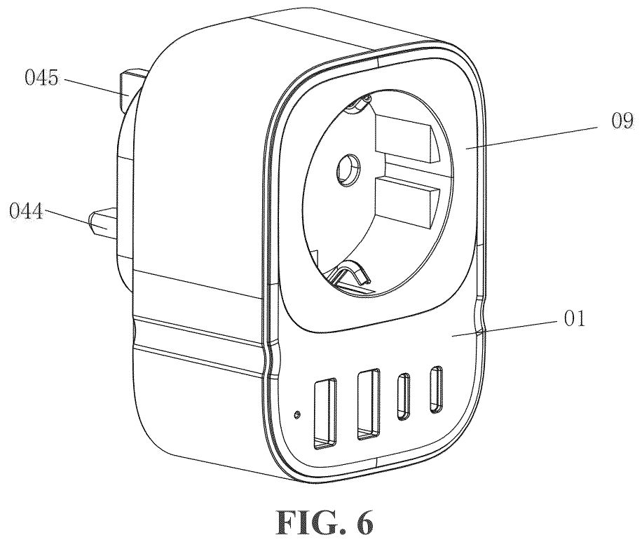

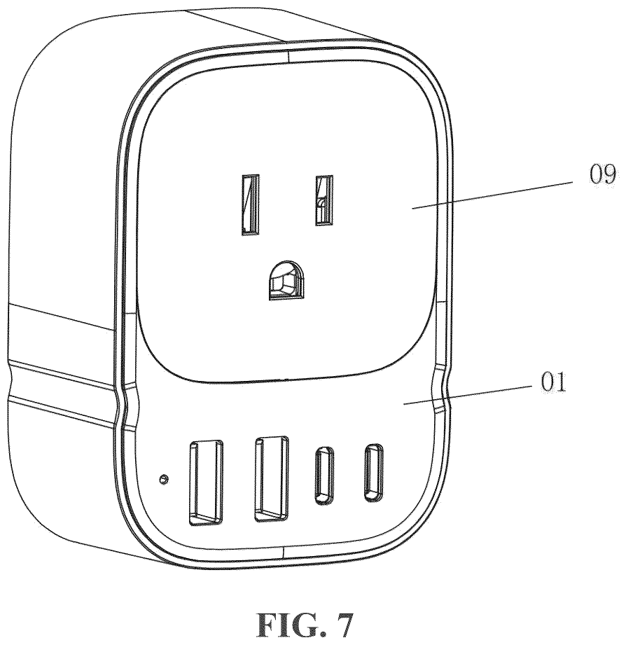

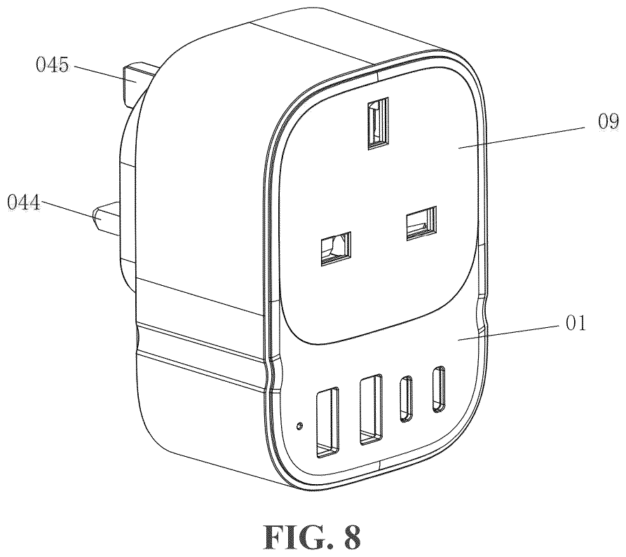

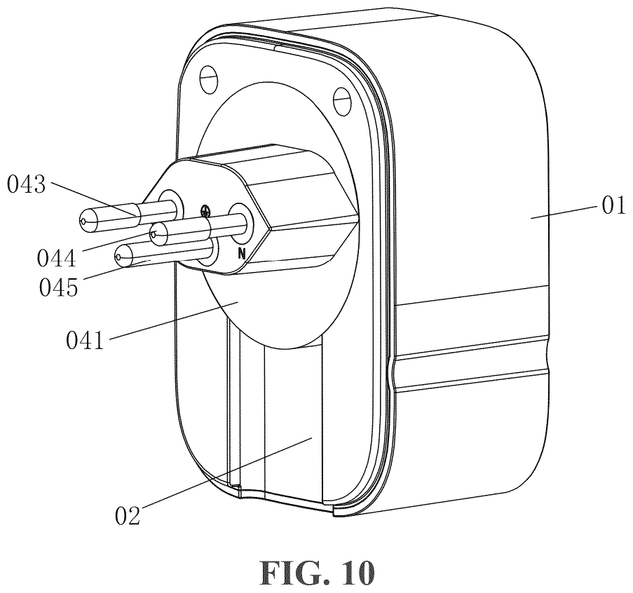

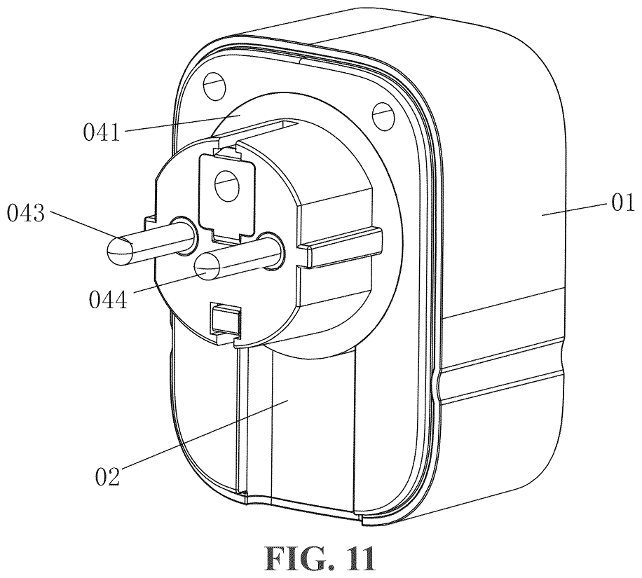

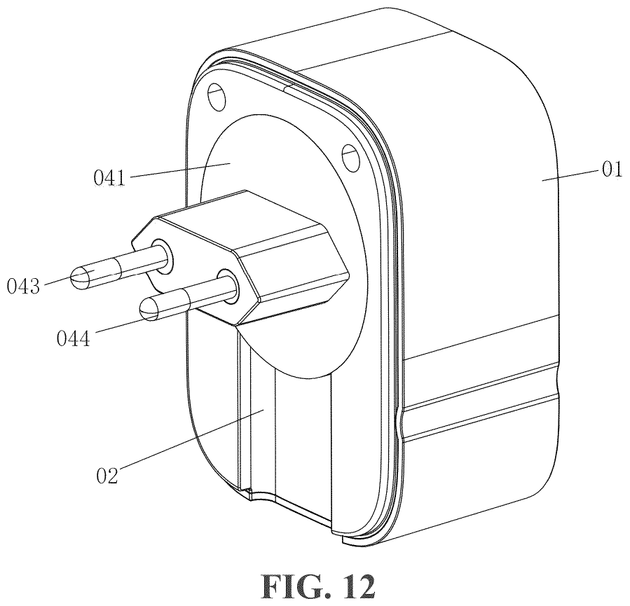

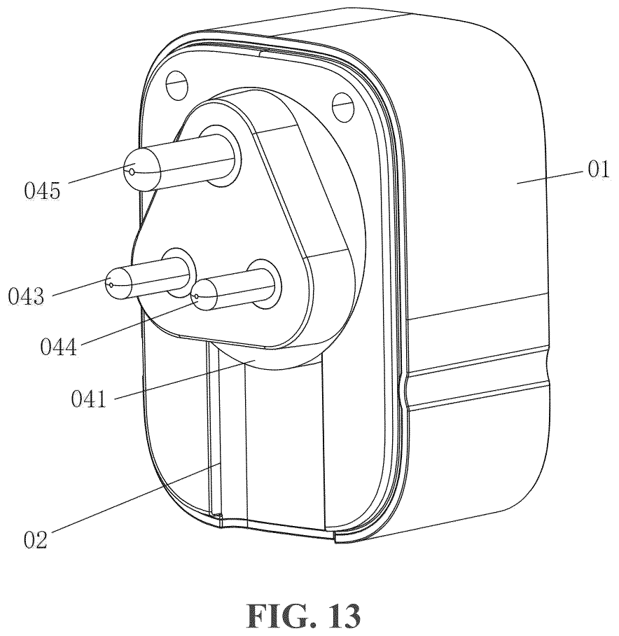

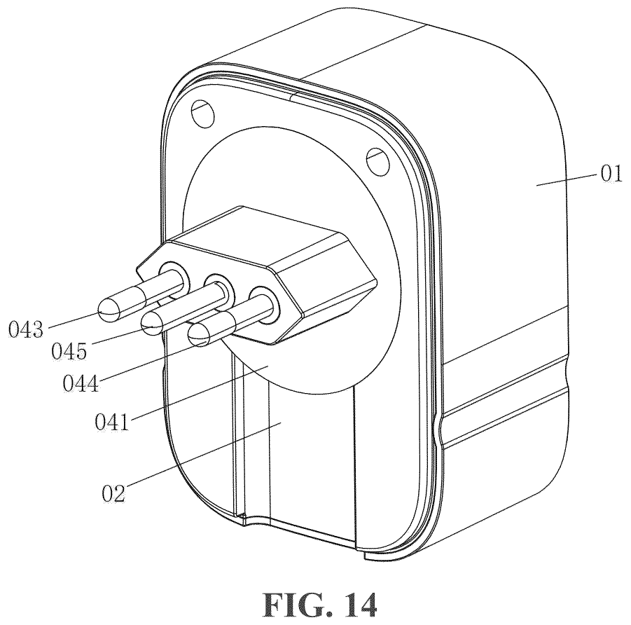

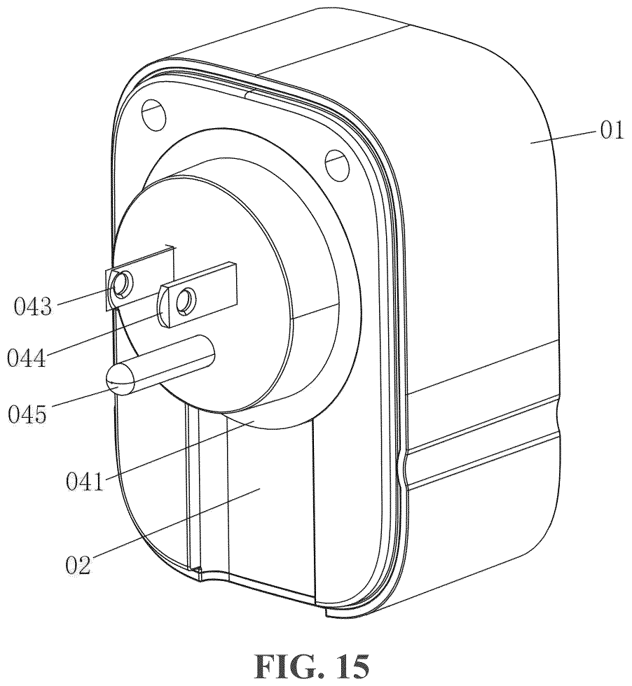

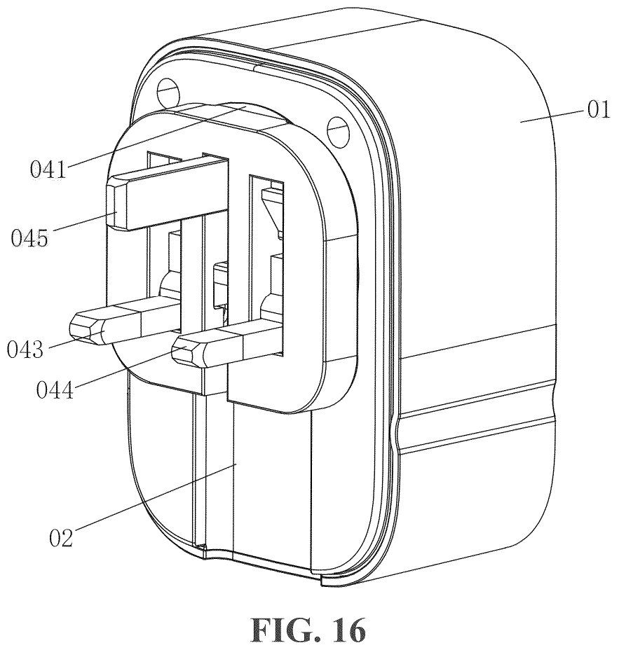

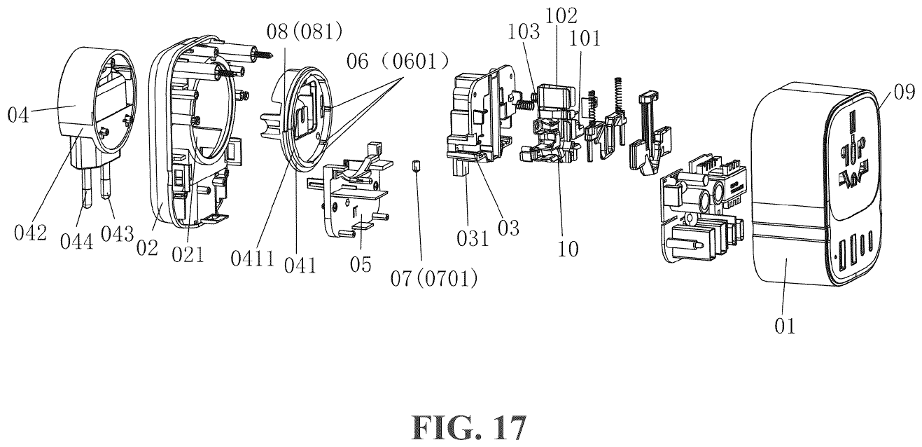

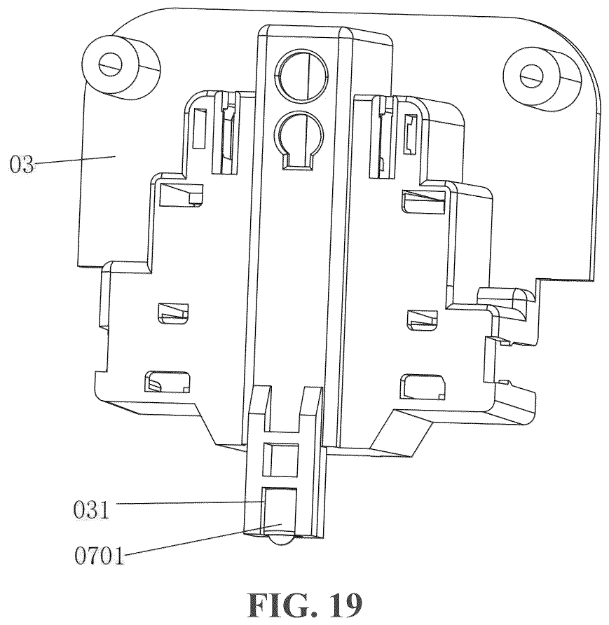

Referring to FIGS. 1 to 20, the present invention provides a pin rotation structure for a power converter, including an upper cap 01, a lower cap 02 covered to the upper cap 01, and a support 03 disposed between the upper cap 01 and the lower cap 02. The pin rotation structure further includes a plug assembly 04 rotatably disposed on the lower cap 02. The plug assembly 04 includes a rotary base 041 rotatably disposed on the lower cap 02, and a plug body 042 disposed on the rotary base 041. The rotary base 041 is formed with at least one feel limit portion 06. A rotation avoidance hole 021 for placing the rotary base 041 in rotation is disposed on the lower cap 02. The pin rotation structure further includes a feel limit mechanism 07 disposed on the support 03. The feel limit mechanism 07 and the feel limit portion 06 interfere with each other and are matched with each other when the rotary base 041 rotates.

The plug assembly 04 is disposed in the rotary base 041, and the rotary base 041 is rotated on the rotation avoidance hole 021, so that the plug assembly 04 can rotate on the lower cap 02, thereby achieving the change of the position of the plug assembly 04. A user can change the position of the plug assembly 04, so that the whole power converter can be applied to a power socket at different positions, and the other outlets on the power socket are not covered too much, so as to improve the practicability of the power converter, facilitate people's travel, and effectively improve people's experience of use.

By arranging the feel limit mechanism 07 to match with the feel limit portion 06, when the rotary base 041 rotates, the feel limit mechanism 07 rotates relative to the feel limit portion 06, and the other mechanisms on the power converter are not concave structures on the feel limit portion 06, so that when the feel limit mechanism 07 contacts with the feel limit portion 06, a different sense of detent is generated than when the feel limit mechanism 07 rotates to other positions, thereby providing a user with a good recessed and improving the experience of using the power converter. In addition, the user can be prompted that the user has rotated to a specific position, and the rotary base 041 can be limited to stay at this position without any external force, so as to facilitate the user's use.

With regard to the specific structural arrangement of the feel limit portion 06, the feel limit portion 06 is a groove, and the feel limit mechanism 07 is an elastic limit bump matched with the groove. Alternatively, the feel limit portion 06 is an elastic limit bump, and the feel limit mechanism 07 is a groove matched with the elastic limit bump. The reference can be made to a twenty-second embodiment. It can be set according to the actual situation.

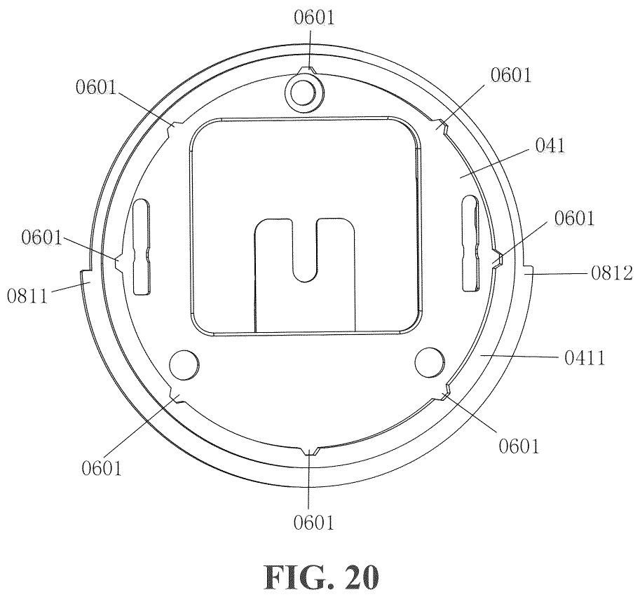

In order to prevent the rotary base 041 from rotating excessively, as shown in FIG. 20, the present pin rotation structure further includes a rotation limit assembly 08 disposed between the upper cap 01 and the lower cap 02. The rotation limit assembly 08 includes a rotation limit step 081 and a rotation limit block (not shown in the figure). The rotation restricting step 081 is disposed on the outer edge of the rotary base 041. The rotation limit block is disposed at the edge of the rotation avoidance hole 021. After the rotation limit step 081 is rotated until pressed against the rotation limit block, the rotation limit block prevents the rotation limit step 081 from continuing to rotate, so as to prevent the plug assembly 04 disposed on the rotary base 041 from over-rotating, resulting in the problem of knotting or breaking of the internal connection structure, etc., thus ensuring the safety of the present pin rotation structure.

With regard to the specific structure of the rotation limit step 081, as shown in FIG. 20, the rotation limit step 081 includes a first rotation limit step 0811 and/or a second rotation limit step 0812 respectively disposed on the rotary base 041, and the symmetrically provided structure thereof is more consistent with the structure of a circular rotary base 041, so that the rotary base 041 can be limited during rotation regardless of whether the first rotation limit step 0811 or the second rotation limit step 0812 thereof is pressed against the rotation limit block. Therefore, the rotational stroke of the plug assembly 04 is better limited, preventing the problem that the internal connection structure is knotted or broken due to the excessive rotation of the plug assembly 04 disposed on the rotary base 041. This guarantees the safety of the pin rotary structure. The first rotation limit step 0811 and the second rotation limit step 0812 may be used alone or in combination.

With regard to the specific structural arrangement of the plug body 042, as shown in FIGS. 1-8, the plug body 042 is any one of a European standard plug, a United Kingdom standard plug, an Australian standard plug, an American standard plug, an Italian standard plug, a Swiss standard plug and an Indian standard plug. The European standard plug, the United Kingdom standard plug, the Australian standard plug, the American standard plug, the Italian standard plug, the Swiss standard plug and the Indian standard plug are all conventional technical means in the industry, and the structure and operation mode thereof are all prior art. Therefore, the description thereof will not be repeated in this embodiment.

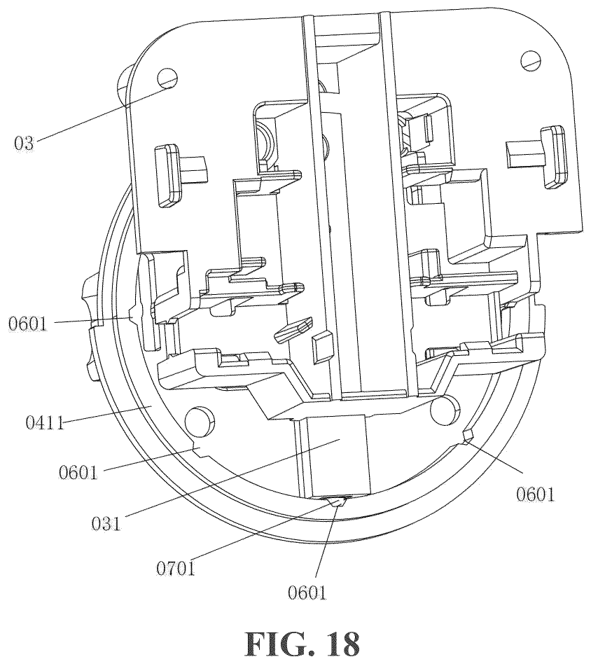

With regard to the specific manner in which the feel limit mechanism 07 and the feel limit portion 06 interfere with each other and are matched with each other. As shown in FIGS. 18 and 20, a first step 0411 protrudes from the rotary base 041 in the direction toward the support 03. A first fixing portion 031 is disposed on the support 03 and opens in the direction towards the first step 0411. The feel limit mechanism 07 includes a first feel limit block 0701 which is disposed in the first fixing portion 031 and has a top end extending in the inner circumferential direction of the first step 0411. The feel limit portion 06 includes at least a first feel limit portion 0601 formed on the inner circumference of the first step 0411 and matched with the first feel limit block 0701. The first feel limit block 0701 and the first feel limit portion 0601 interfere with each other when the rotary base 041 rotates. The first feel limit block 0701 is an elastic member. In use, the first feel limit block 0701 is fixed on the first fixing portion 031, and the front end thereof presses against a position on the first step 0411 other than the first feel limit portion 0601. When the first feel limit portion 0601 on which the rotary base 041 is rotated is directly opposite to the first feel limit block 0701, the first feel limit block 0701 correspondingly extends into the first feel limit portion 0601, so as to generate a different hand feeling from that of pressing against the non-recessed part of the first step 0411, and a sense of detent is generated between two different hand feelings. Thus, the user's favorable feeling of use is improved, the user's experience of using the power converter is improved, and the user is prompted that the power converter has been rotated to a specific position, so as to facilitate the user to grasp the rotation condition of the plug assembly 04. The rotary base 041 can be limited, and can be stopped at this position without external force, so as to facilitate the user's use.

### Second embodiment

In the first embodiment, the pin rotation structure has been described. In the present embodiment, the differences from the other embodiments are mainly described, and the description of the same configuration will not be repeated in the present embodiment.

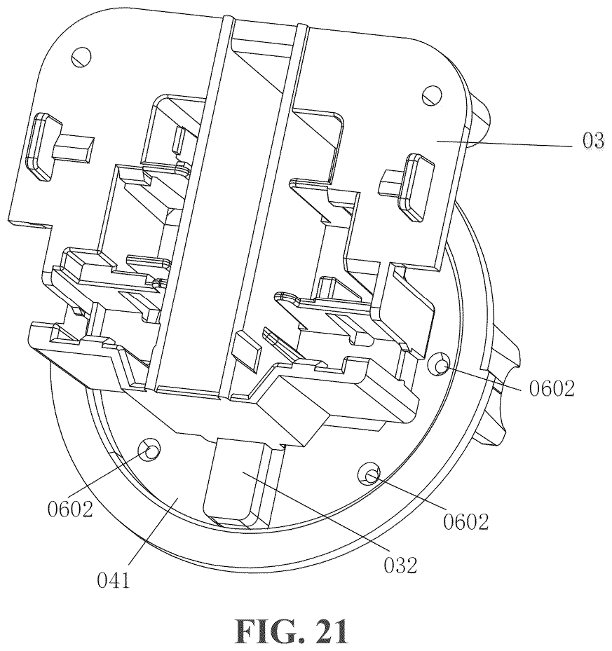

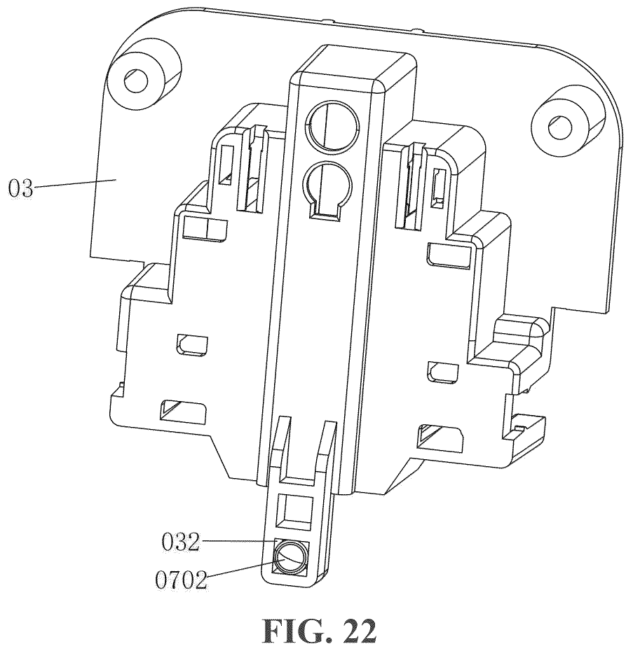

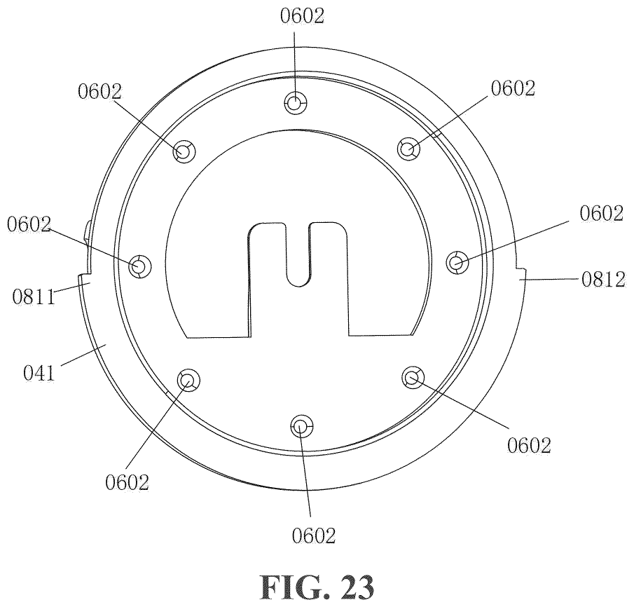

In the second embodiment, as shown in FIG. 21 to FIG. 23, a specific configuration of the feel limit mechanism 07 and the feel limit portion 06 is such that the support 03 is provided with a second fixing portion 032 having an opening in the direction of the rotary base 041. The feel limit mechanism 07 includes a second feel limit block 0702 disposed on the second fixing portion 032 and having a top end extending in the direction of the rotary base 041. The feel limit portion 06 includes a second feel limit portion 0602 disposed on the rotary base 041 directly opposite to the support 03. The second feel limit block 0702 and the second feel limit portion 0602 interfere with each other when the rotary base 041 is rotated. The second feel limit block 0702 is an elastic member. In use, the second feel limit block 0702 is fixed on the second fixing portion 032, and the front end thereof presses against a position of the rotary base 041 facing towards the round surface of the support 03 which is not the second feel limit portion 0602. When the second feel limit portion 0602 on which the rotary base 041 rotates is directly opposite to the second feel limit block 0702, the second feel limit block 0702 correspondingly extends into the second feel limit portion 0602, so as to generate a feel different from that of pressing against the round surface of the rotary base 041, and a sense of detent is generated between two different hand feelings. Thus, the user's favorable feeling of use is improved, the user's experience of using the power converter is improved, and the user is prompted that the power converter has been rotated to a specific position, so as to facilitate the user to grasp the rotation condition of the plug assembly 04. The rotary base 041 can be limited, and can be stopped at this position without external force, so as to facilitate the user's use.

### Third Embodiment

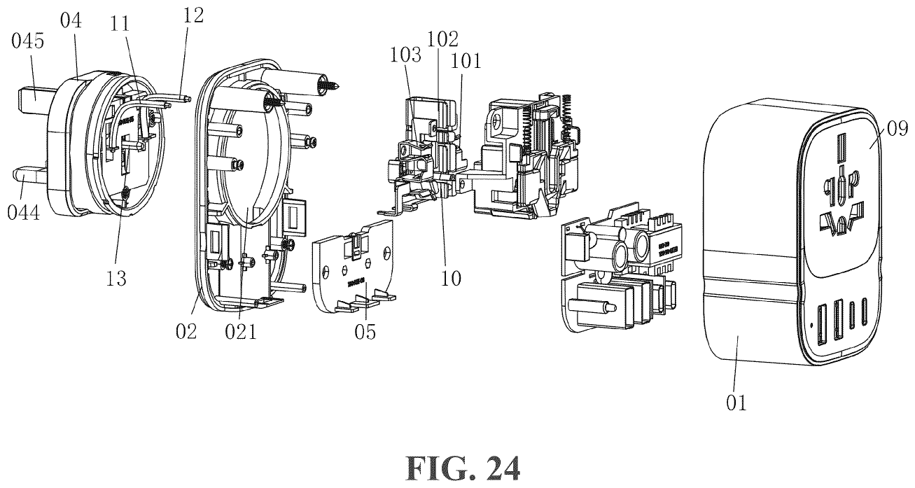

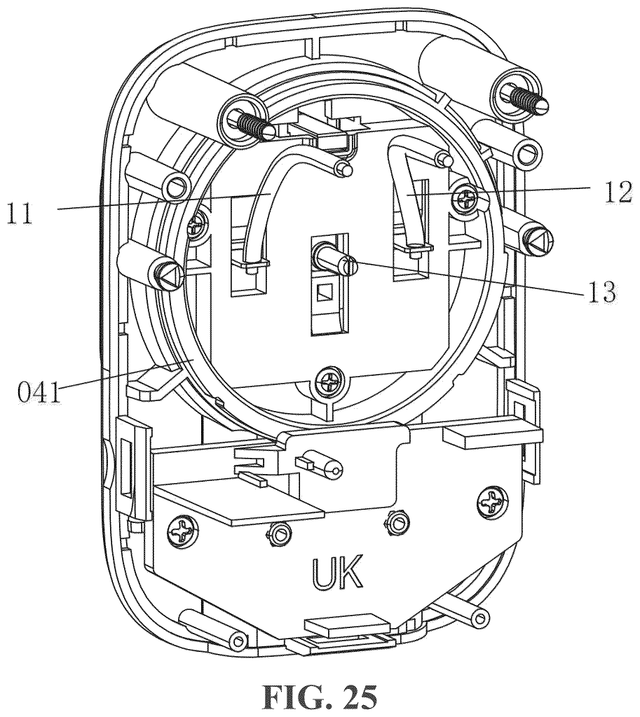

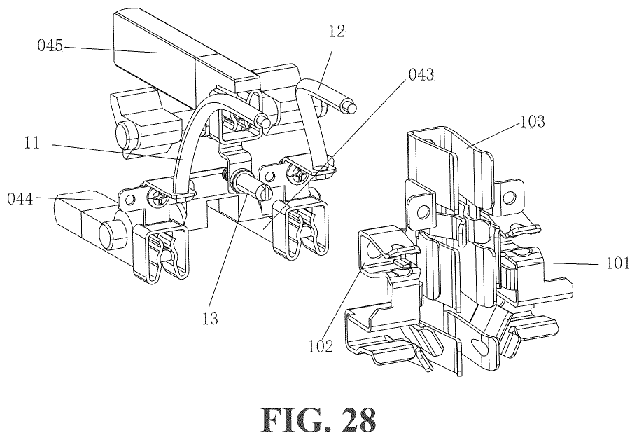

The present invention also includes a power converter, as shown in FIGS. 1-28, including a pin rotation structure in any one of the above-mentioned first to second embodiments, a socket panel 09 disposed on an upper cap 01, and a socket assembly 10 disposed between the upper cap 01 and the lower cap 02. The socket assembly 10 includes a socket live wire conductive clip 101 disposed on a support 03 and matched with the socket panel 09, and a socket neutral wire conductive clip 103 disposed on the support 03 and matched with the socket panel 09. The plug assembly 04 further includes a live wire pin 043 disposed between the upper cap 01 and the lower cap 02, and a neutral wire pin 044 disposed between the upper cap 01 and the lower cap 02. The socket neutral wire conductive clip 103 and the neutral wire pin 044 are electrically connected via a flexible neutral wire connecting line 11. The socket live wire conductive clip 101 and the live wire pin 043 are electrically connected via a flexible live wire connecting line 12. The connection line between the above-mentioned two is arranged as a flexible conductive line structure, so as to be more matched with the rotating structure of the plug assembly 04, the plug assembly 04 can be rotated while ensuring a smooth degree of conduction, so as to facilitate the cooperation between various components.

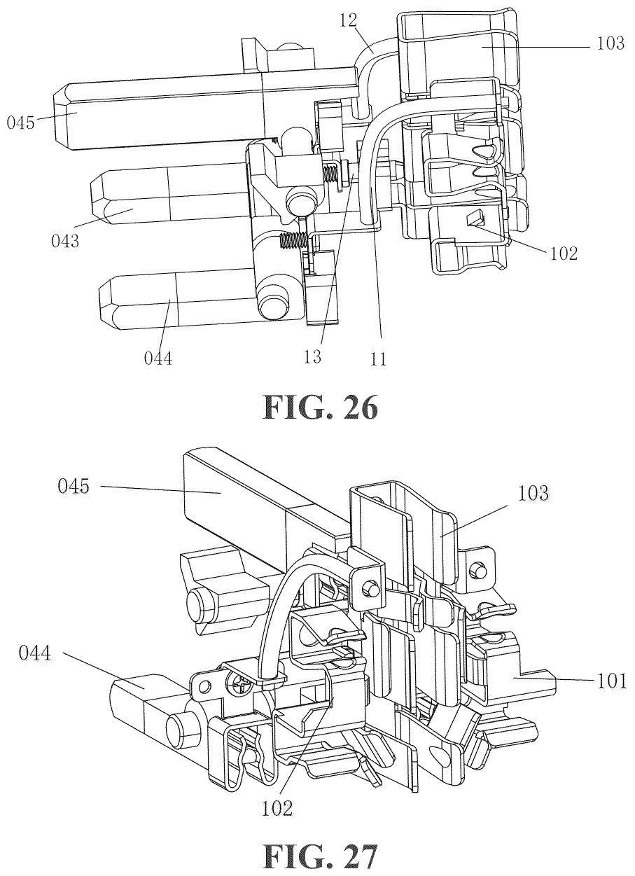

Preferably, as shown in FIGS. 26-28, the socket assembly 10 further includes a socket ground wire conductive clip 102 disposed on the support 03 and matched with the socket panel 09. The plug assembly 04 further includes a ground wire pin 045 disposed between the upper cap 01 and the lower cap 02. The socket ground wire conductive clip 102 and the ground wire pin 045 are electrically connected by the ground wire connector 13. By arranging the flexible ground connection piece 13 as a flexible conductive line structure, so as to be more matched with the rotating structure of the plug assembly 04, the smooth degree of conduction is ensured while the plug assembly 04 rotates, so as to facilitate the cooperation between various components.

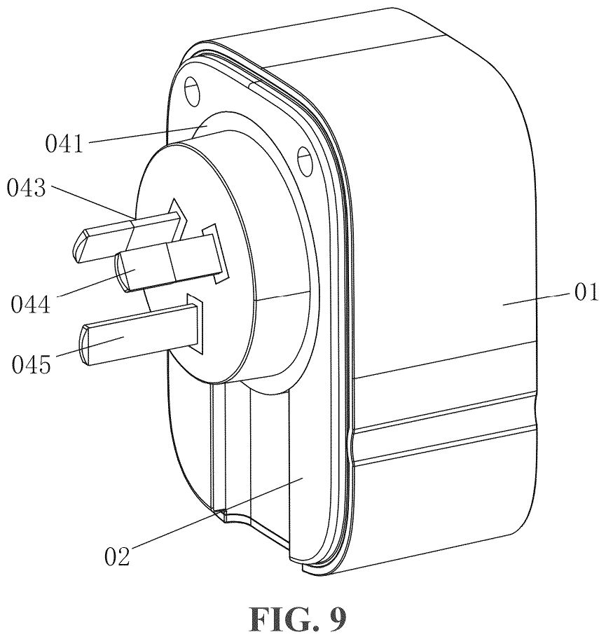

With regard to the specific structural arrangement of the socket panel 09, as shown in FIGS. 9 to 16, the socket panel 09 includes any one of or a combination of at least two of a German standard socket, an Australian standard socket, a American standard socket, an Italian standard socket, a Swiss standard socket, an Indian standard socket or a United Kingdom standard socket, which can be specifically arranged according to the actual situation, and thus is not particularly limited in the present embodiment.

### Fourth Embodiment

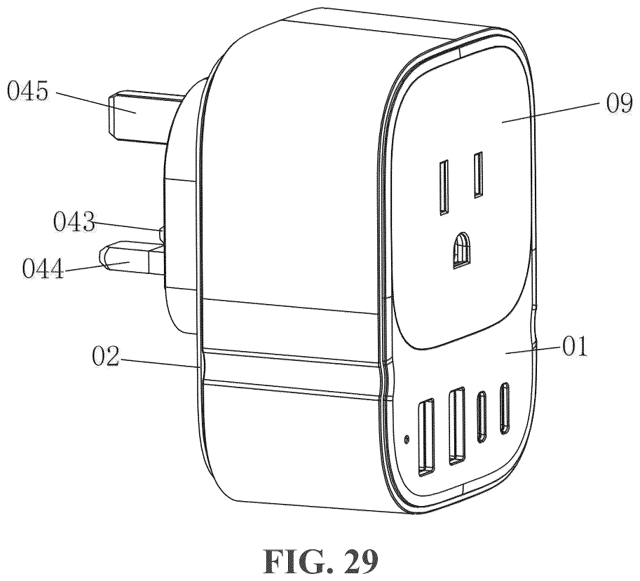

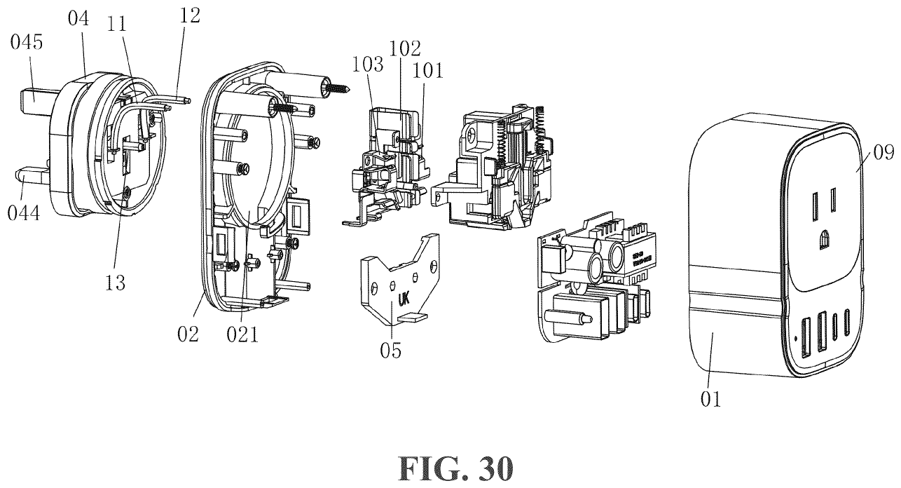

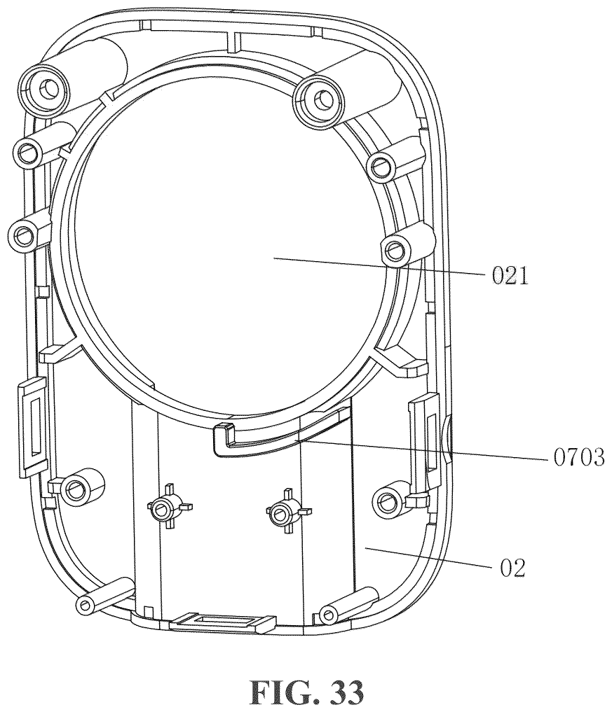

A pin rotation structure for a power converter, as shown in FIGS. 29 to 33, includes an upper cap 01, a lower cap 02 covered to the upper cap 01, and a support 03 disposed between the upper cap 01 and the lower cap 02. The pin rotation structure further includes a plug assembly 04 rotatably disposed on the lower cap 02. The plug assembly 04 includes a rotary base 041 rotatably disposed on the lower cap 02, and a plug body 042 disposed on the rotary base 041. At least one feel limit portion 06 is formed on the rotary base 041. A rotation avoidance hole 021 for placing the rotary base 041 in rotation is disposed on the lower cap 02. The pin rotation structure further includes a feel limit mechanism 07 disposed on the lower cap 02. The feel limit mechanism 07 and the feel limit portion 06 interfere with each other and are matched with each other when the rotary base 041 rotates.

The specific structure of the plug assembly 04 is the same as that of the first embodiment.

The arrangement of the feel limit mechanism 07 and the feel limit portion 06 is the same as that of the first embodiment.

The specific structure and arrangement of the feel limit portion 06 are the same as those in the first embodiment.

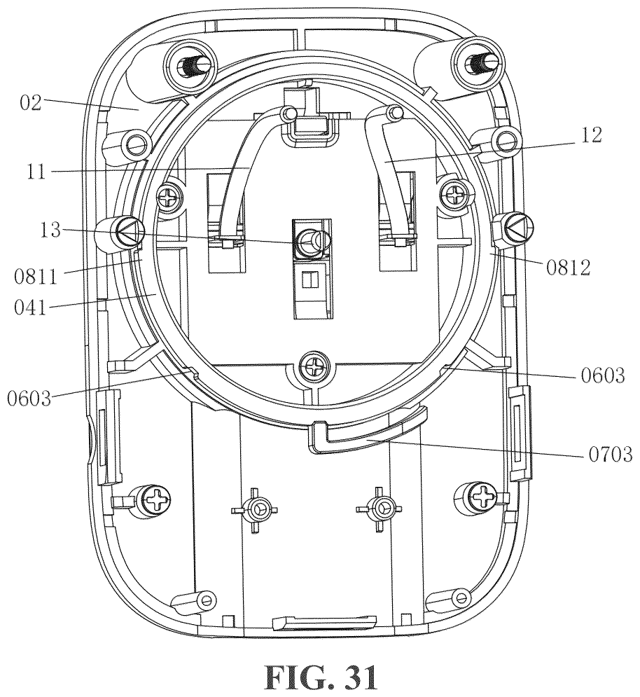

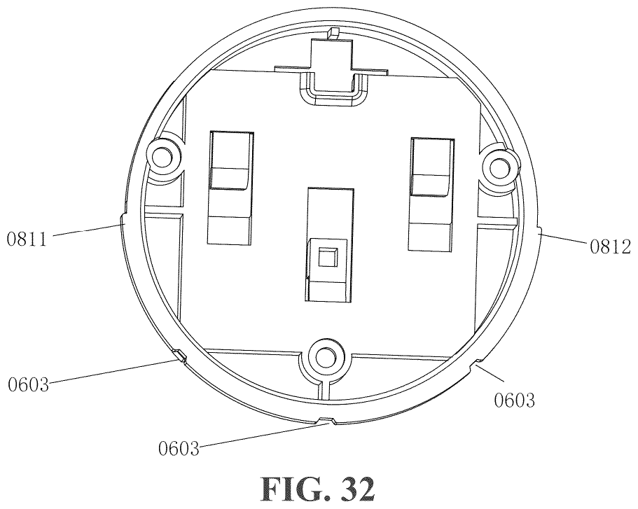

In order to prevent the rotary base 041 from rotating excessively, as shown in FIGS. 31 and 32, the present pin rotation structure further includes a rotation limit assembly 08 disposed between the upper cap 01 and the lower cap 02. The rotation limit assembly 08 includes a rotation limit step 081 and a rotation limit block (not shown in the figure). The rotation restricting step 081 is disposed on the outer edge of the rotary base 041. The rotation limit block is disposed at the edge of the rotation avoidance hole 021. After the rotation limit step 081 is rotated until pressed against the rotation limit block, the rotation limit block prevents the rotation limit step 081 from continuing to rotate, so as to prevent the plug assembly 04 disposed on the rotary base 041 from over-rotating, resulting in the problem of knotting or breaking of the internal connection structure, etc., thus ensuring the safety of the present pin rotation structure.

With regard to the specific structure of the rotation limit step 081, as shown in FIGS. 31 and 32, the rotation limit step 081 includes a first rotation limit step 0811 and/or a second rotation limit step 0812 respectively disposed on the rotary base 041, and the symmetrically provided structure thereof is more consistent with the structure of a circular rotary base 041, so that the rotary base 041 can be limited during rotation regardless of whether the first rotation limit step 0811 or the second rotation limit step 0812 thereof is pressed against the rotation limit block. Therefore, the rotational stroke of the plug assembly 04 is better limited, preventing the problem that the internal connection structure is knotted or broken due to the excessive rotation of the plug assembly 04 disposed on the rotary base 041. This guarantees the safety of the pin rotary structure. The first rotation limit step 0811 and the second rotation limit step 0812 may be used alone or in combination.

The specific structural arrangement of the plug body 042 is the same as that of the first embodiment.

According to the specific structure of the feel limit portion 06 and the feel limit mechanism 07, as shown in FIGS. 31 to 33, the feel limit portion 06 includes a plurality of third feel limit portions 0603 which are disposed on the outer ring of the rotary base 041 and are recessed inwards. The feel limit mechanism 07 includes a third feel limit block 0703 which is disposed on the lower cap 02 and has a “└” hook shape as a whole. The top end of the hook of the third feel limit block 0703 and the third feel limit portion 0603 interfere with each other when the rotary base 041 rotates. The third feel limit block 0703 is a plastic elastic member. When in use, the top end of the hook of the fourth feel limit block 0704 is pressed against the outer ring of the rotary base 041. When the third feel limit portion 0603 on which the rotary base 041 is rotated is directly opposite to the third feel limit block 0703, the top end of the hook on the third feel limit block 0703 is correspondingly placed into the third feel limit portion 0603, so as to generate a different hand feeling from that of pressing against the non-recessed part of the outer ring of the rotary base 041, and a sense of detent is generated between the two different hand feelings, thereby improving a user's good feeling of use. The use experience of the power converter is improved, and the user is prompted that the power converter has been rotated to a specific position, so as to facilitate the user to grasp the rotation condition of the plug assembly 04. The rotary base 041 can be limited, and can be stopped at this position without any external force, so as to facilitate the use by the user.

### Fifth Embodiment

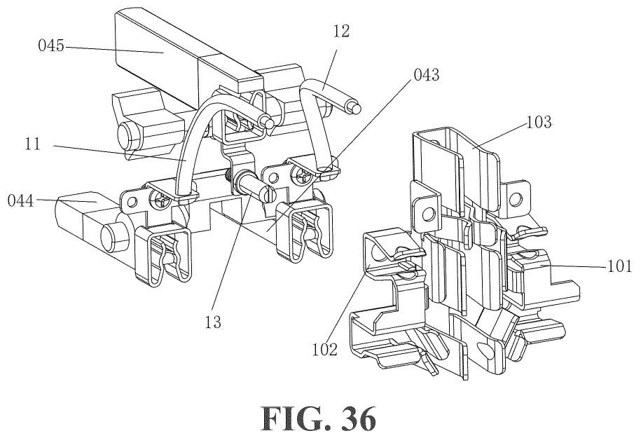

The present invention also includes a power converter, as shown in FIGS. 29-36, including the pin rotation structure in the above-mentioned fourth embodiment, a socket panel 09 disposed on an upper cap 01, and a socket assembly 10 disposed between the upper cap 01 and the lower cap 02. The socket assembly 10 includes a socket live wire conductive clip 101 disposed on a support 03 and matched with the socket panel 09, and a socket neutral wire conductive clip 103 disposed on the support 03 and matched with the socket panel 09. The plug assembly 04 further includes a live wire pin 043 disposed between the upper cap 01 and the lower cap 02, and a neutral wire pin 044 disposed between the upper cap 01 and the lower cap 02. The socket neutral wire conductive clip 103 and the neutral wire pin 044 are electrically connected via a flexible neutral wire connecting line 11. The socket live wire conductive clip 101 and the live wire pin 043 are electrically connected via a flexible live wire connecting line 12. By providing the connection line between the above-mentioned two as a flexible conductive line structure, so as to be more matched with the rotating structure of the plug assembly 04, the plug assembly 04 can be rotated while ensuring a smooth degree of conduction, so as to facilitate the cooperation between various components.

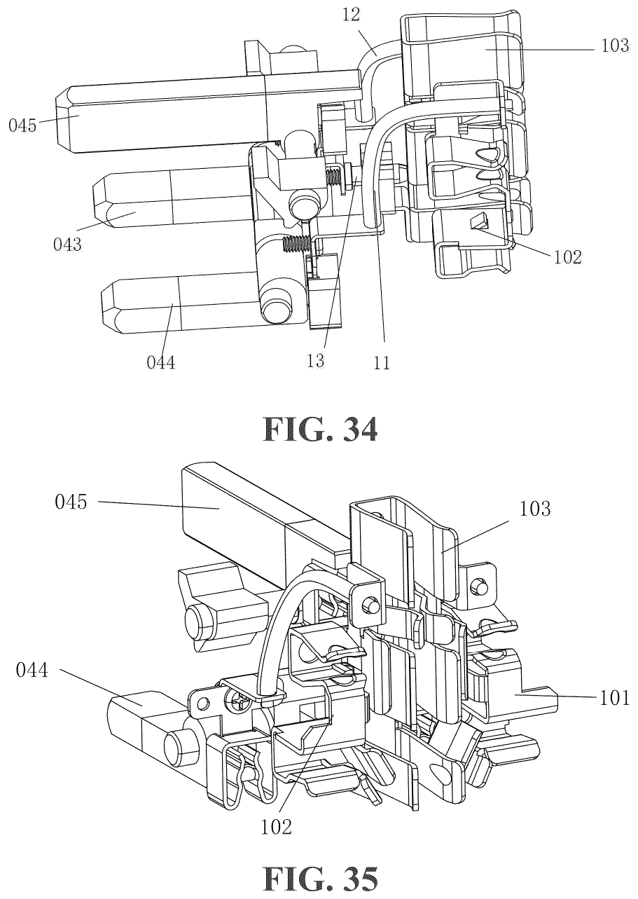

Preferably, as shown in FIGS. 34-36, the socket assembly 10 further includes a socket ground wire conductive clip 102 disposed on the support 03 and matched with the socket panel 09. The plug assembly 04 further includes a ground wire pin 045 disposed between the upper cap 01 and the lower cap 02. The socket ground wire conductive clip 102 and the ground wire pin 045 are electrically connected by the ground wire connector 13. The flexible ground wire connector 13 is arranged as a structure of a flexible conductive piece, so as to be more matched with the rotating structure of the plug assembly 04, the plug assembly 04 can be rotated while ensuring a smooth degree of conduction to facilitate the cooperation between various components.

The specific structural arrangement of the socket panel 09 is the same as that of the third embodiment.

### Sixth Embodiment

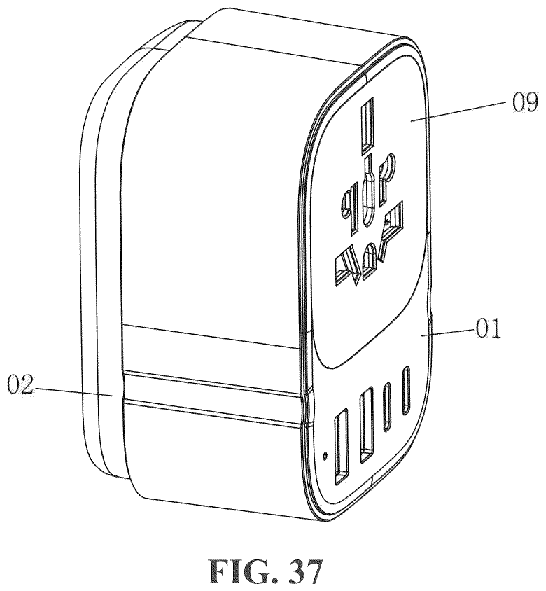

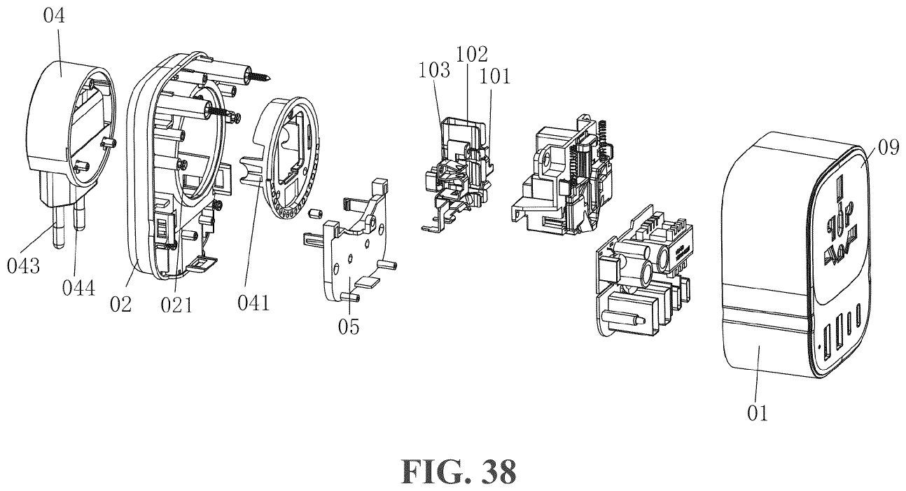

A pin rotation structure for a power converter, as shown in FIGS. 37 to 41, includes an upper cap 01, a lower cap 02 covered to the upper cap 01, a support 03 disposed between the upper cap 01 and the lower cap 02, a plug assembly 04 rotatably disposed on the lower cap 02, and a feel limit fixing plate 05 disposed between the upper cap 01 and the lower cap 02. The plug assembly 04 includes a rotary base 041 rotatably disposed on the lower cap 02, and a plug body 042 disposed on the rotary base 041. At least one feel limit portion 06 is formed on the rotary base 041, and a rotation avoidance hole 021 for placing the rotary base 041 in rotation is disposed on the lower cap 02. The pin rotation structure further includes a feel limit mechanism 07 disposed on the feel limit fixing plate 05 or the support 03. The feel limit mechanism 07 and the feel limit portion 06 interfere with each other and are matched with each other when the rotary base 041 rotates.

The specific structure of the plug assembly 04 is the same as that of the first embodiment.

The arrangement of the feel limit mechanism 07 and the feel limit portion 06 is the same as that of the first embodiment.

The specific structure and arrangement of the feel limit portion 06 are the same as those in the first embodiment.

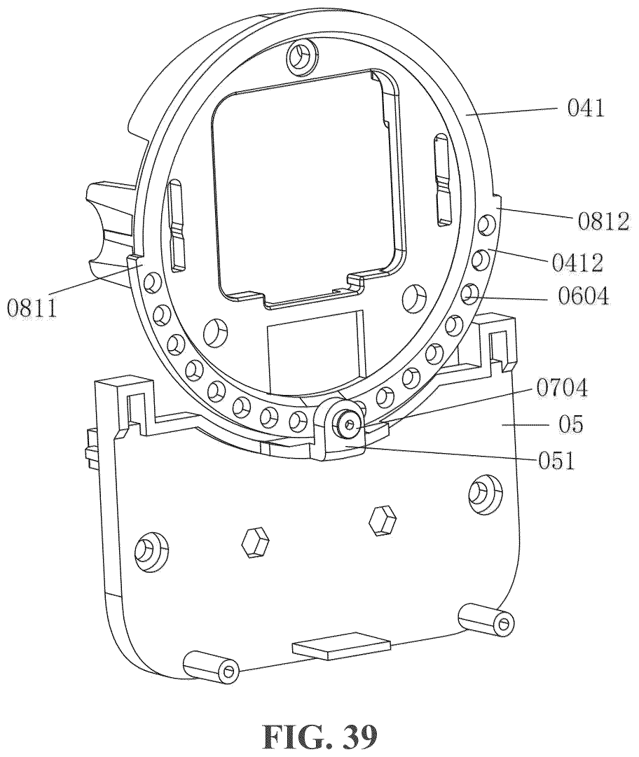

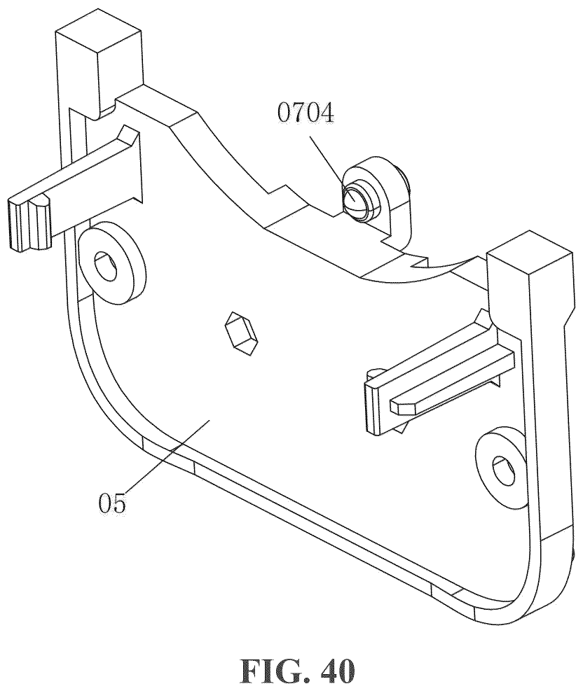

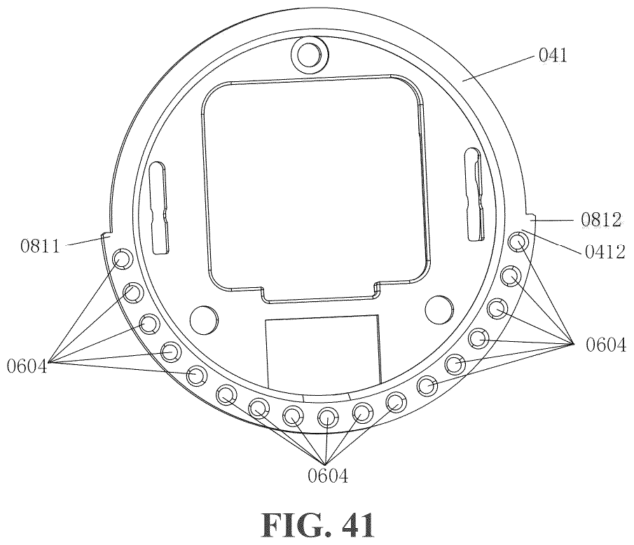

In order to prevent the rotary base 041 from over-rotating, as shown in FIGS. 39 and 41, the present pin rotation structure further includes a rotation limit assembly 08 disposed between the upper cap 01 and the lower cap 02. The rotation limit assembly 08 includes a rotation limit step 081 and a rotation limit block (not shown in the figure). The rotation restricting step 081 is disposed on the outer edge of the rotary base 041. The rotation limit block is disposed at the edge of the rotation avoidance hole 021. After the rotation limit step 081 is rotated until pressed against the rotation limit block, the rotation limit block prevents the rotation limit step 081 from continuing to rotate, so as to prevent the plug assembly 04 disposed on the rotary base 041 from over-rotating, resulting in the problem of knotting or breaking of the internal connection structure, etc., thus ensuring the safety of the present pin rotation structure.

With regard to the specific structure of the rotation limit step 081, as shown in FIGS. 39 and 41, the rotation limit step 081 includes a first rotation limit step 0811 and/or a second rotation limit step 0812 respectively disposed on the rotary base 041, and the symmetrically provided structure thereof is more consistent with the structure of a circular rotary base 041, so that the rotary base 041 can be limited during rotation regardless of whether the first rotation limit step 0811 or the second rotation limit step 0812 thereof is pressed against the rotation limit block. Therefore, the rotational stroke of the plug assembly 04 is better limited, preventing the problem that the internal connection structure is knotted or broken due to the excessive rotation of the plug assembly 04 disposed on the rotary base 041. This guarantees the safety of the pin rotary structure.

The specific structural arrangement of the plug body 042 is the same as that of the first embodiment.

With regard to the specific structural arrangement of the feel limit portion 06 and the feel limit mechanism 07, as shown in FIGS. 39 and 41, a fourth step 0412 protrudes in the direction of the rotary base 041 towards the support 03. The feel limit portion 06 includes a plurality of fourth feel limit portions 0604 disposed on the annular surface of the fourth step 0412 towards the support 03. The feel limit fixing plate 05 is provided with a fourth fixing portion 051 which is in the shape of a “┌” as a whole. The feel limit mechanism 07 includes a fourth feel limit block 0704 disposed on the fourth fixing portion 051 and protruding in the direction of the fourth feel limit portion 0604. The fourth feel limit block 0704 and the fourth feel limit portion 0604 interfere with each other when the rotary base 041 rotates. The fourth feel limit block 0704 is an elastic member and is fixed in the fourth fixing portion 051. The top end of the fourth feel limit block 0704 fixed in the fourth fixing portion 051 is directly opposite to the fourth step 0412 because the fourth fixing portion 051 has a “┌”-shaped structure. When in use, the fourth feel limit block 0704 is pressed against the position of the fourth step 0412 other than the fourth feel limit portion 0604. When the fourth feel limit portion 0604 on which the rotary base 041 is rotated is directly opposite to the fourth feel limit block 0704, the fourth feel limit block 0704 correspondingly extends into the fourth feel limit portion 0604, so as to generate a different hand feeling from that pressed against the non-recessed position of the fourth step 0412, and a sense of detent is generated between the two different hand feelings, thereby improving a user's good feeling of use. The use experience of the power converter is improved, and the user is prompted that the power converter has been rotated to a specific position, so as to facilitate the user to grasp the rotation condition of the plug assembly 04. The rotary base 041 can be limited, and can be stopped at this position without any external force, so as to facilitate the use by the user.

### Seventh Embodiment

In the sixth embodiment, the pin rotation structure has been described. In the present embodiment, the differences from the other embodiments are mainly described, and the description of the same configuration will not be repeated in the present embodiment.

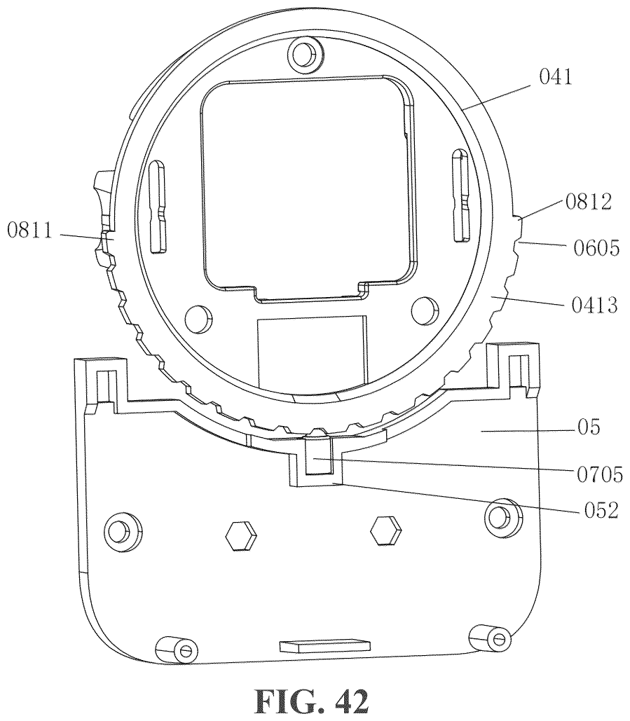

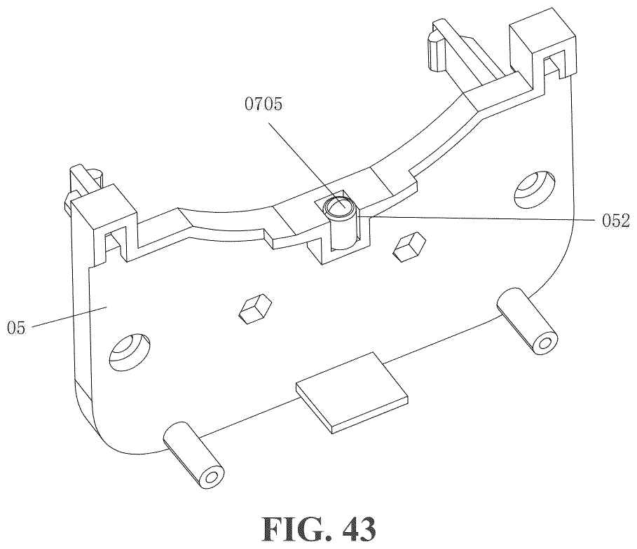

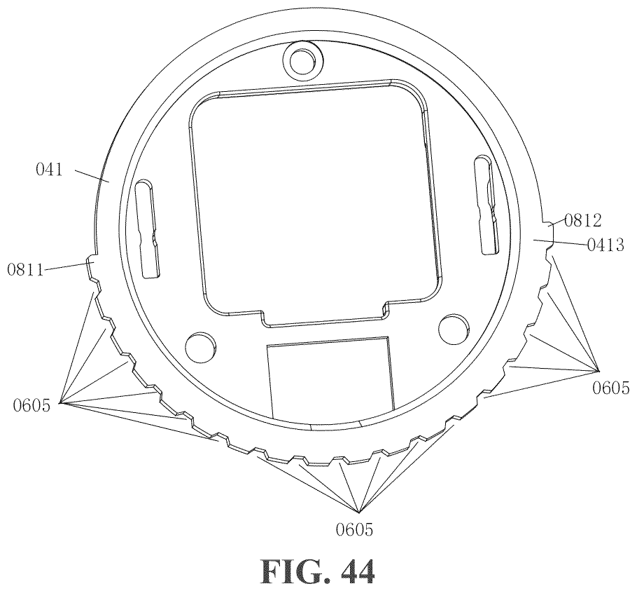

In the seventh embodiment, as shown in FIG. 42 to FIG. 44, according to the specific structure of the feel limit portion 06 and the feel limit mechanism 07, a fifth step 0413 protrudes in the direction of the rotary base 041 towards the support 03. The feel limit portion 06 includes a plurality of fifth feel limit portions 0605 disposed on the outer wall of the fifth step 0413 towards the feel limit fixing plate 05. The feel limit fixing plate 05 is provided with a fifth fixing portion 052 that is recessed in the direction away from the rotary base 041. The feel limit mechanism 07 includes a fifth feel limit block 0705 disposed on the fifth fixing portion 052 and protruding in the direction of the fifth feel limit portion 0605. The fifth feel limit block 0705 and the fifth feel limit portion 0605 interfere with each other when the rotary base 041 is rotated. The fifth feel limit block 0705 is an elastic member. When in use, the fifth feel limit block 0705 is fixed at a recessed position of the fifth fixing portion 052 so as to achieve fixing, and the front end thereof presses against the outer wall of the fifth step 0413 facing towards the feel limit fixing plate 05. When the rotary base 041 is rotated to a position where the fifth feel limit portion 0605 thereon is directly opposite to the fifth feel limit block 0705, the fifth feel limit block 0705 correspondingly protrudes into the fifth feel limit portion 0605, thereby generating a different hand feeling from pressing against the non-recessed position of the fifth step 0413, and a sense of detent is generated between two different hand feelings. Thus, the user's favorable feeling of use is improved, the user's experience of using the power converter is improved, and the user is prompted that the power converter has been rotated to a specific position, so as to facilitate the user to grasp the rotation condition of the plug assembly 04. The rotary base 041 can be limited, and can be stopped at this position without external force, so as to facilitate the user's use.

### Eighth Embodiment

In the sixth embodiment, the pin rotation structure has been described. In the present embodiment, the differences from the other embodiments are mainly described, and the description of the same configuration will not be repeated in the present embodiment.

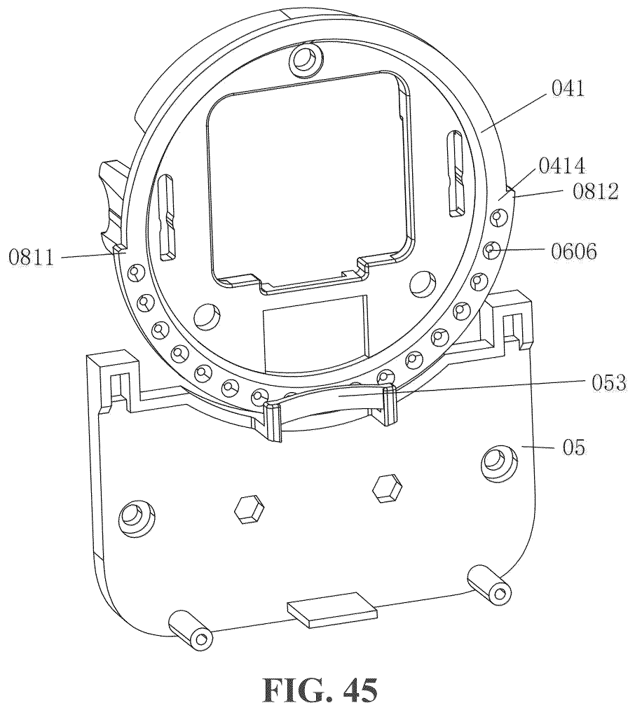

In the eighth embodiment, as shown in FIG. 45 to FIG. 47, according to the specific structure of the feel limit portion 06 and the feel limit mechanism 07, a sixth step 0414 protrudes in the direction of the rotary base 041 towards the support 03. The feel limit portion 06 includes a plurality of sixth feel limit portions 0606 disposed on the circumferential surface of the fourth step 0412 towards the support 03, and the feel limit fixing plate 05 is formed with a sixth fixing plate 053 which has a shape of a cross-bar and has an overall shape of a “┌” . The feel limit mechanism 07 includes a sixth feel limit block 0706 disposed on the sixth fixing plate 053 and protruding towards the sixth feel limit portion 0606. The sixth feel limit block 0706 and the sixth feel limit portion 0606 interfere with each other when the rotary base 041 rotates. The sixth fixing plate 053 or the sixth feel limit block 0706 is an elastic member. When in use, the sixth feel limit block 0706 is pressed against the sixth step 0414. When the sixth feel limit portion 0606 on which the rotary base 041 is rotated is directly opposite to the sixth feel limit block 0706, the sixth feel limit block 0706 is correspondingly placed into the sixth feel limit portion 0606, so as to generate a different hand feeling from that of pressing against the non-recessed part of the sixth step 0414, and a sense of detent is generated between the two different hand feelings, so as to improve a user's good use feel and improve the use experience of the power converter. In addition, it is prompted that the user has rotated to a specific position, so as to facilitate the user to grasp the rotation condition of the plug assembly 04, and it is also feasible to limit the rotary base 041 and stop at this position without external force, so as to facilitate the user to use it.

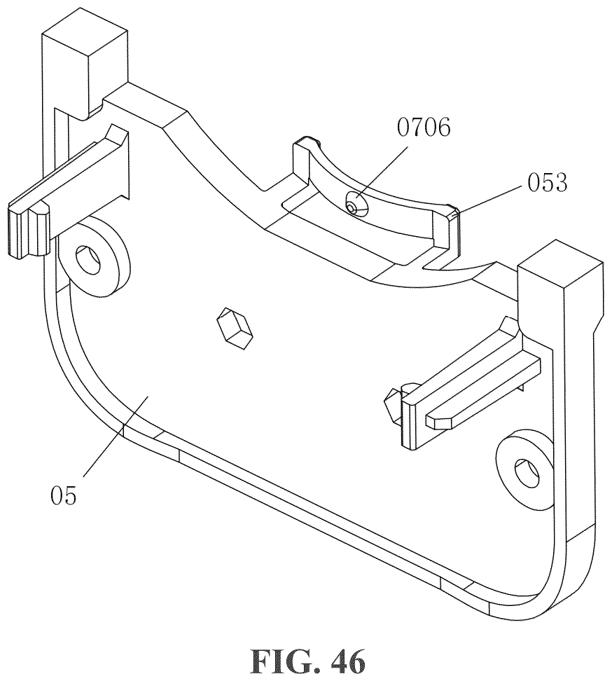

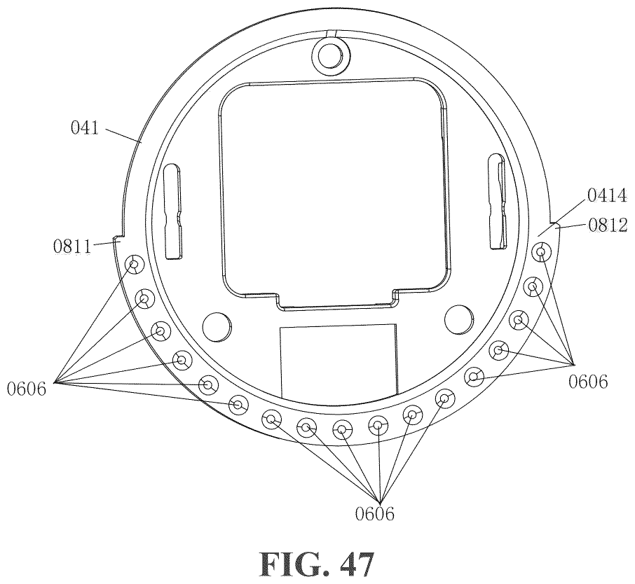

Preferably, the sixth fixing plate 053 has a lateral portion being arc-shaped right with respect to the circular surface of the rotary base 041, as shown in FIGS. 45 to 46, so that the sixth feel limit block 0706 provided thereon is closer to the rotary base 041, improving the accuracy and efficiency in which the sixth feel limit block 0706 and the sixth feel limit portion 0606 interfere with each other and are matched with each other.

### Ninth Embodiment

In the sixth embodiment, the pin rotation structure has been described. In the present embodiment, the differences from the other embodiments are mainly described, and the description of the same configuration will not be repeated in the present embodiment.

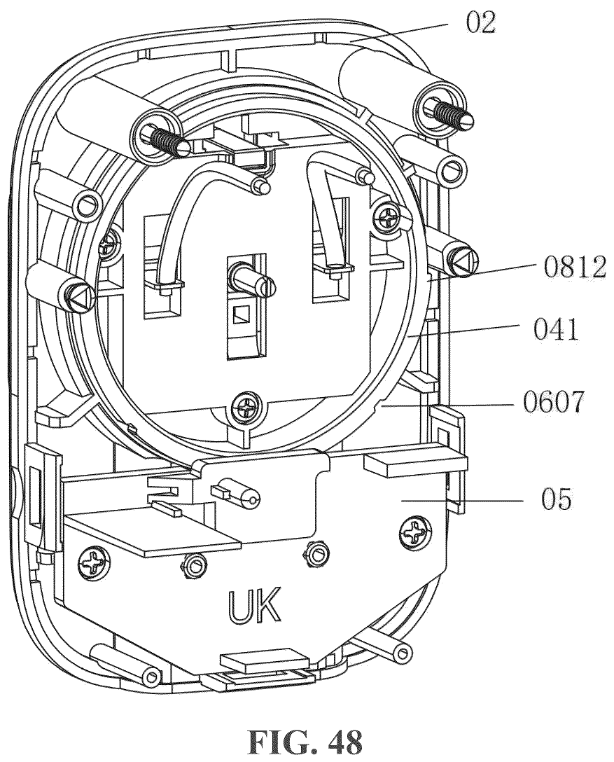

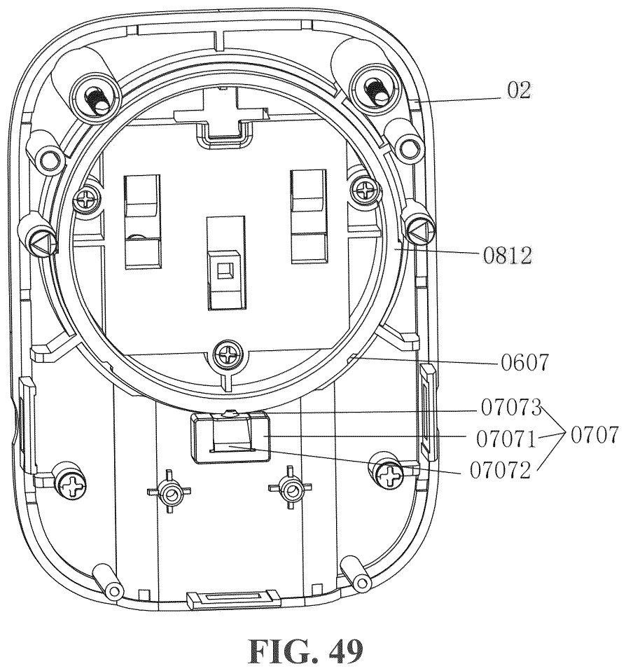

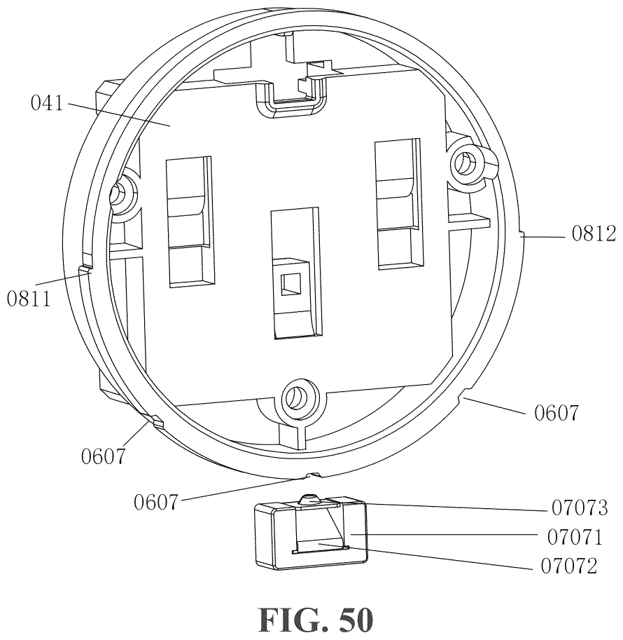

In the ninth embodiment, as shown in FIG. 48 to FIG. 52, the specific structure of the feel limit portion 06 and the feel limit mechanism 07 is as follows. The feel limit portion 06 includes a plurality of seventh feel limit portions 0607 disposed on the outer ring of the rotary base 041 and recessed inwards. The feel limit mechanism 07 includes a seventh feel limit mechanism 0707 disposed on the feel limit fixing plate 05. The seventh feel limit mechanism 0707 includes a seventh mounting seat 07071 disposed on the feel limit fixing plate 05, a seventh elastic member 07072 disposed in the mounting seat and formed in a zigzag shape as a whole, and a seventh feel limit block 07073 formed on the seventh elastic member 07072 and protruding towards the seventh feel limit portion 0607. The seventh feel limit block 07073 and the seventh feel limit portion 0607 interfere with each other when the rotary base 041 rotates. The seventh elastic member 07072 provides an elastic force to push out the seventh feel limit block 07073 towards the rotary base 041. When in use, the seventh feel limit block 07073 is pressed against a side edge of the rotary base 041. When the seventh feel limit portion 0607 on which the rotary base 041 is rotated is directly opposite to the seventh feel limit block 07073 on the seventh mounting seat 07071, the seventh feel limit block 07073 correspondingly extends into the seventh feel limit portion 0607, so as to generate a different hand feeling from that of pressing against the side edge of the rotary base 041, and a sense of detent is generated between the two different hand feelings, thereby improving a user's good feeling of use. The use experience of the power converter is improved, and the user is prompted that the power converter has been rotated to a specific position, so as to facilitate the user to grasp the rotation condition of the plug assembly 04. The rotary base 041 can be limited, and can be stopped at this position without any external force, so as to facilitate the use by the user.

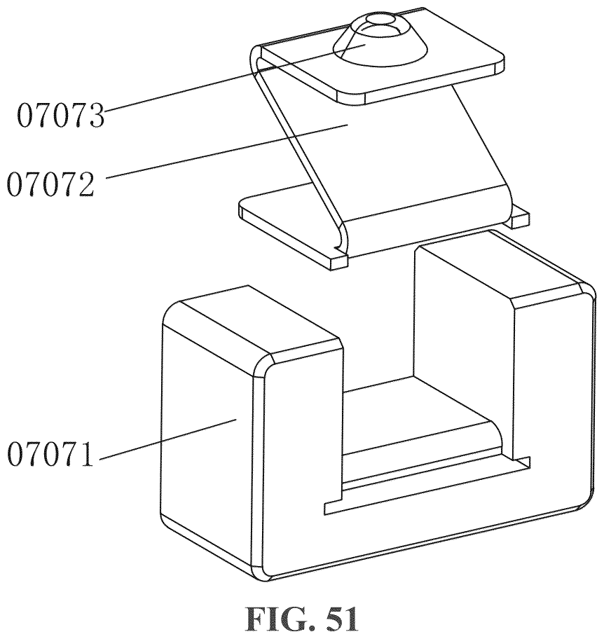

Preferably, as shown in FIG. 51, two sides of the bottom end of the seventh elastic member 07072 are respectively formed with fixing plates extending to the outside, and two sides of the bottom inside of the seventh mounting seat 07071 are formed with insertion grooves matched with the fixing plates. The fixing plates are correspondingly inserted into the insertion grooves, so as to fix the seventh elastic member 07072 and the seventh feel limit block 07073 in the seventh mounting seat 07071.

Of course, the seventh elastic member 07072 and the seventh feel limit block 07073 may be integrally formed on the seventh mounting seat 07071.

With regard to the specific structural arrangement of the seventh elastic member 07072, as shown in FIG. 51, the seventh elastic member 07072 is an elastic member with a Z-shape as a whole. The elastic member has low price, and high durability. The production cost is effectively reduced, and the normal operation of the pin rotation structure is ensured.

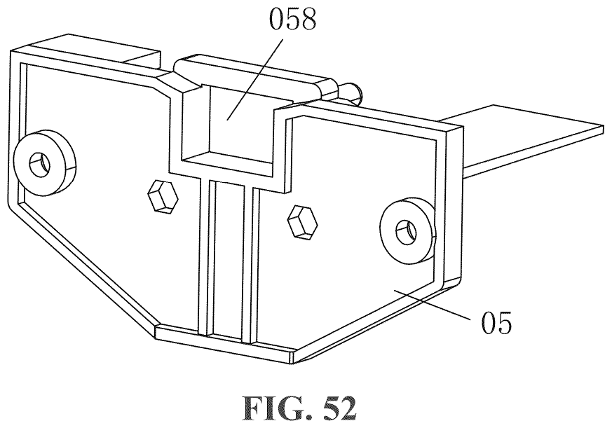

With regard to the specific method for fixing the seventh mounting seat 07071, as shown in FIGS. 51 and 52, a seventh mounting groove 058 for inserting the seventh mounting seat 07071 is formed on the inner wall of the feel limit fixing plate 05 facing in the direction of the seventh mounting seat 07071. The seventh mounting seat 07071 is correspondingly inserted into the seventh mounting groove 058. When the feel limit fixing plate 05 is fixed on the lower cap 02, the seventh mounting seat 07071 is fixed on the lower cap 02 at the same time, so as to fix the seventh mounting seat 07071.

### Tenth Embodiment

In the sixth embodiment, the pin rotation structure has been described. In the present embodiment, the differences from the other embodiments are mainly described, and the description of the same configuration will not be repeated in the present embodiment.

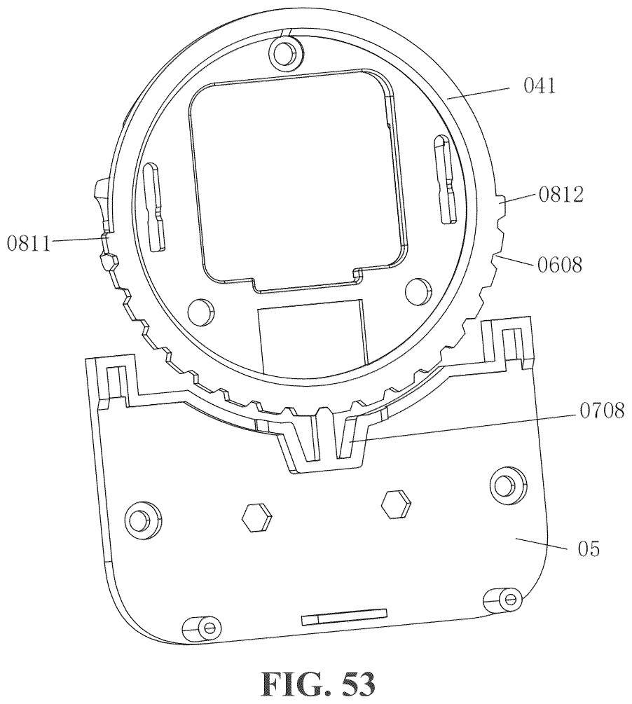

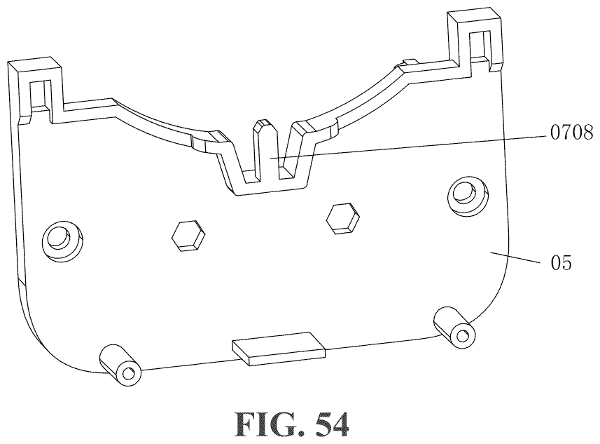

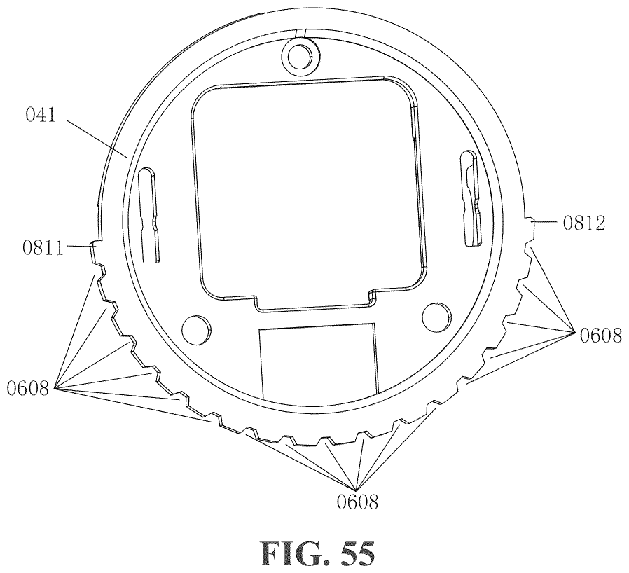

In the tenth embodiment, as shown in FIG. 53 to FIG. 55, according to the specific structure of the feel limit portion 06 and the feel limit mechanism 07, the feel limit portion 06 includes a plurality of eighth feel limit portions 0608 disposed on the outer ring of the rotary base 041 and recessed inwards. The feel limit mechanism 07 includes an eighth feel limit block 0708 formed on the feel limit fixing plate 05 and having a ILI-shaped character as a whole. The middle raised portion of the eighth feel limit block 0708 and the eighth feel limit portion 0608 interfere with each other when the rotary base 041 is rotated. The raised portion in the middle of the [symbol] -shaped character of the eighth feel limit block 0708 is an elastic member. When in use, the [symbol] -shaped character middle raised portion of the eighth feel limit block 0708 is pressed against the outer ring of the rotary base 041. When the eighth feel limit portion 0608 on which the rotary base 041 is rotated is directly opposite to the eighth feel limit block 0708, the [symbol] -shaped character middle raised portion of the eighth feel limit block 0708 is correspondingly inserted into the eighth feel limit portion 0608, so as to generate a different hand feeling from that of the non-recessed part on the outer ring of the rotary base 041, and a sense of detent is generated between the two different hand feelings, thereby improving a user's good feeling of use. The use experience of the power converter is improved, and the user is prompted that the power converter has been rotated to a specific position, so as to facilitate the user to grasp the rotation condition of the plug assembly 04. The rotary base 041 can be limited, and can be stopped at this position without any external force, so as to facilitate the use by the user.

The connection blocks on the two sides of the [symbol] -shaped character on the eighth feel limit block 0708 can be disposed in an inclined manner or in a vertical manner, and can be adjusted according to actual situations. Therefore, no specific restriction is made in this embodiment.

### Eleventh Embodiment

In the sixth embodiment, the pin rotation structure has been described. In the present embodiment, the differences from the other embodiments are mainly described, and the description of the same configuration will not be repeated in the present embodiment.

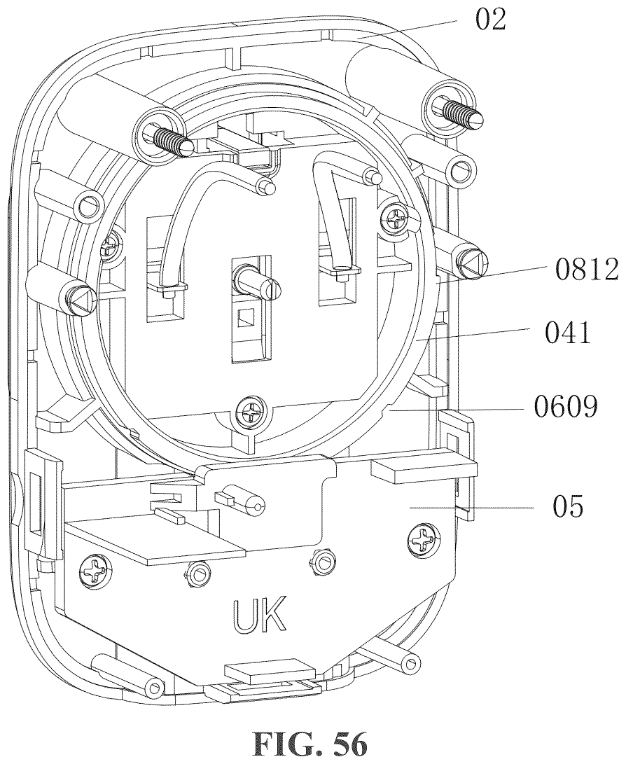

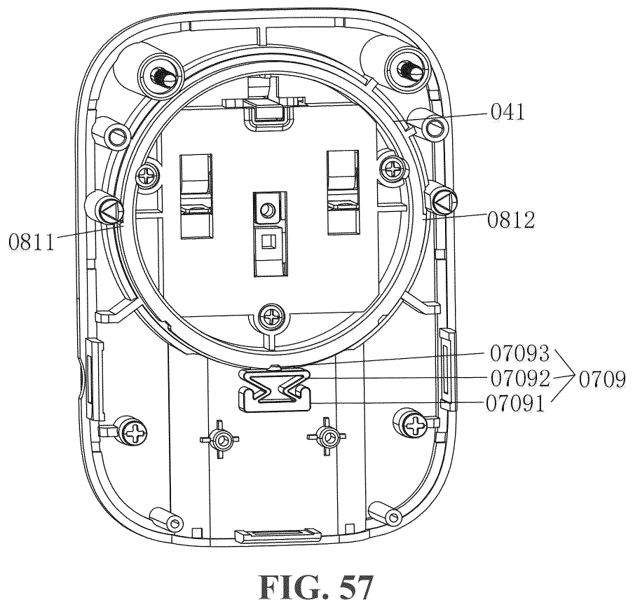

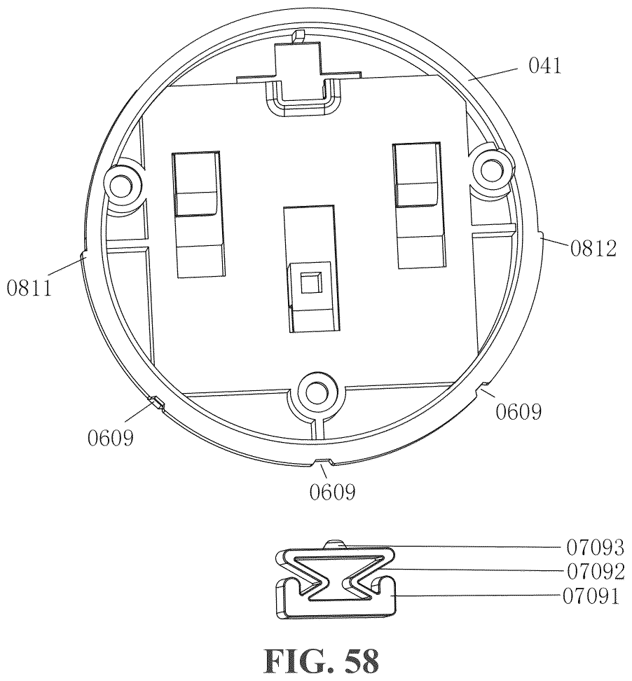

In the eleventh embodiment, as shown in FIG. 56 to FIG. 59, according to the specific structure of the feel limit portion 06 and the feel limit mechanism 07, the feel limit portion 06 includes a plurality of ninth feel limit portions 0609 disposed on the outer ring of the rotary base 041 and recessed inwards. The feel limit mechanism 07 includes a ninth feel limit mechanism 0709 disposed on the feel limit fixing plate 05. The ninth feel limit mechanism 0709 includes a ninth mounting seat 07091 disposed on the feel limit fixing plate 05, a ninth elastic member 07092 which is integrally formed on the ninth mounting seat 07091 and is M-shaped on both sides, a ninth feel stop block 07093 which is formed on the ninth elastic member 07092 and protrudes towards the ninth feel limit portion 0609. The ninth feel stop block 07093 and the ninth feel limit portion 0609 interfere with each other when the rotary base 041 rotates. The ninth elastic member 07092 provides an elastic force to push out the ninth feel limit block 07093 in the direction of the rotary base 041. When in use, the ninth feel limit block 07093 is pressed against the side edge of the rotary base 041. When the ninth feel limit block 07093 on which the rotary base 041 is rotated is directly opposite to the ninth feel limit block 07093 on the ninth mounting seat 07091, the ninth feel limit block 07093 correspondingly extends into the ninth feel limit portion 0609, so as to generate a feel different from the feel pressed against the side edge of the rotary base 041, and a sense of detent is generated between the two different hand feelings, thereby improving a user's good feeling of use. The use experience of the power converter is improved, and the user is prompted that the power converter has been rotated to a specific position, so as to facilitate the user to grasp the rotation condition of the plug assembly 04. The rotary base 041 can be limited, and can be stopped at this position without any external force, so as to facilitate the use by the user.

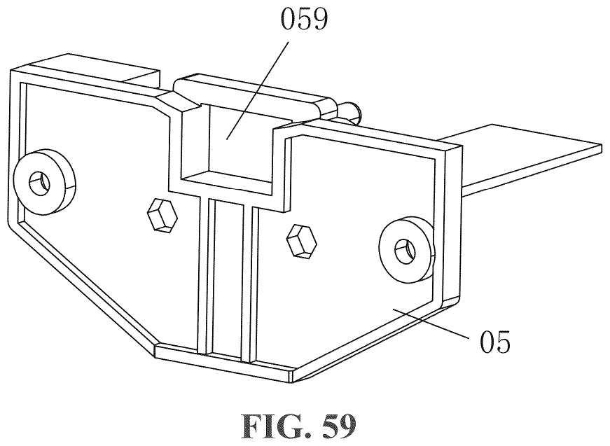

With regard to the specific method for fixing the ninth mounting seat 07091, as shown in FIGS. 56 and 59, a ninth mounting groove 059 for inserting the ninth mounting seat 07091 is formed on the inner wall of the feel limit fixing plate 05 facing in the direction of the ninth mounting seat 07091. The ninth mounting seat 07091 is correspondingly inserted into the ninth mounting groove 059. When the feel limit fixing plate 05 is fixed on the lower cap 02, the ninth mounting seat 07091 is fixed on the lower cap 02 at the same time, so as to fix the ninth mounting seat 07091.

### Twelfth Embodiment

In the sixth embodiment, the pin rotation structure has been described. In the present embodiment, the differences from the other embodiments are mainly described, and the description of the same configuration will not be repeated in the present embodiment.

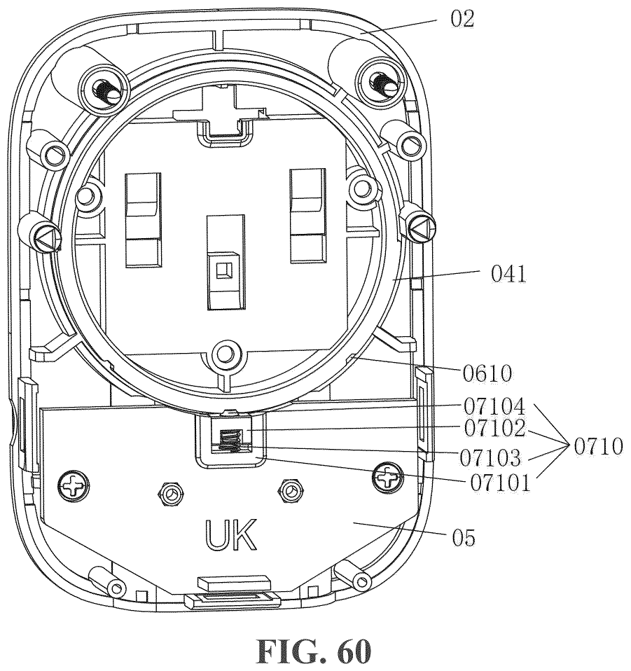

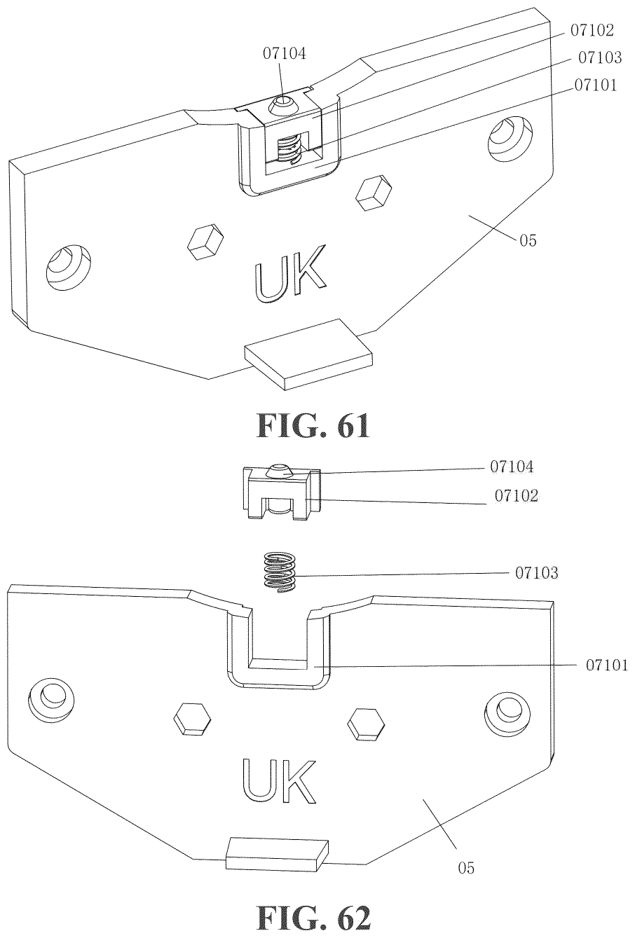

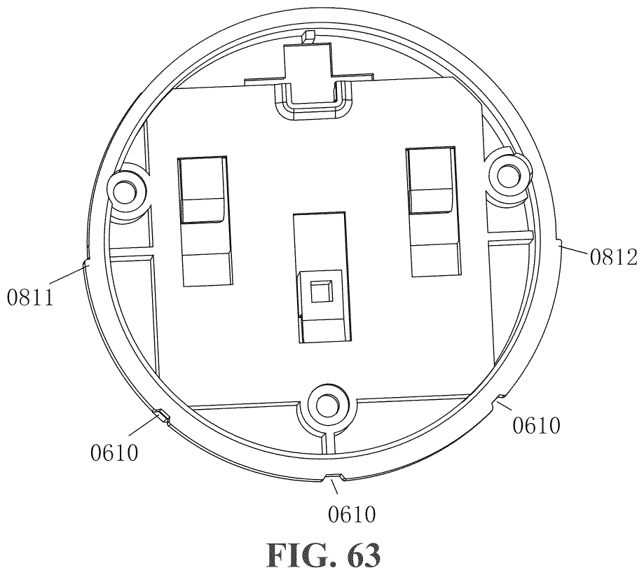

In the twelfth embodiment, as shown in FIG. 60 to FIG. 63, according to the specific structure of the feel limit portion 06 and the feel limit mechanism 07, the feel limit portion 06 includes a plurality of tenth feel limit portions 0610 which are disposed on the outer ring of the rotary base 041 and are recessed inwards. The feel limit mechanism 07 includes a tenth feel limit mechanism 0710 which is disposed on the feel limit fixing plate 05. The tenth feel limit mechanism 0710 includes a tenth mounting seat 07101 which is disposed on the feel limit fixing plate 05, a tenth feel limit member 07102 provided in the tenth mounting seat 07101, a tenth elastic member 07103 disposed between the tenth mounting seat 07101 and the tenth feel limit member 07102, and a tenth feel limit block 07104 formed on the tenth feel limit member 07102 and protruding towards the tenth feel limit portion 0610. The tenth feel limit block 07104 and the tenth feel limit portion 0610 interfere with each other when the rotary base 041 rotates. The tenth elastic member 07103 provides an elastic force to push out the tenth feel limit block 07104 in the direction of the rotary base 041. When in use, the tenth feel limit block 07104 is pressed against the side edge of the rotary base 041. When the tenth feel limit portion 0610 on which the rotary base 041 is rotated is directly opposite to the tenth feel limit block 07104 on the tenth mounting seat 07101, the tenth feel limit block 07104 correspondingly extends into the tenth feel limit portion 0610, so as to generate a different hand feeling from that of pressing against the side edge of the rotary base 041, and a sense of detent is generated between the two different hand feelings, thereby improving a user's good feeling of use. The use experience of the power converter is improved, and the user is prompted that the power converter has been rotated to a specific position, so as to facilitate the user to grasp the rotation condition of the plug assembly 04. The rotary base 041 can be limited, and can be stopped at this position without any external force, so as to facilitate the use by the user.

Preferably, as shown in FIG. 62, the tenth elastic member 07103 is a spring, which has low price and high durability, effectively reduces the production cost and ensures the normal operation of the pin rotation structure.

### Thirteenth Embodiment

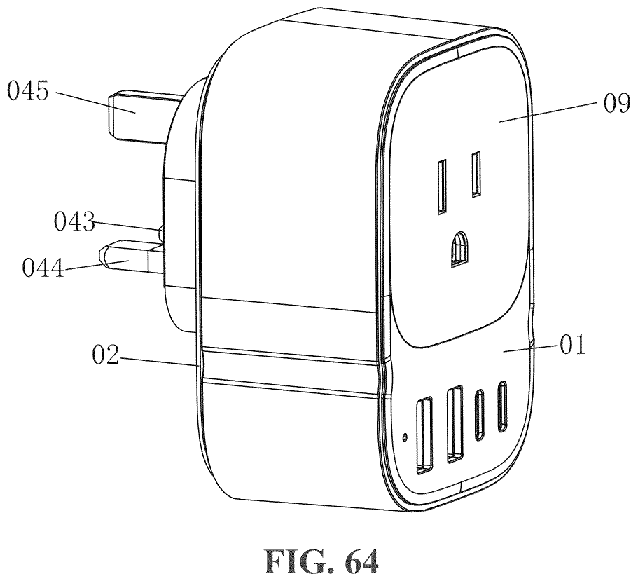

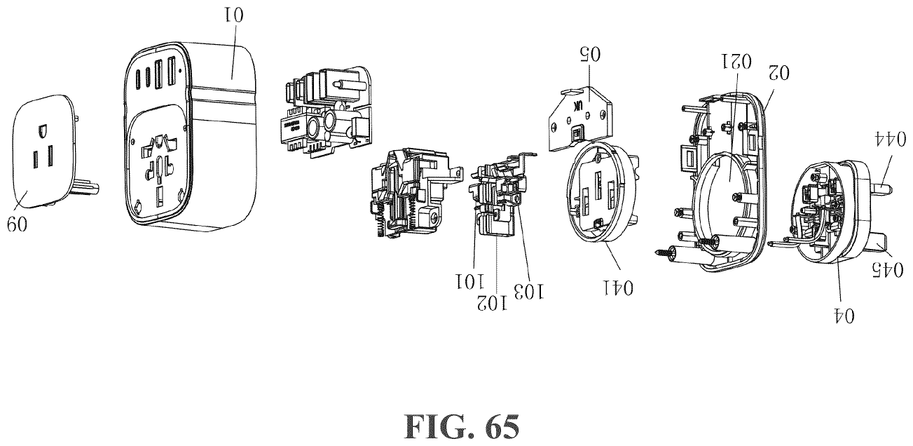

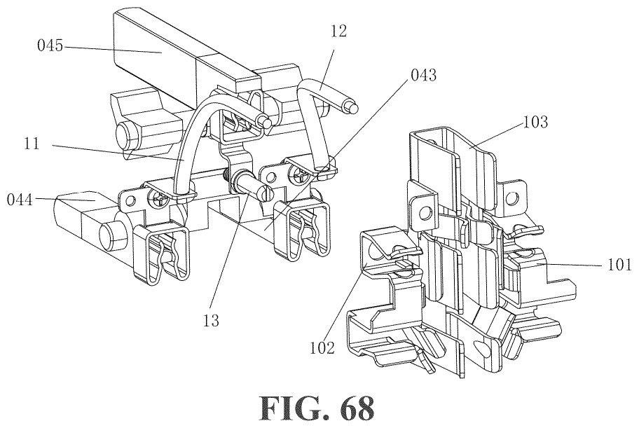

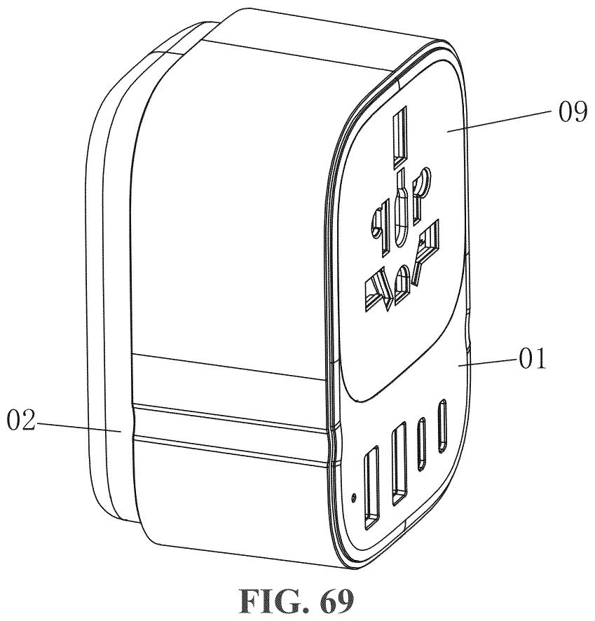

The present invention also includes a power converter, as shown in FIGS. 64-68, including the pin rotation structure in any one of the above-mentioned sixth to twelfth embodiments, a socket panel 09 disposed on an upper cap 01, and a socket assembly 10 disposed between the upper cap 01 and the lower cap 02. The socket assembly 10 includes a socket live wire conductive clip 101 disposed on a support 03 and matched with the socket panel 09, and a socket neutral wire conductive clip 103 disposed on the support 03 and matched with the socket panel 09. The plug assembly 04 further includes a live wire pin 043 disposed between the upper cap 01 and the lower cap 02, and a neutral wire pin 044 disposed between the upper cap 01 and the lower cap 02. The socket neutral wire conductive clip 103 and the neutral wire pin 044 are electrically connected via a flexible neutral wire connecting line 11. The socket live wire conductive clip 101 and the live wire pin 043 are electrically connected via a flexible live wire connecting line 12. By providing the connection line between the above-mentioned two as a flexible conductive line structure, so as to be more matched with the rotating structure of the plug assembly 04, the plug assembly 04 can be rotated while ensuring a smooth degree of conduction, so as to facilitate the cooperation between various components.

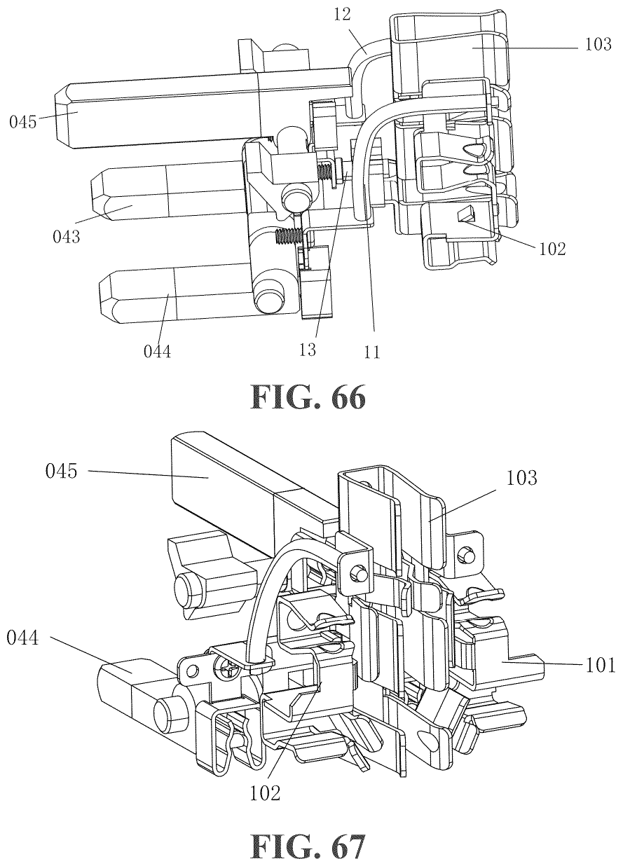

Preferably, as shown in FIGS. 66-68, the socket assembly 10 further includes a socket ground wire conductive clip 102 disposed on the support 03 and matched with the socket panel 09. The plug assembly 04 further includes a ground wire pin 045 disposed between the upper cap 01 and the lower cap 02. The socket ground wire conductive clip 102 and the ground wire pin 045 are electrically connected by the ground wire connector 13. By arranging the flexible ground connection piece 13 as a flexible conductive line structure, so as to be more matched with the rotating structure of the plug assembly 04, the smooth degree of conduction is ensured while the plug assembly 04 rotates, so as to facilitate the cooperation between various components.

The specific structural arrangement of the socket panel 09 is the same as that of the third embodiment.

### Fourteenth Embodiment

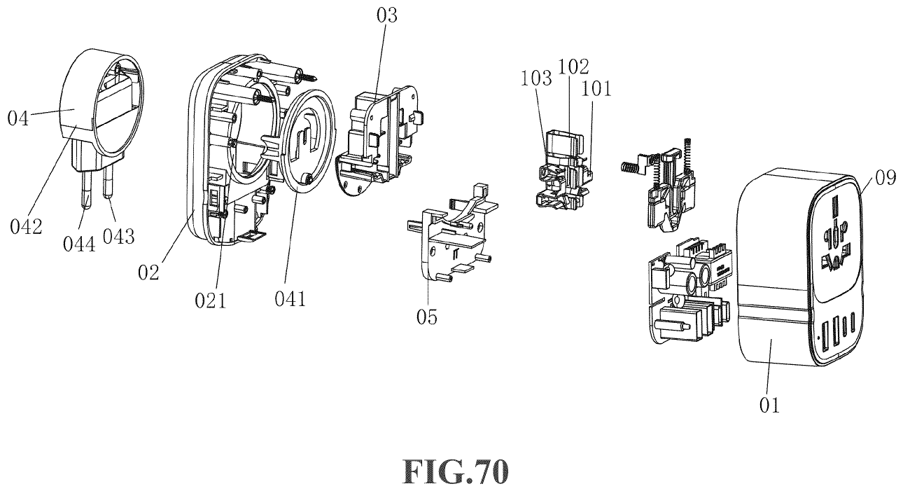

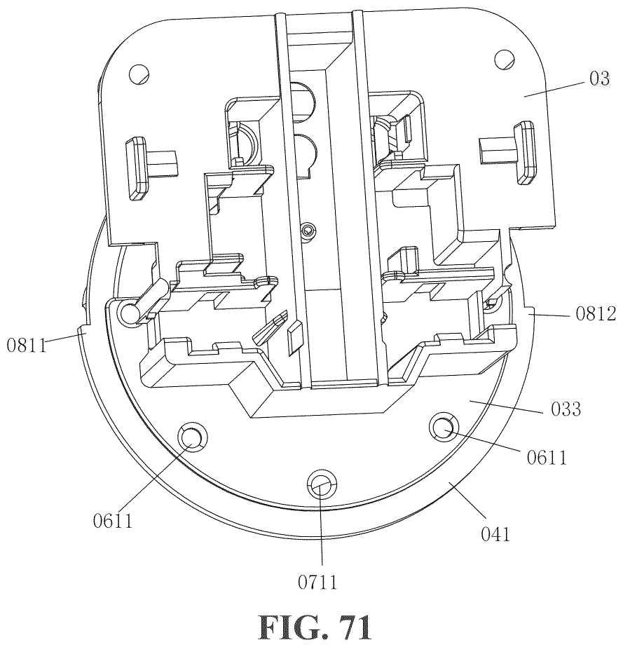

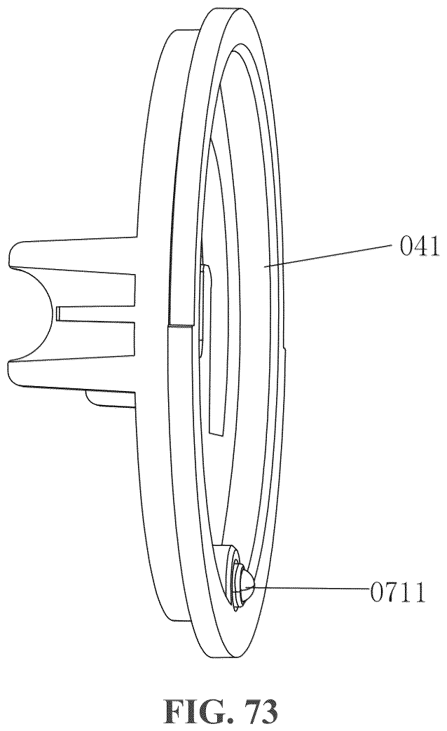

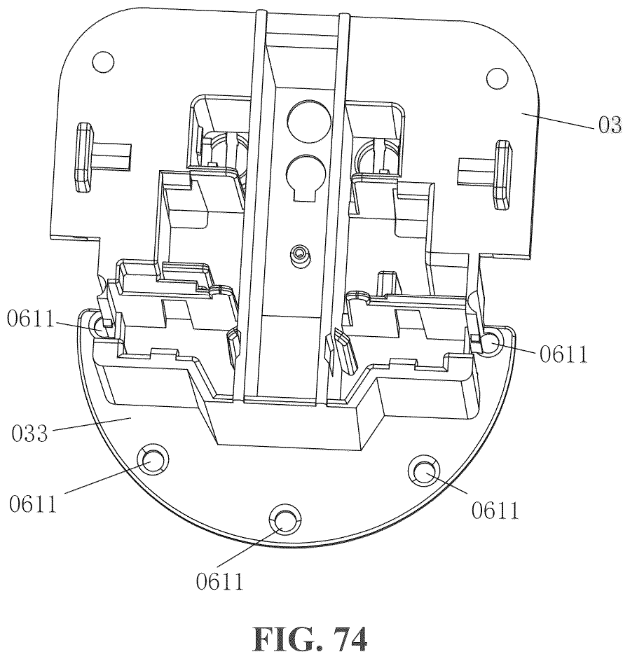

The present invention also includes a pin rotation structure for a power converter. As shown in FIGS. 69 to 74, the pin rotation structure includes an upper cap 01, a lower cap 02 covered to the upper cap 01, a support 03 disposed between the upper cap 01 and the lower cap 02, and a plug assembly 04 rotatably disposed on the lower cap 02. The plug assembly 04 includes a rotary base 041 rotatably disposed on the lower cap 02, and a plug body 042 disposed on the rotary base 041. The support 03 is formed with at least one feel limit portion 06. A rotation avoidance hole 021 for placing the rotary base 041 in rotation is disposed on the lower cap 02. The pin rotation structure further includes a feel limit mechanism 07 disposed on the rotary base 041. The feel limit mechanism 07 and the feel limit portion 06 interfere with each other and are matched with each other when the rotary base 041 rotates.

The specific structure of the plug assembly 04 is the same as that of the first embodiment.

The arrangement of the feel limit mechanism 07 and the feel limit portion 06 is the same as that of the first embodiment.

The specific structure and arrangement of the feel limit portion 06 are the same as those in the first embodiment.

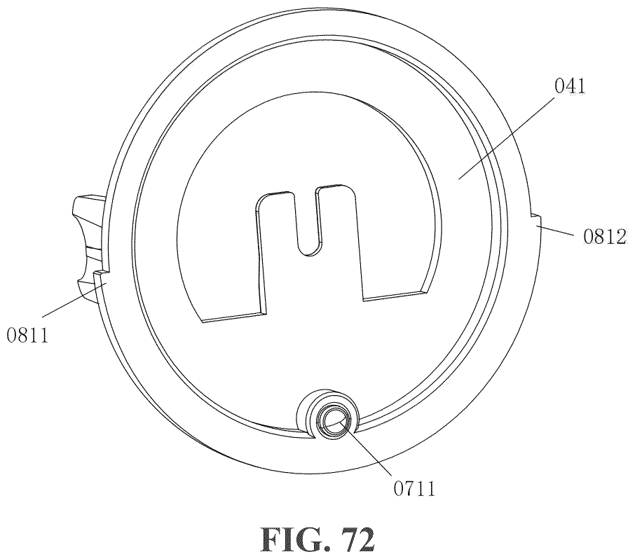

In order to prevent the rotary base 041 from rotating excessively, as shown in FIGS. 71 and 72, the present pin rotation structure further includes a rotation limit assembly 08 disposed between the upper cap 01 and the lower cap 02. The rotation limit assembly 08 includes a rotation limit step 081 and a rotation limit block (not shown in the figure). The rotation restricting step 081 is disposed on the outer edge of the rotary base 041. The rotation limit block is disposed at the edge of the rotation avoidance hole 021. After the rotation limit step 081 is rotated until pressed against the rotation limit block, the rotation limit block prevents the rotation limit step 081 from continuing to rotate, so as to prevent the plug assembly 04 disposed on the rotary base 041 from over-rotating, resulting in the problem of knotting or breaking of the internal connection structure, etc., thus ensuring the safety of the present pin rotation structure.

With regard to the specific structure of the rotation limit step 081, as shown in FIGS. 71 and 72, the rotation limit step 081 includes a first rotation limit step 0811 and/or a second rotation limit step 0812 respectively disposed on the rotary base 041, and the symmetrically provided structure thereof is more consistent with the structure of a circular rotary base 041, so that the rotary base 041 can be limited during rotation regardless of whether the first rotation limit step 0811 or the second rotation limit step 0812 thereof is pressed against the rotation limit block. Therefore, the rotational stroke of the plug assembly 04 is better limited, preventing the problem that the internal connection structure is knotted or broken due to the excessive rotation of the plug assembly 04 disposed on the rotary base 041. This guarantees the safety of the pin rotary structure.

The specific structural arrangement of the plug body 042 is the same as that of the first embodiment.

With regard to the specific manner in which the feel limit mechanism 07 and the feel limit portion 06 interfere with each other and are matched with each other, as shown in FIGS. 71 to 74, a sector plate 033 matched with the rotary base 041 is formed on the support 03. The feel limit portion 06 includes a plurality of eleventh feel limit portions 0611 formed inside the sector plate 033 and arranged around the sector plate 033. The feel limit mechanism 07 includes an eleventh feel limit block 0711 disposed on the rotary base 041 and protruding towards the eleventh feel limit portion 0611 at the top end thereof. The eleventh feel limit block 0711 and the eleventh feel limit portion 0611 interfere with each other and are matched with each other when the rotary base 041 rotates. The eleventh feel limit block 0711 is an elastic member. When in use, the front end of the eleventh feel limit block 0711 is pressed against the sector plate 033. When the eleventh feel limit block 0711 on which the rotary base 041 is rotated is directly opposite to the eleventh feel limit portion 0611 on the sector plate 033, the eleventh feel limit block 0711 extends into the eleventh feel limit portion 0611, so as to generate a touch different from that on the non-recessed part of the sector plate 033, and a sense of detent is generated between the two different hand feelings, so as to improve a user's good use feel and improve the use experience of the power converter. In addition, it is prompted that the user has rotated to a specific position, so as to facilitate the user to grasp the rotation condition of the plug assembly 04, and it is also feasible to limit the rotary base 041 and stop at this position without external force, so as to facilitate the user to use it.

### Fifteenth Embodiment

In the fourteenth embodiment, the pin rotation structure is described. In the present embodiment, the differences from the other embodiments are mainly described, and the description of the same configuration will not be repeated in the present embodiment.

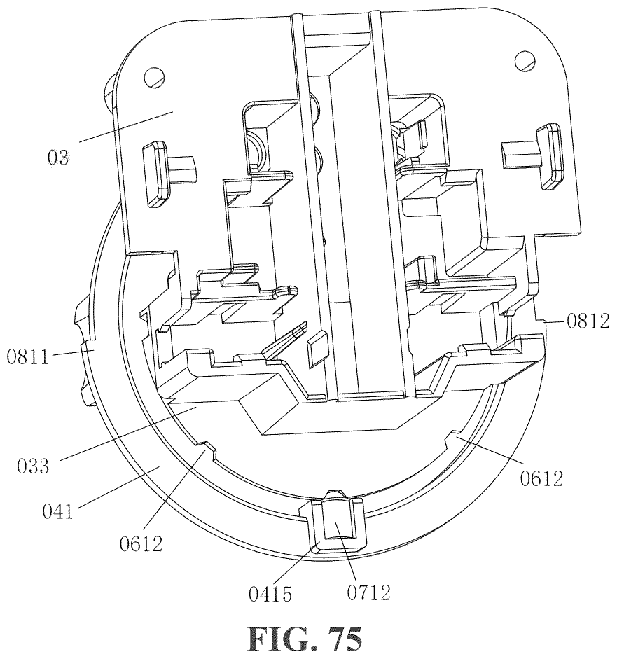

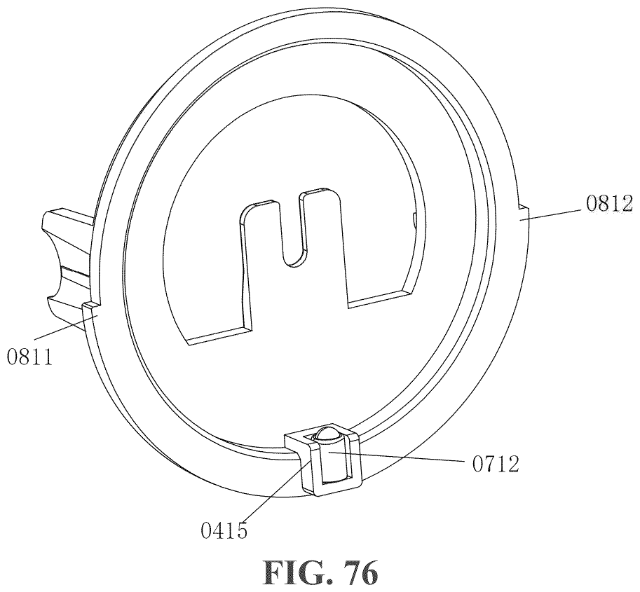

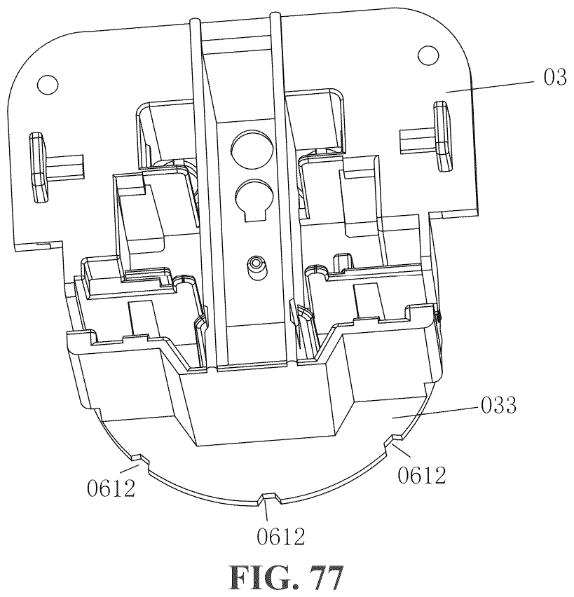

In the fifteenth embodiment, as shown in FIG. 75 to FIG. 77, according to the specific structure of the feel limit portion 06 and the feel limit mechanism 07, a sector plate 033 matched with the rotary base 041 is formed on the support 03. The feel limit portion 06 includes a plurality of twelfth feel limit portions 0612 formed on the arc-shaped outer wall of the sector plate 033. A twelfth fixing portion 0415 protruding upwards and opening towards the sector plate 033 is formed on the rotary base 041. The feel limit mechanism 07 includes a twelfth feel limit block 0712 disposed on the twelfth fixing portion 0415 and protruding towards the twelfth feel limit portion 0612. The twelfth feel limit block 0712 and the twelfth feel limit portion 0612 interfere with each other and are matched with each other when the rotary base 041 rotates. The twelfth feel limit block 0712 is an elastic member. During use, the twelfth feel limit block 0712 is fixed in the twelfth fixing portion 0415 and the front end thereof is pressed against the arc-shaped outer wall of the sector plate 033. When the rotary base 041 is rotated to the point that the twelfth feel limit block 0712 thereon is directly opposite to the twelfth feel limit portion 0612 on the sector plate 033, the twelfth feel limit block 0712 correspondingly protrudes into the twelfth feel limit portion 0612, thereby generating a feel different from that of the non-recessed part of the sector plate 033, and a sense of detent is generated between the two different hand feelings, so as to improve a user's good use feel and improve the use experience of the power converter. In addition, it is prompted that the user has rotated to a specific position, so as to facilitate the user to grasp the rotation condition of the plug assembly 04, and it is also feasible to limit the rotary base 041 and stop at this position without external force, so as to facilitate the user to use it.

### Sixteenth Embodiment

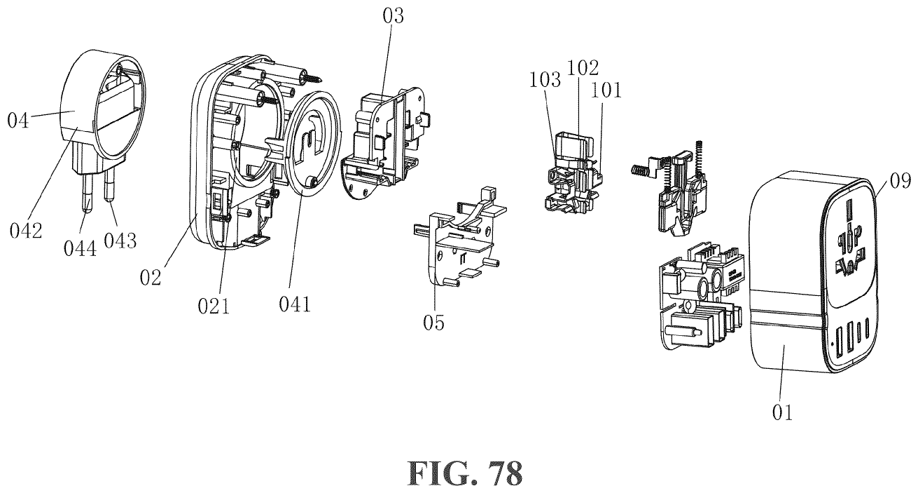

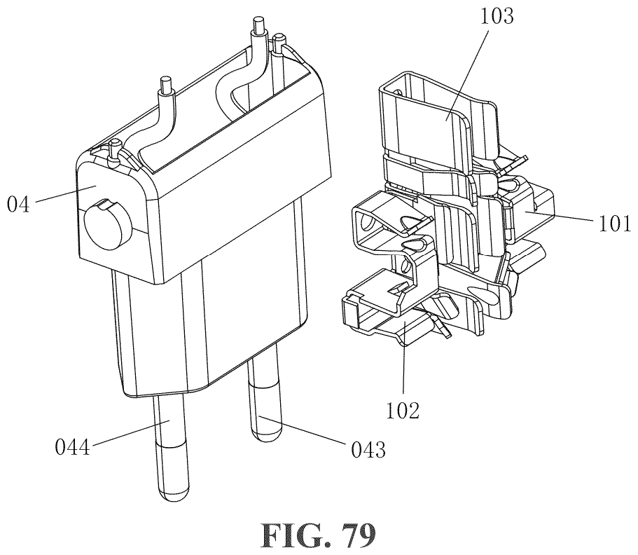

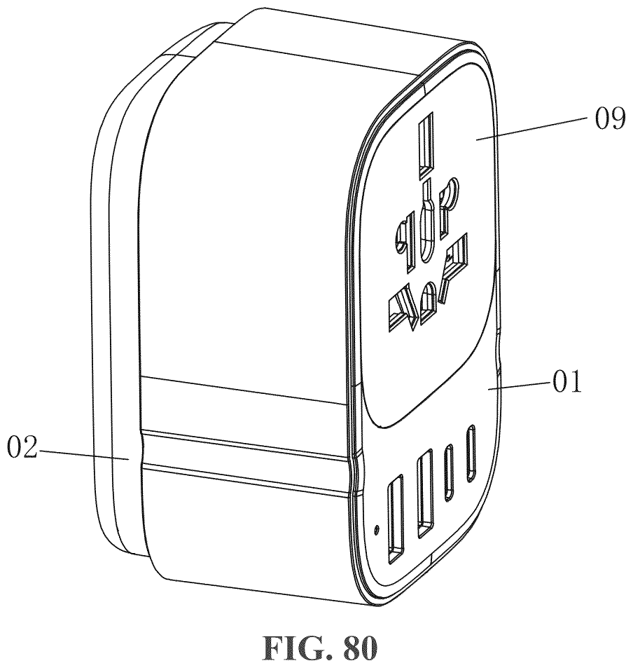

The present invention also includes a power converter, as shown in FIGS. 69 and 78-79, including the pin rotation structure in any one of the above-mentioned fourteenth to fifteenth embodiments, a socket panel 09 disposed on an upper cap 01, and a socket assembly 10 disposed between the upper cap 01 and the lower cap 02. The socket assembly 10 includes a socket live wire conductive clip 101 disposed on a support 03 and matched with the socket panel 09, and a socket neutral wire conductive clip 103 disposed on the support 03 and matched with the socket panel 09. The plug assembly 04 further includes a live wire pin 043 disposed between the upper cap 01 and the lower cap 02, and a neutral wire pin 044 disposed between the upper cap 01 and the lower cap 02. The socket neutral wire conductive clip 103 and the neutral wire pin 044 are electrically connected via a flexible neutral wire connecting line 11. The socket live wire conductive clip 101 and the live wire pin 043 are electrically connected via a flexible live wire connecting line 12. By providing the connection line between the above-mentioned two as a flexible conductive line structure, so as to be more matched with the rotating structure of the plug assembly 04, the plug assembly 04 can be rotated while ensuring a smooth degree of conduction, so as to facilitate the cooperation between various components.

Preferably, the socket assembly 10 further includes a socket ground wire conductive clip (not shown in the drawings) disposed on the support 03 and matched with the socket panel 09. The plug assembly 04 further includes a ground wire pin (not shown in the drawings) disposed between the upper cap 01 and the lower cap 02. The socket ground wire conductive clip and the ground wire pin are electrically connected by a ground wire connector (not shown in the drawings). By arranging the flexible ground connection piece as a flexible conductive line structure, so as to be more matched with the rotating structure of the plug assembly 04, the smooth degree of conduction is ensured while the plug assembly 04 rotates, so as to facilitate the cooperation between various components.

The specific structural arrangement of the socket panel 09 is the same as that of the third embodiment.

### Seventeenth Embodiment

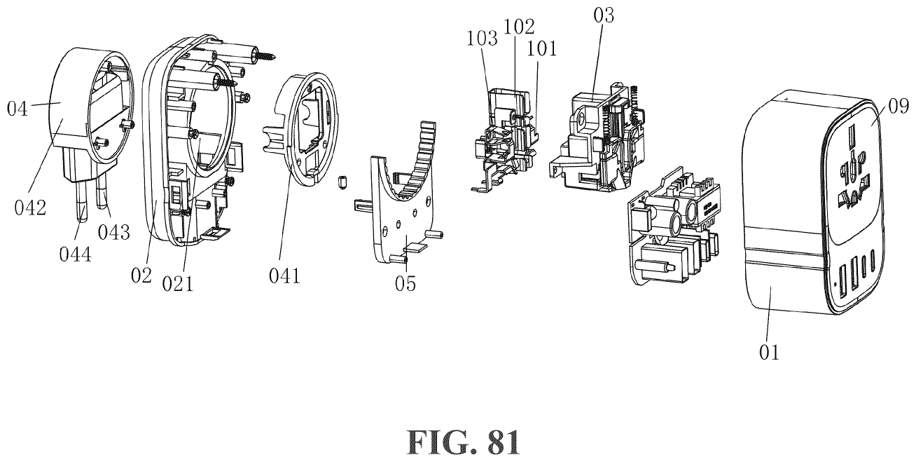

The present invention also includes a pin rotation structure for a power converter, as shown in FIGS. 80-84, including an upper cap 01, a lower cap 02 covered to the upper cap 01, and a support 03 disposed between the upper cap 01 and the lower cap 02. The pin rotation structure further includes a plug assembly 04 rotatably arranged on the lower cap 02, and a feel limit fixing plate 05 disposed between the upper cap 01 and the lower cap 02. The plug assembly 04 includes a rotary base 041 rotatably disposed on the lower cap 02, and a plug body 042 disposed on the rotary base 041. At least one feel limit portion 06 is formed on the feel limit fixing plate 05, and a rotation avoidance hole 021 is disposed on the lower cap 02 for placing the rotary base 041 in rotation. The pin rotation structure further includes a feel limit mechanism 07 disposed on the rotary base 041. The feel limit mechanism 07 and the feel limit portion 06 interfere with each other and are matched with each other when the rotary base 041 rotates.

The specific structure of the plug assembly 04 is the same as that of the first embodiment.

The arrangement of the feel limit mechanism 07 and the feel limit portion 06 is the same as that of the first embodiment.

The specific structure and arrangement of the feel limit portion 06 are the same as those in the first embodiment.

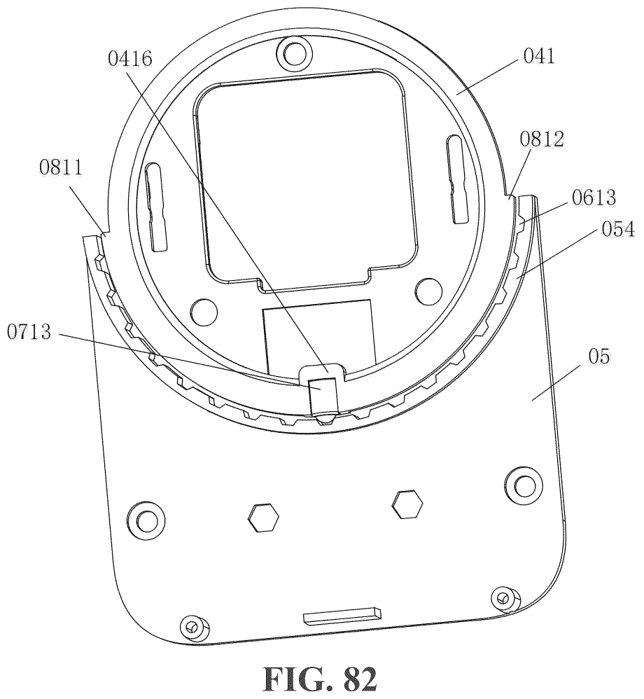

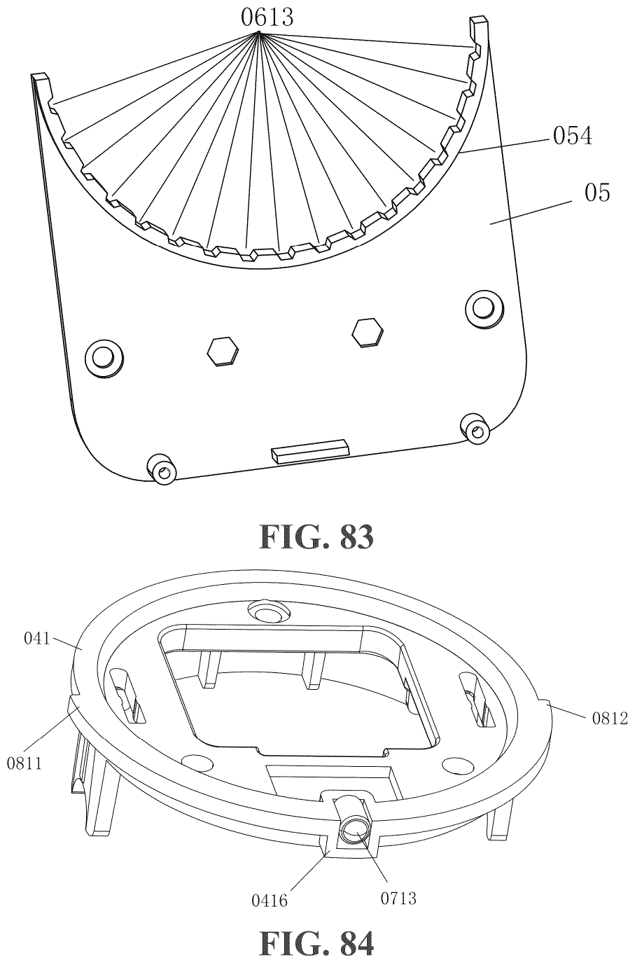

In order to prevent the rotary base 041 from over-rotating, as shown in FIGS. 82 and 84, the present pin rotation structure further includes a rotation limit assembly 08 disposed between the upper cap 01 and the lower cap 02. The rotation limit assembly 08 includes a rotation limit step 081 and a rotation limit block (not shown in the figure). The rotation restricting step 081 is disposed on the outer edge of the rotary base 041. The rotation limit block is disposed at the edge of the rotation avoidance hole 021. After the rotation limit step 081 is rotated until pressed against the rotation limit block, the rotation limit block prevents the rotation limit step 081 from continuing to rotate, so as to prevent the plug assembly 04 disposed on the rotary base 041 from over-rotating, resulting in the problem of knotting or breaking of the internal connection structure, etc., thus ensuring the safety of the present pin rotation structure.

With regard to the specific structure of the rotation limit step 081, as shown in FIGS. 82 and 84, the rotation limit step 081 includes a first rotation limit step 0811 and/or a second rotation limit step 0812 respectively disposed on the rotary base 041, and the symmetrically provided structure thereof is more consistent with the structure of a circular rotary base 041, so that the rotary base 041 can be limited during rotation regardless of whether the first rotation limit step 0811 or the second rotation limit step 0812 thereof is pressed against the rotation limit block. Therefore, the rotational stroke of the plug assembly 04 is better limited, preventing the problem that the internal connection structure is knotted or broken due to the excessive rotation of the plug assembly 04 disposed on the rotary base 041. This guarantees the safety of the pin rotary structure.

The specific structural arrangement of the plug body 042 is the same as that of the first embodiment.

As shown in FIG. 82 to FIG. 84, a thirteenth step 054 protruding in the direction of the support 03 and matched with the rotary base 041 is formed on the feel limit fixing plate 05. The feel limit fixing plate 06 includes a plurality of thirteenth feel limit portions 0613 disposed on the inner circumference of the thirteenth step 054 in the direction of the rotary base 041 and recessed inwards. A thirteenth fixing portion 0416 recessed inwards is formed on the rotary base 041. The feel limit mechanism 07 includes a thirteenth feel limit block 0713 disposed on the thirteenth fixing portion 0416 and having a top end extending towards the thirteenth feel limit portion 0613. The thirteenth feel limit block 0713 and the thirteenth feel limit portion 0613 interfere with each other and are matched with each other when the rotary base 041 rotates. The thirteenth feel limit block 0713 is an elastic member. During use, the thirteenth feel limit block 0713 is fixed in a thirteenth fixing portion 0416 of the rotary base 041 and the front end thereof presses against the thirteenth step 054. When the rotary base 041 is rotated until the thirteenth feel limit block 0713 thereon is directly opposite to the thirteenth hand limiting part 0613, the thirteenth feel limit block 0713 correspondingly extends into the thirteenth hand limiting part 0613, thereby generating a different hand feeling from that of pressing against the non-recessed part of the thirteenth step 054, and a sense of detent is generated between the two different hand feelings, so as to improve a user's good use feel and improve the use experience of the power converter. In addition, it is prompted that the user has rotated to a specific position, so as to facilitate the user to grasp the rotation condition of the plug assembly 04, and it is also feasible to limit the rotary base 041 and stop at this position without external force, so as to facilitate the user to use it.

### Eighteenth Embodiment

In the seventeenth embodiment, the pin rotation structure is described. In the present embodiment, the differences from the other embodiments are mainly described, and the description of the same configuration will not be repeated in the present embodiment.

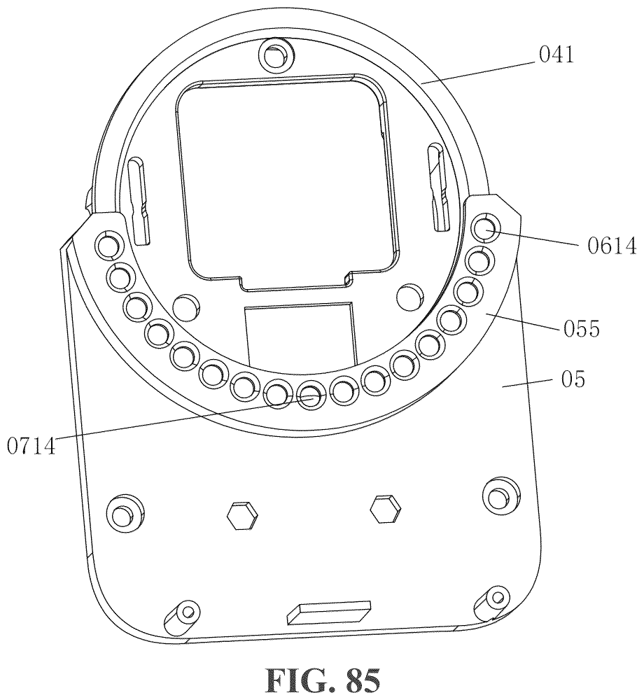

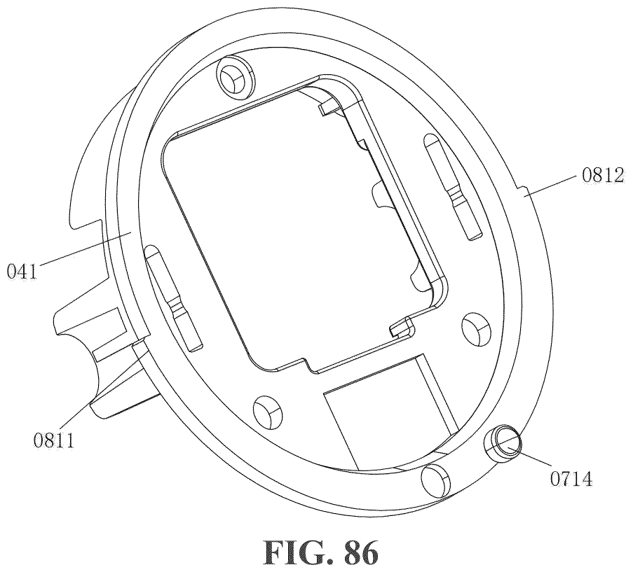

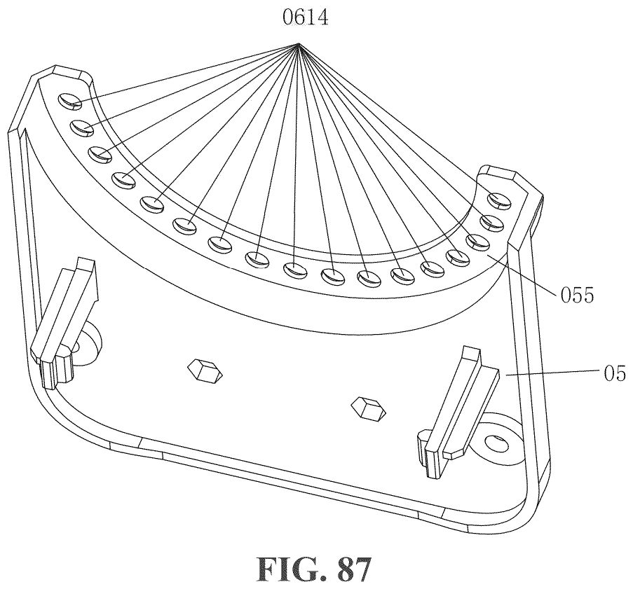

In the eighteenth embodiment, as shown in FIG. 85 to FIG. 87, according to the specific structure of the feel limit portion 06 and the feel limit mechanism 07, the feel limit fixing plate 05 is formed with a fourteenth ring terminal 055 for covering the outer circumference of the lower end of the rotary base 041. The feel limit portion 06 includes a plurality of fourteenth feel limit portions 0614 annularly arranged on the fourteenth ring terminal 055 in this order. The feel limit mechanism 07 includes a fourteenth feel limit block 0714 disposed on the rotary base 041 and protruding from the top end thereof in the direction of the fourteenth feel limit portion 0614. The fourteenth feel limit block 0714 and the fourteenth feel limit portion 0614 interfere with each other and are matched with each other when the rotary base 041 rotates. The fourteenth feel limit block 0714 is an elastic member. When in use, the front end of the fourteenth feel limit block 0714 is pressed against the fourteenth ring terminal 055. When the fourteenth feel limit block 0714 on which the rotary base 041 is rotated is directly opposite to the fourteenth feel limit portion 0614, the fourteenth feel limit block 0714 is correspondingly placed into the fourteenth feel limit portion 0614, so as to generate a different hand feeling from pressing against the non-recessed part of the fourteenth ring terminal 055, and a sense of detent is generated between the two different hand feelings, so as to improve a user's good use feel and improve the use experience of the power converter. In addition, it is prompted that the user has rotated to a specific position, so as to facilitate the user to grasp the rotation condition of the plug assembly 04, and it is also feasible to limit the rotary base 041 and stop at this position without external force, so as to facilitate the user to use it.

### Nineteenth Embodiment

In the seventeenth embodiment, the pin rotation structure is described. In the present embodiment, the differences from the other embodiments are mainly described, and the description of the same configuration will not be repeated in the present embodiment.

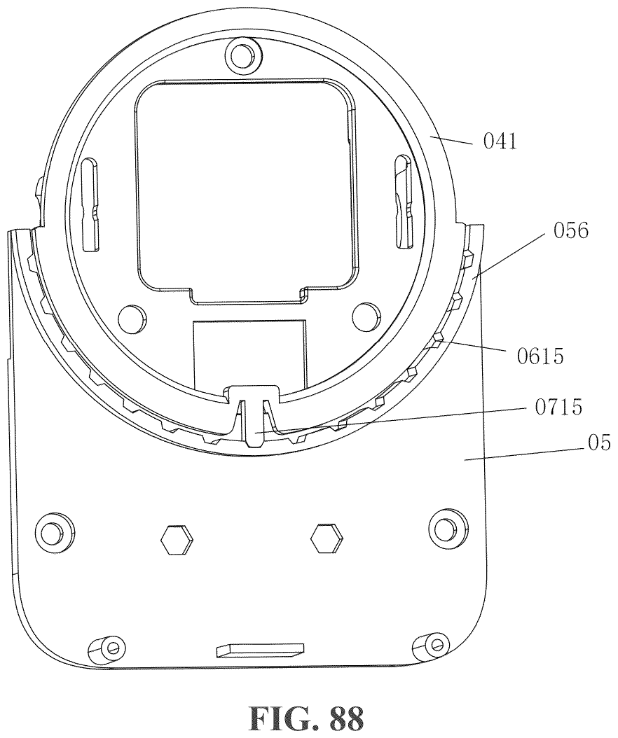

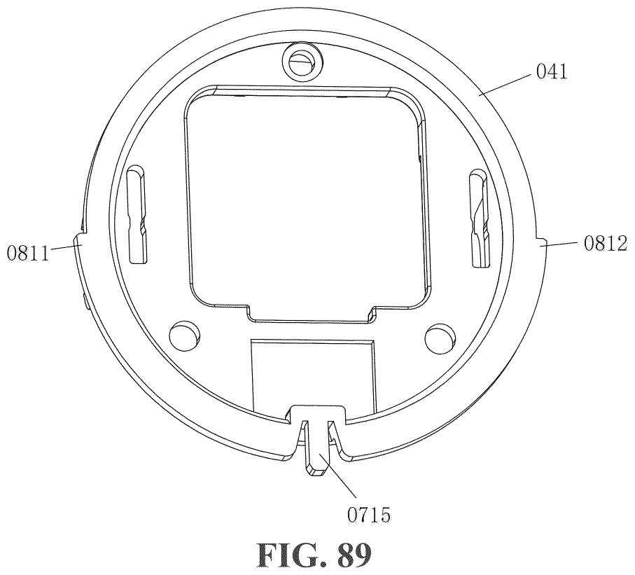

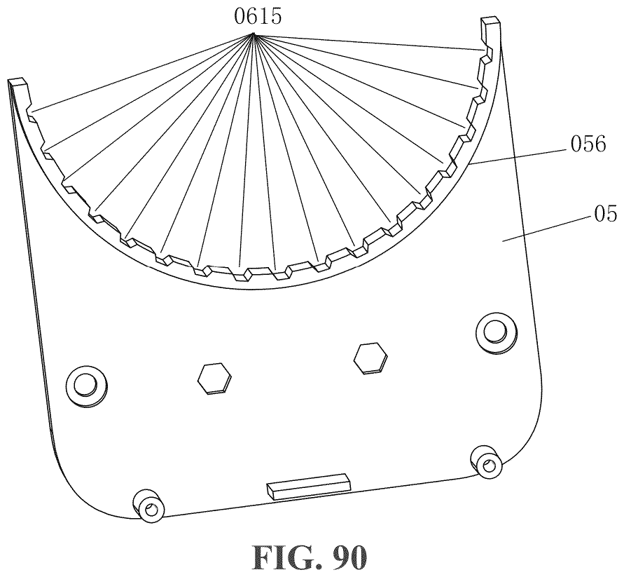

In the nineteenth embodiment, as shown in FIG. 88 to FIG. 90, according to the specific structure of the feel limit portion 06 and the feel limit mechanism 07, a fifteenth step 056 protruding in the direction of the support 03 and matched with the rotary base 041 is formed on the feel limit fixing plate 05. The feel limit portion 06 includes a plurality of fifteenth feel limit portions 0615 disposed on the inner circumference of the fifteenth step 056 in the direction of the rotary base 041 and recessed inward. The feel limit mechanism 07 includes a fifteenth feel limit block 0715 disposed on an outer ring of the rotary base 041 and protruding towards the fifteenth feel limit portion 0615. The fifteenth feel limit block 0715 and the fifteenth feel limit portion 0615 interfere with each other and are matched with each other when the rotary base 041 rotates. The fifteenth feel limit block 0715 is an elastic member. When in use, the front end of the fifteenth feel limit block 0715 is pressed against the fifteenth step 056. When the fifteenth feel limit block 0715 on which the rotary base 041 is rotated is directly opposite to the fifteenth feel limit portion 0615, the fifteenth feel limit block 0715 correspondingly extends into the fifteenth feel limit portion 0615, so as to generate a different hand feel from that of pressing against the non-recessed part of the fifteenth step 056, and a sense of detent is generated between the two different hand feelings, so as to improve a user's good use feel and improve the use experience of the power converter. In addition, it is prompted that the user has rotated to a specific position, so as to facilitate the user to grasp the rotation condition of the plug assembly 04, and it is also feasible to limit the rotary base 041 and stop at this position without external force, so as to facilitate the user to use it.

### Twentieth Embodiment

In the seventeenth embodiment, the pin rotation structure is described. In the present embodiment, the differences from the other embodiments are mainly described, and the description of the same configuration will not be repeated in the present embodiment.

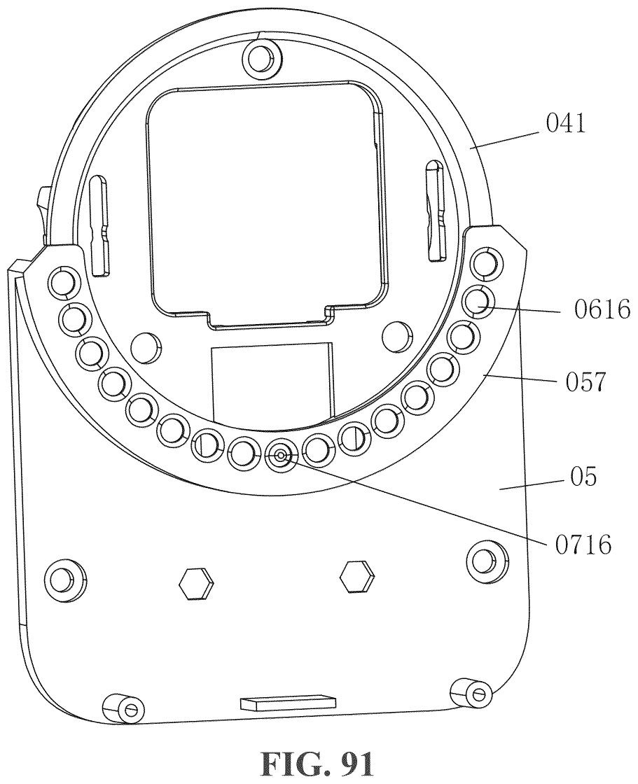

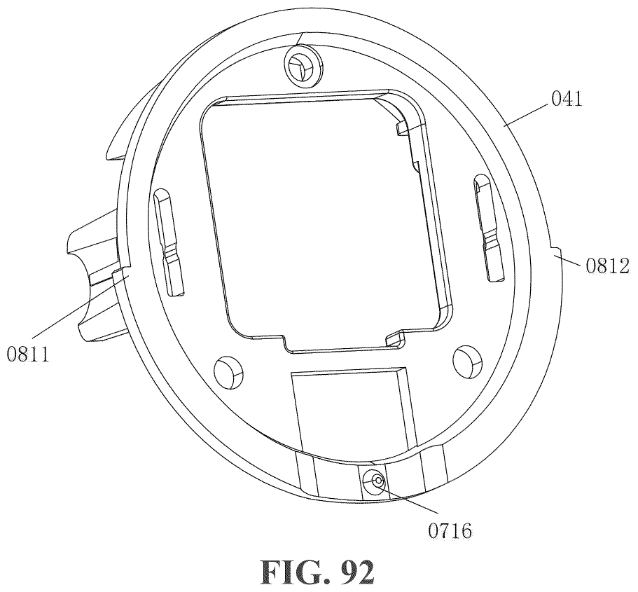

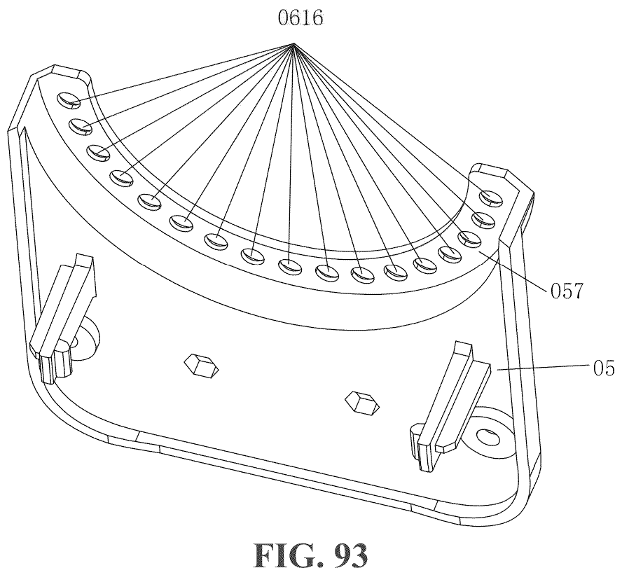

In the twenty-second embodiment, as shown in FIG. 91 to FIG. 93, according to the specific structure of the feel limit portion 06 and the feel limit mechanism 07, the feel limit fixing plate 05 is formed with a sixteenth ring terminal 057 for covering the outer circumference of the lower end of the rotary base 041. The feel limit portion 06 includes a plurality of sixteenth feel limit portions 0616 annularly arranged on the sixteenth ring terminal 057 in this order. The feel limit mechanism 07 includes a sixteenth feel limit block 0716 integrally formed on the rotary base 041 and protruding in the direction of a sixteenth feel limit portion 0616. The sixteenth feel limit block 0716 and the sixteenth feel limit portion 0616 interfere with each other and are matched with each other when the rotary base 041 is rotated. The sixteenth feel limit block 0716 is an elastic member. When in use, the top end of the sixteenth feel limit block 0716 is pressed against the sixteenth ring terminal 057. When the sixteenth feel limit block 0716 on which the rotary base 041 is rotated is directly opposite to the sixteenth feel limit portion 0616, the sixteenth feel limit block 0716 correspondingly extends into the sixteenth feel limit portion 0616, so as to generate a different hand feeling from pressing against a non-recessed part of the sixteenth ring terminal 057, and a sense of detent is generated between the two different hand feelings, so as to improve a user's good use feel and improve the use experience of the power converter. In addition, it is prompted that the user has rotated to a specific position, so as to facilitate the user to grasp the rotation condition of the plug assembly 04, and it is also feasible to limit the rotary base 041 and stop at this position without external force, so as to facilitate the user to use it.

### Twenty-First Embodiment

In the seventeenth embodiment, the pin rotation structure is described. In the present embodiment, the differences from the other embodiments are mainly described, and the description of the same configuration will not be repeated in the present embodiment.

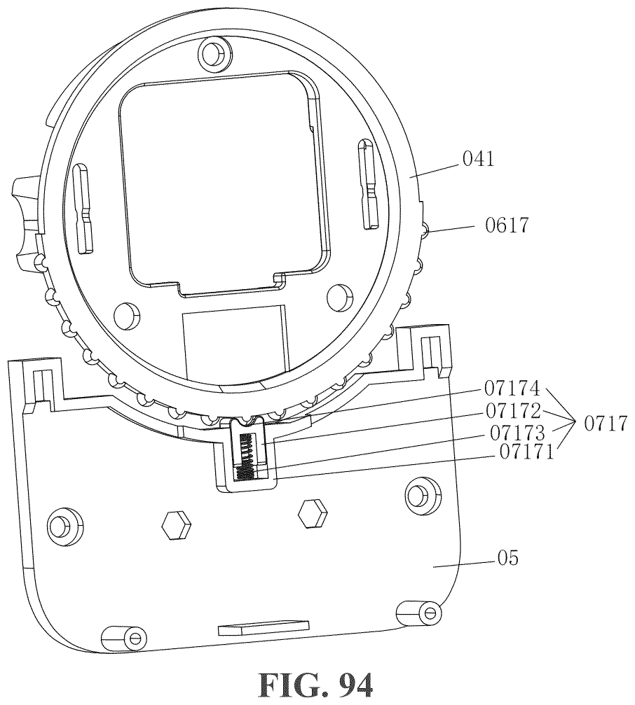

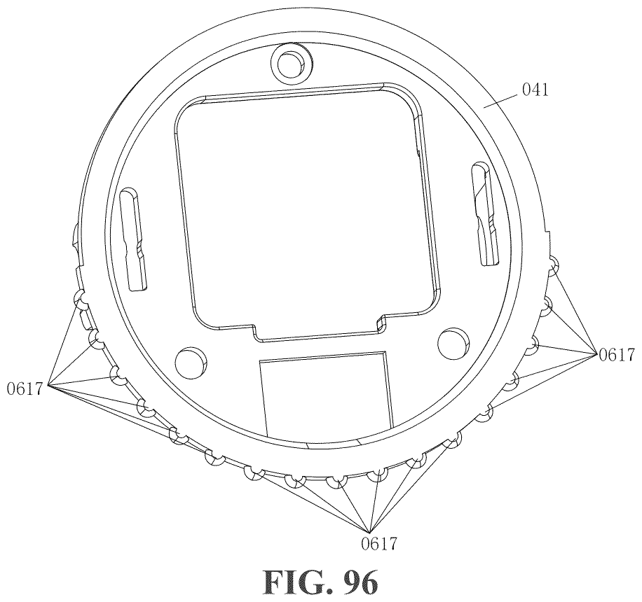

In the twenty-first embodiment, as shown in FIG. 94 to FIG. 96, the feel limit portion 06 includes a plurality of seventeenth feel limit blocks 0617 disposed on the outer ring of the rotary base 041 and protruding towards the feel limit fixing plate 05. The feel limit mechanism 07 includes a seventeenth feel limit mechanism 0717 disposed on the feel limit fixing plate 05. The seventeenth feel limit mechanism 0717 includes a seventeenth mounting seat 07171 formed on the feel limit fixing plate 05, a seventeenth feel limit member 07172 disposed in the seventeenth mounting seat 07171, a seventeenth elastic member 07173 disposed between the seventeenth mounting seat 07171 and the seventeenth feel limit member 07172, and a seventeenth feel limit groove 07174 formed on the seventeenth feel limit member 07172 and recessed inwards to match the seventeenth feel limit block 0617. The seventeenth feel limit groove 07174 and the seventeenth feel limit block 0617 interfere with each other when the rotary base 041 rotates. The seventeenth elastic member 07173 provides an elastic force to push out the seventeenth feel limit member 07172 in the direction of the rotary base 041. When in use, the seventeenth feel limit groove 07174 is pressed against the side edge of the rotary base 041. When the seventeenth feel limit block 0617 on which the rotary base 041 is rotated is directly opposite to the seventeenth feel limit groove 07174 on the seventeenth hand limiting member 07172, the seventeenth feel limit block 0617 correspondingly extends into the seventeenth feel limit groove 07174, so as to generate a hand feeling different from the hand feeling pressed against the side edge of the rotary base 041041, and a sense of detent is generated between the two different hand feelings, thereby improving a user's good feeling of use. The use experience of the power converter is improved, and the user is prompted that the power converter has been rotated to a specific position, so as to facilitate the user to grasp the rotation condition of the plug assembly 04. The rotary base 041 can be limited, and can be stopped at this position without any external force, so as to facilitate the use by the user.

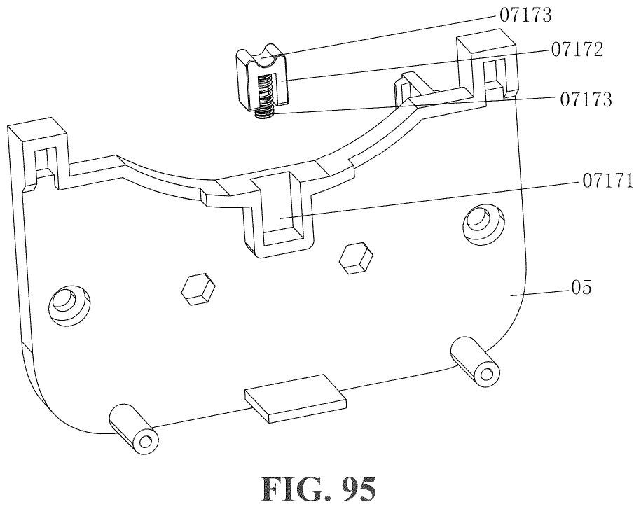

Preferably, as shown in FIGS. 94 to 95, the seventeenth elastic member 07173 is a spring, which has low price and high durability, effectively reduces the production cost and ensures the normal operation of the pin rotation structure.

### Twenty-Second Embodiment

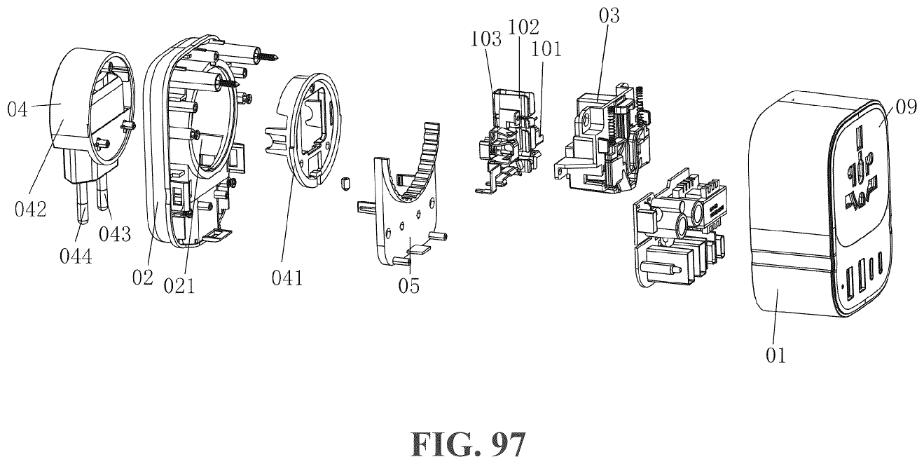

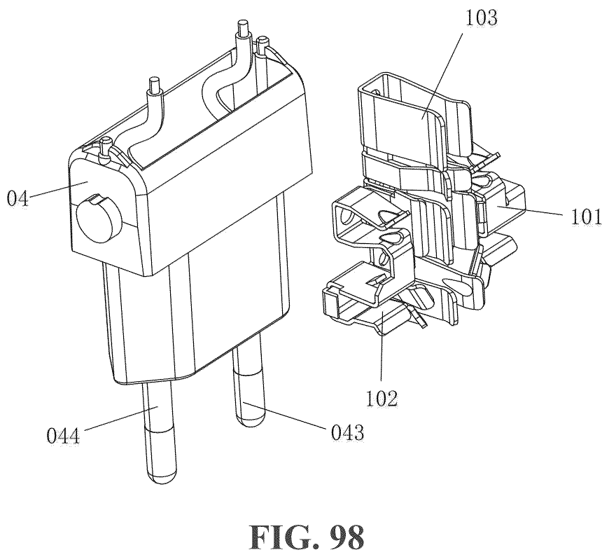

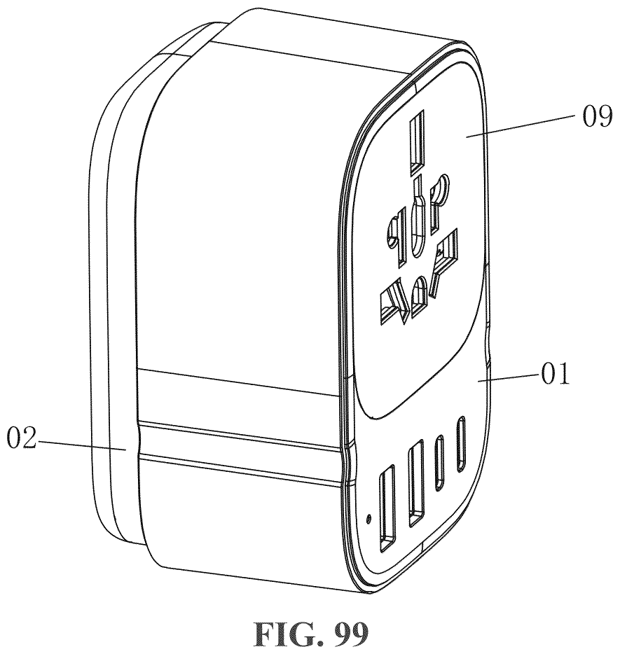

The present invention also includes a power converter, as shown in FIGS. 80-81 and 97-98, including the pin rotation structure in any one of the above-mentioned seventeenth to twenty-first embodiments, a socket panel 09 disposed on an upper cap 01, and a socket assembly 10 disposed between the upper cap 01 and the lower cap 02. The socket assembly 10 includes a socket live wire conductive clip 101 disposed on a support 03 and matched with the socket panel 09, and a socket neutral wire conductive clip 103 disposed on the support 03 and matched with the socket panel 09. The plug assembly 04 further includes a live wire pin 043 disposed between the upper cap 01 and the lower cap 02, and a neutral wire pin 044 disposed between the upper cap 01 and the lower cap 02. The socket neutral wire conductive clip 103 and the neutral wire pin 044 are electrically connected via a flexible neutral wire connecting line 11. The socket live wire conductive clip 101 and the live wire pin 043 are electrically connected via a flexible live wire connecting line 12. By providing the connection line between the above-mentioned two as a flexible conductive line structure, so as to be more matched with the rotating structure of the plug assembly 04, the plug assembly 04 can be rotated while ensuring a smooth degree of conduction, so as to facilitate the cooperation between various components.

Preferably, the socket assembly 10 further includes a socket ground wire conductive clip (not shown in the drawings) disposed on the support 03 and matched with the socket panel 09. The plug assembly 04 further includes a ground wire pin (not shown in the drawings) disposed between the upper cap 01 and the lower cap 02. The socket ground wire conductive clip and the ground wire pin are electrically connected by a ground wire connector (not shown in the drawings). By arranging the flexible ground connection piece as a flexible conductive line structure, so as to be more matched with the rotating structure of the plug assembly 04, the smooth degree of conduction is ensured while the plug assembly 04 rotates, so as to facilitate the cooperation between various components.

The specific structural arrangement of the socket panel 09 is the same as that of the third embodiment.

### Twenty-Third Embodiment

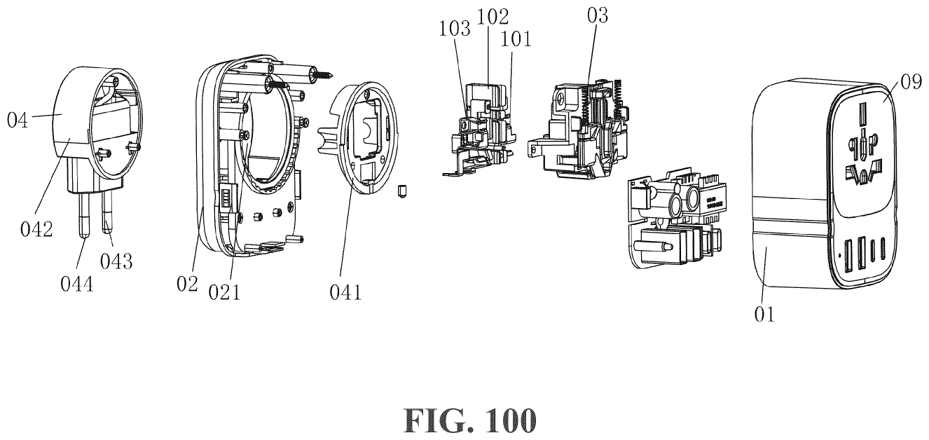

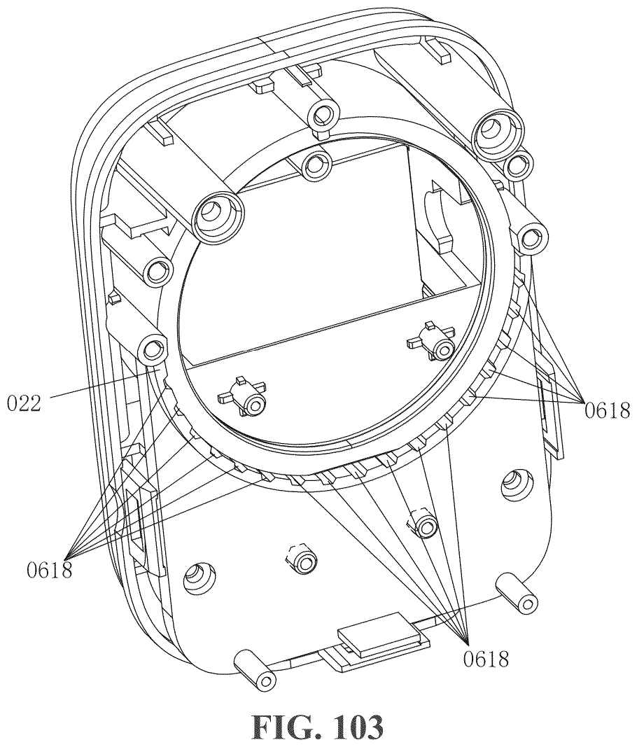

The present invention also includes a pin rotation structure for a power converter. As shown in FIGS. 99 to 103, the pin rotation structure includes an upper cap 01, a lower cap 02 covered to the upper cap 01, a support 03 disposed between the upper cap 01 and the lower cap 02, and a plug assembly 04 rotatably disposed on the lower cap 02. The plug assembly 04 includes a rotary base 041 rotatably disposed on the lower cap 02, and a plug body 042 disposed on the rotary base 041. The lower cap 02 is formed with at least one feel limit portion 06. A rotation avoidance hole 021 for placing the rotary base 041 in rotation is disposed on the lower cap 02. The pin rotation structure further includes a feel limit mechanism 07 disposed on the rotary base 041. The feel limit mechanism 07 and the feel limit portion 06 interfere with each other and are matched with each other when the rotary base 041 rotates.

The specific structure of the plug assembly 04 is the same as that of the first embodiment.

The arrangement of the feel limit mechanism 07 and the feel limit portion 06 is the same as that of the first embodiment.

The specific structural arrangement of the feel limit portion 06 is the same as that of the first embodiment.

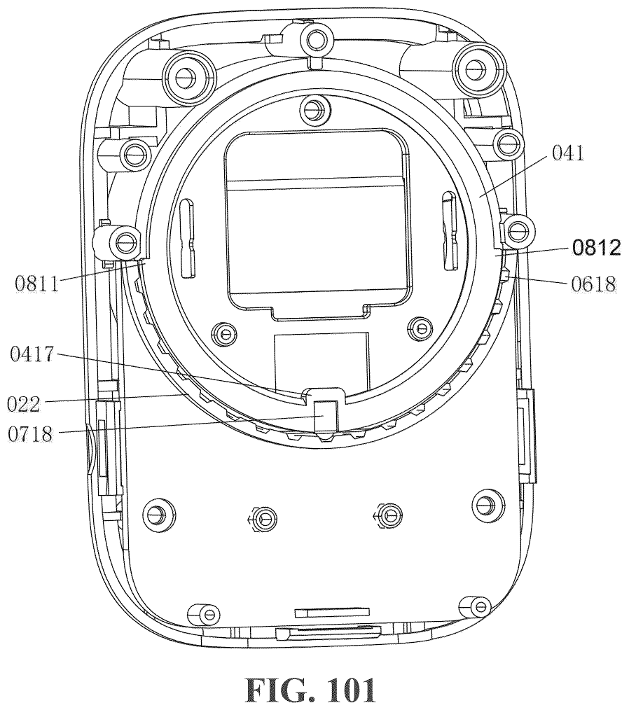

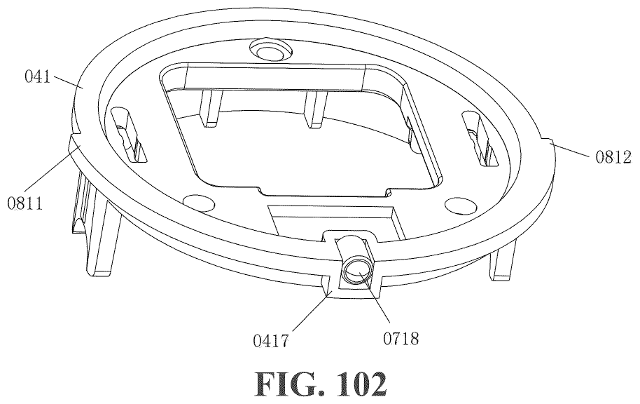

In order to prevent the rotary base 041 from over-rotating, as shown in FIGS. 101 and 102, the present pin rotation structure further includes a rotation limit assembly 08 disposed between the upper cap 01 and the lower cap 02. The rotation limit assembly 08 includes a rotation limit step 081 and a rotation limit block (not shown in the figure). The rotation restricting step 081 is disposed on the outer edge of the rotary base 041. The rotation limit block is disposed at the edge of the rotation avoidance hole 021. After the rotation limit step 081 is rotated until pressed against the rotation limit block, the rotation limit block prevents the rotation limit step 081 from continuing to rotate, so as to prevent the plug assembly 04 disposed on the rotary base 041 from over-rotating, resulting in the problem of knotting or breaking of the internal connection structure, etc., thus ensuring the safety of the present pin rotation structure.

With regard to the specific structure of the rotation limit step 081, as shown in FIGS. 101 and 102, the rotation limit step 081 includes a first rotation limit step 0811 and/or a second rotation limit step 0812 respectively disposed on the rotary base 041, and the symmetrically provided structure thereof is more consistent with the structure of a circular rotary base 041, so that the rotary base 041 can be limited during rotation regardless of whether the first rotation limit step 0811 or the second rotation limit step 0812 thereof is pressed against the rotation limit block. Therefore, the rotational stroke of the plug assembly 04 is better limited, preventing the problem that the internal connection structure is knotted or broken due to the excessive rotation of the plug assembly 04 disposed on the rotary base 041. This guarantees the safety of the pin rotary structure.

The specific structural arrangement of the plug body 042 is the same as that of the first embodiment.

As shown in FIG. 101 to FIG. 103, the lower cap 02 is formed with an eighteenth step 022 protruding in the direction of the support 03 and matched with the rotary base 041. The feel limit portion 06 includes a plurality of eighteenth feel limit portions 0618 disposed on the inner circumference of the eighteenth step 022 in the direction of the rotary base 041 and recessed inwards. An eighteenth fixing portion 0417 recessed inwards is formed on the rotary base 041. The feel limit mechanism 07 includes an eighteenth feel limit block 0718 disposed on the eighteenth fixing portion 0417 and having a top end extending towards the eighteenth feel limit portion 0618. The eighteenth feel limit block 0718 and the eighteenth feel limit portion 0618 interfere with each other and are matched with each other when the rotary base 041 is rotated. The eighteenth feel limit block 0718 is an elastic member. When in use, the top end of the eighteenth feel limit block 0718 is pressed against the eighteenth step 022. When the rotary base 041 is rotated until the eighteenth feel limit block 0718 is directly opposite to the eighteenth feel limit portion 0618, the eighteenth feel limit block 0718 correspondingly extends into the eighteenth feel limit portion 0618, so as to generate a different hand feeling from being pressed against a non-recessed part of the eighteenth step 022, and a sense of detent is generated between the two different hand feelings, so as to improve a user's good use feel and improve the use experience of the power converter. In addition, it is prompted that the user has rotated to a specific position, so as to facilitate the user to grasp the rotation condition of the plug assembly 04, and it is also feasible to limit the rotary base 041 and stop at this position without external force, so as to facilitate the user to use it.

### Twenty-Fourth Embodiment

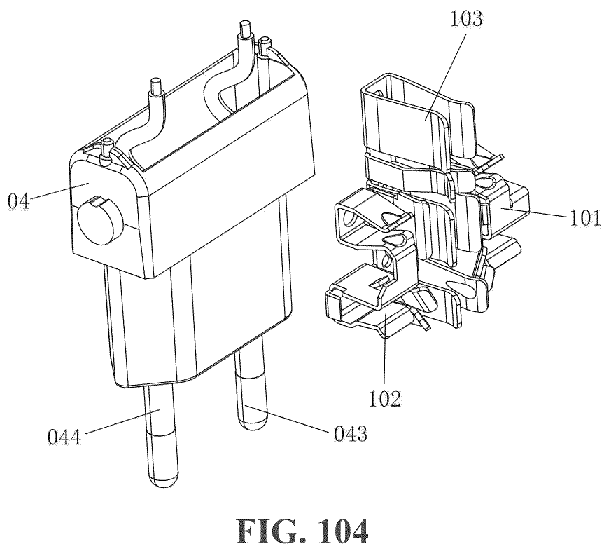

The present invention also includes a power converter, as shown in FIGS. 99-100 and 104, including the pin rotation structure in the above-mentioned twenty-third embodiment, a socket panel 09 disposed on an upper cap 01, and a socket assembly 10 disposed between the upper cap 01 and the lower cap 02. The socket assembly 10 includes a socket live wire conductive clip 101 disposed on a support 03 and matched with the socket panel 09, and a socket neutral wire conductive clip 103 disposed on the support 03 and matched with the socket panel 09. The plug assembly 04 further includes a live wire pin 043 disposed between the upper cap 01 and the lower cap 02, and a neutral wire pin 044 disposed between the upper cap 01 and the lower cap 02. The socket neutral wire conductive clip 103 and the neutral wire pin 044 are electrically connected via a flexible neutral wire connecting line 11. The socket live wire conductive clip 101 and the live wire pin 043 are electrically connected via a flexible live wire connecting line 12. By providing the connection line between the above-mentioned two as a flexible conductive line structure, so as to be more matched with the rotating structure of the plug assembly 04, the plug assembly 04 can be rotated while ensuring a smooth degree of conduction, so as to facilitate the cooperation between various components.

Preferably, the specific structure of the socket assembly 10 is the same as that of Embodiment 22.

The specific structural arrangement of the socket panel 09 is the same as that of the third embodiment.

### Twenty-Fifth Embodiment

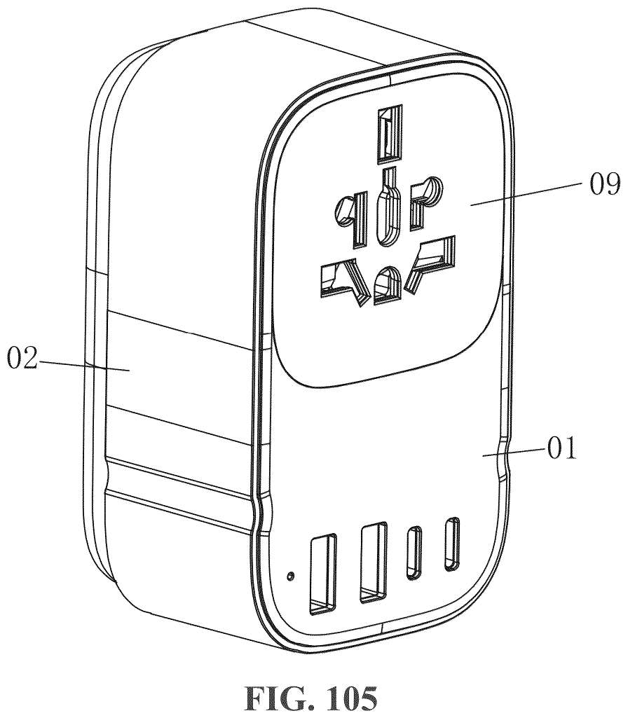

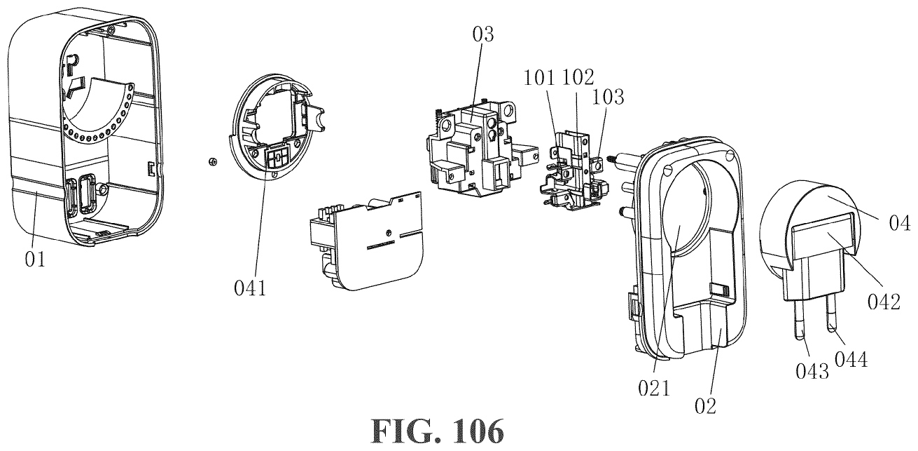

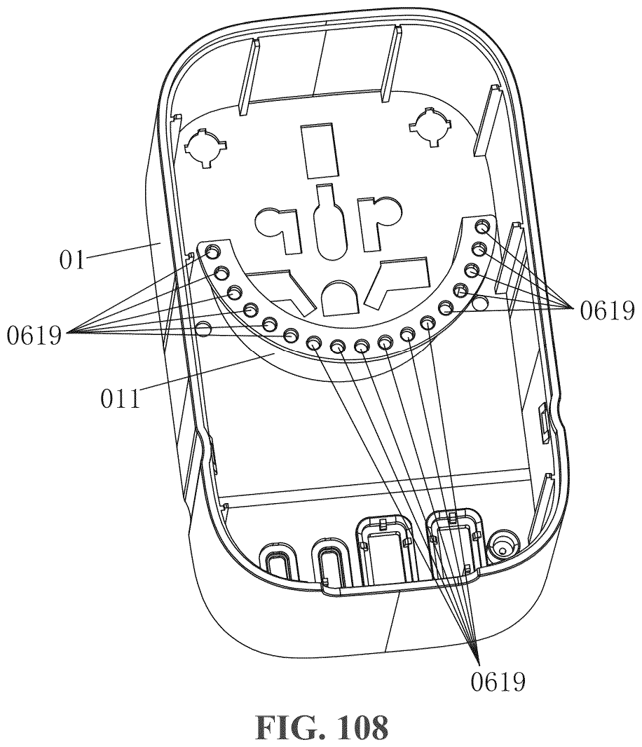

The present invention also includes a pin rotation structure for a power converter. As shown in FIGS. 105 to 109, the pin rotation structure includes an upper cap 01, a lower cap 02 covered to the upper cap 01, a support 03 disposed between the upper cap 01 and the lower cap 02, and a plug assembly 04 rotatably disposed on the lower cap 02. The plug assembly 04 includes a rotary base 041 rotatably disposed on the lower cap 02, and a plug body 042 disposed on the rotary base 041. The upper cap 01 is formed with at least one feel limit portion 06. A rotation avoidance hole 021 for placing the rotary base 041 in rotation is disposed on the lower cap 02. The pin rotation structure further includes a feel limit mechanism 07 disposed on the rotary base 041. The feel limit mechanism 07 and the feel limit portion 06 interfere with each other and are matched with each other when the rotary base 041 rotates.

The specific structure of the plug assembly 04 is the same as that of the first embodiment.

The arrangement of the feel limit mechanism 07 and the feel limit portion 06 is the same as that of the first embodiment.

The specific structure and arrangement of the feel limit portion 06 are the same as those in the first embodiment.

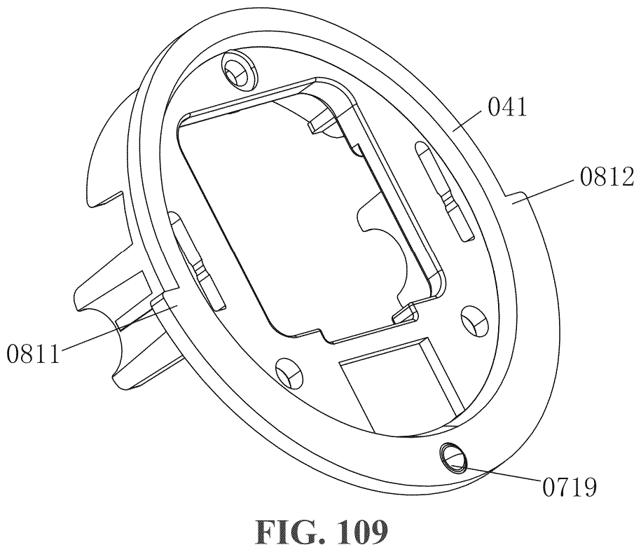

In order to prevent the rotary base 041 from rotating excessively, as shown in FIG. 109, the present pin rotation structure further includes a rotation limit assembly 08 disposed between the upper cap 01 and the lower cap 02. The rotation limit assembly 08 includes a rotation limit step 081 and a rotation limit block (not shown in the figure). The rotation restricting step 081 is disposed on the outer edge of the rotary base 041. The rotation limit block is disposed at the edge of the rotation avoidance hole 021. After the rotation limit step 081 is rotated until pressed against the rotation limit block, the rotation limit block prevents the rotation limit step 081 from continuing to rotate, so as to prevent the plug assembly 04 disposed on the rotary base 041 from over-rotating, resulting in the problem of knotting or breaking of the internal connection structure, etc., thus ensuring the safety of the present pin rotation structure.

With regard to the specific structure of the rotation limit step 081, as shown in FIG. 109, the rotation limit step 081 includes a first rotation limit step 0811 and/or a second rotation limit step 0812 respectively disposed on the rotary base 041, and the symmetrically provided structure thereof is more consistent with the structure of a circular rotary base 041, so that the rotary base 041 can be limited during rotation regardless of whether the first rotation limit step 0811 or the second rotation limit step 0812 thereof is pressed against the rotation limit block. Therefore, the rotational stroke of the plug assembly 04 is better limited, preventing the problem that the internal connection structure is knotted or broken due to the excessive rotation of the plug assembly 04 disposed on the rotary base 041. This guarantees the safety of the pin rotary structure.

The specific structural arrangement of the plug body 042 is the same as that of the first embodiment.

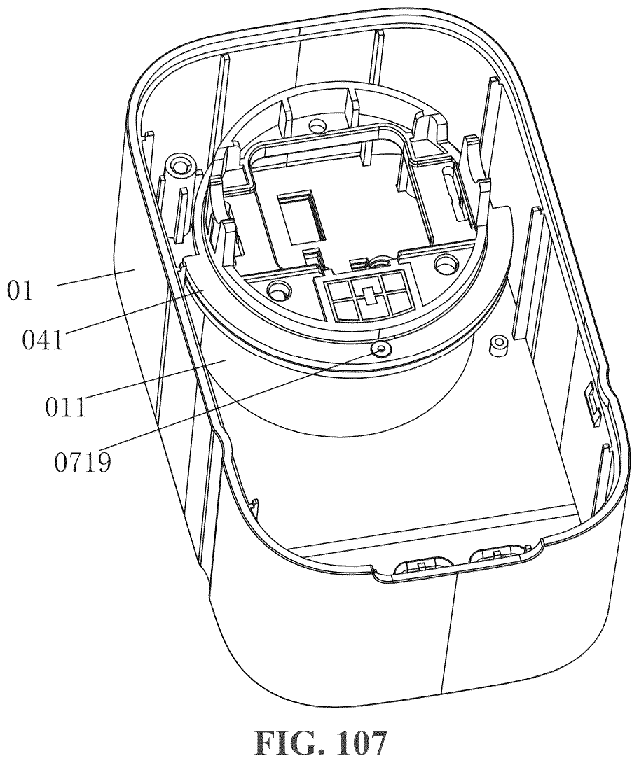

With regard to the specific manner in which the feel limit mechanism 07 and the feel limit portion 06 interfere with each other and are matched with each other, as shown in FIGS. 107 to 109, a nineteenth boss 011 protruding towards the direction of the rotary base 041 and matched with the rotary base 041 is formed in the upper cap 01. The feel limit portion 06 includes a plurality of nineteenth feel limit portions 0619 arranged on one end of the nineteenth boss 011 towards the rotary base 041. The feel limit mechanism 07 includes a nineteenth feel limit block 0719 disposed on the rotary base 041 and protruding towards the nineteenth feel limit portion 0619. The nineteenth feel limit block 0719 and the nineteenth feel limit portion 0619 interfere with each other and are matched with each other when the rotary base 041 rotates. The nineteenth feel limit block 0719 is an elastic member. When in use, the top end of the nineteenth feel limit block 0719 is pressed against the nineteenth boss 011. When the nineteenth feel limit block 0719 on which the rotary base 041 is rotated is directly opposite to the nineteenth feel limit portion 0619, the nineteenth feel limit block 0719 correspondingly extends into the nineteenth feel limit portion 0619, so as to generate a different hand feeling from pressing against a non-recessed part of the nineteenth boss 011, and a sense of detent is generated between the two different hand feelings, so as to improve a user's good use feel and improve the use experience of the power converter. In addition, it is prompted that the user has rotated to a specific position, so as to facilitate the user to grasp the rotation condition of the plug assembly 04, and it is also feasible to limit the rotary base 041 and stop at this position without external force, so as to facilitate the user to use it.

### Twenty-Sixth Embodiment

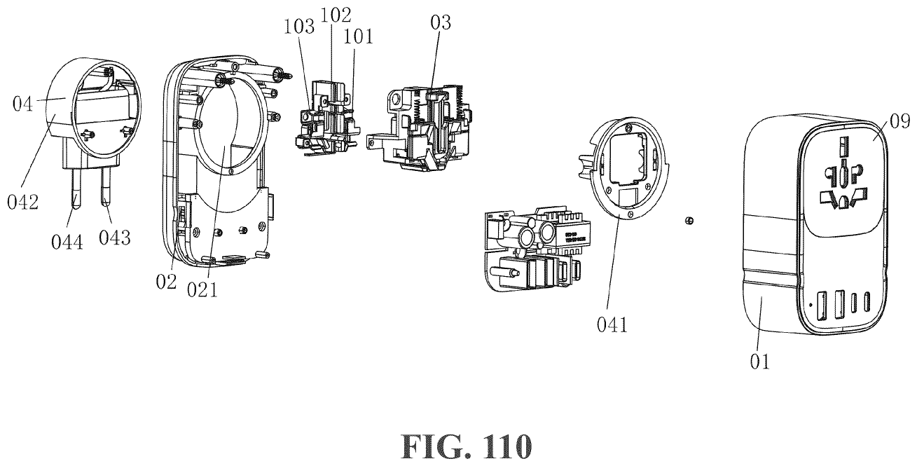

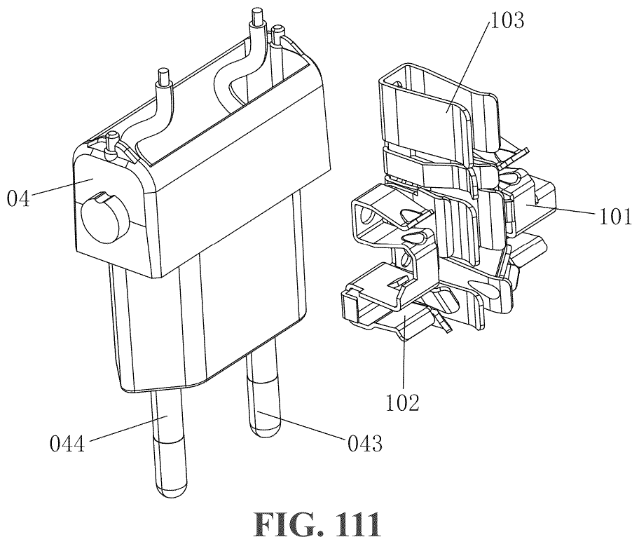

The present invention also includes a power converter, as shown in FIGS. 105, 106 and 110-111, including the pin rotation structure in the above-mentioned twenty-fifth embodiment, a socket panel 09 disposed on an upper cap 01, and a socket assembly 10 disposed between the upper cap 01 and the lower cap 02. The socket assembly 10 includes a socket live wire conductive clip 101 disposed on a support 03 and matched with the socket panel 09, and a socket neutral wire conductive clip 103 disposed on the support 03 and matched with the socket panel 09. The plug assembly 04 further includes a live wire pin 043 disposed between the upper cap 01 and the lower cap 02, and a neutral wire pin 044 disposed between the upper cap 01 and the lower cap 02. The socket neutral wire conductive clip 103 and the neutral wire pin 044 are electrically connected via a flexible neutral wire connecting line 11. The socket live wire conductive clip 101 and the live wire pin 043 are electrically connected via a flexible live wire connecting line 12. By providing the connection line between the above-mentioned two as a flexible conductive line structure, so as to be more matched with the rotating structure of the plug assembly 04, the plug assembly 04 can be rotated while ensuring a smooth degree of conduction, so as to facilitate the cooperation between various components.

Preferably, the specific structure of the socket assembly 10 is the same as that of Embodiment 22.

The specific structural arrangement of the socket panel 09 is the same as that of the third embodiment.

### Twenty-Seventh Embodiment

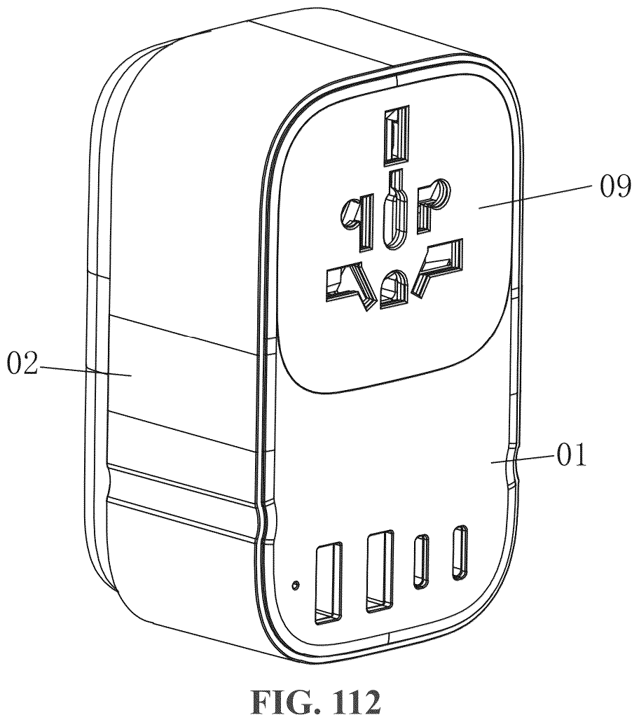

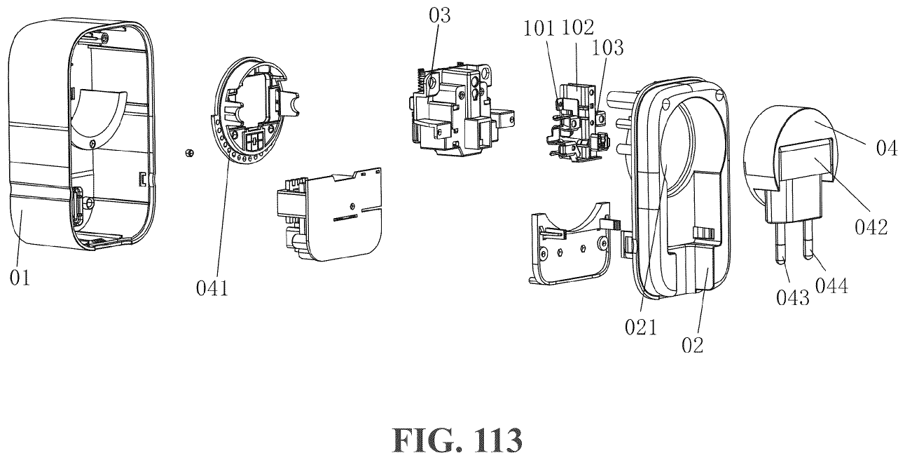

The present invention also includes a pin rotation structure for a power converter. As shown in FIGS. 112 to 116, the pin rotation structure includes an upper cap 01, a lower cap 02 covered to the upper cap 01, a support 03 disposed between the upper cap 01 and the lower cap 02, and a plug assembly 04 rotatably disposed on the lower cap 02. The plug assembly 04 includes a rotary base 041 rotatably disposed on the lower cap 02, and a plug body 042 disposed on the rotary base 041. The rotary base 041 is formed with at least one feel limit portion 06. A rotation avoidance hole 021 for placing the rotary base 041 in rotation is disposed on the lower cap 02. The pin rotation structure further includes a feel limit mechanism 07 disposed on the upper cap 01. The feel limit mechanism 07 and the feel limit portion 06 interfere with each other and are matched with each other when the rotary base 041 rotates.

The specific structure of the plug assembly 04 is the same as that of the first embodiment.

The arrangement of the feel limit mechanism 07 and the feel limit portion 06 is the same as that of the first embodiment.

The specific structure and arrangement of the feel limit portion 06 are the same as those in the first embodiment.

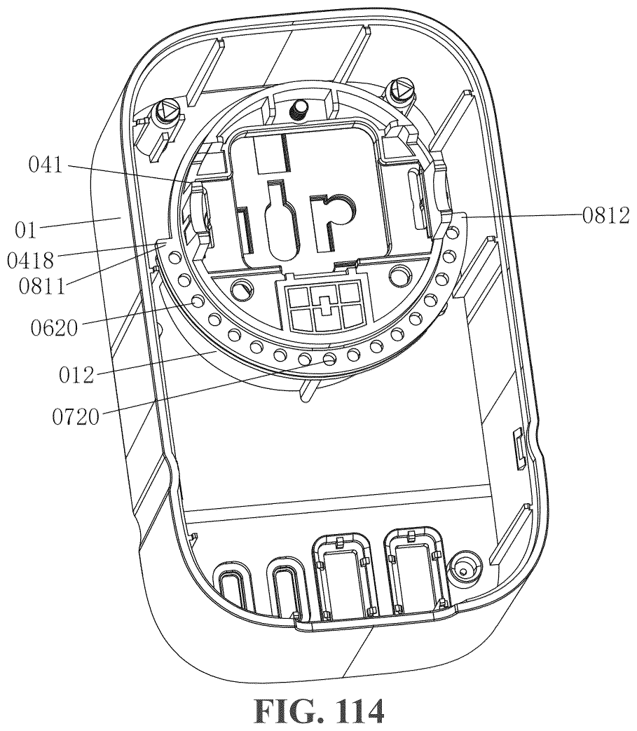

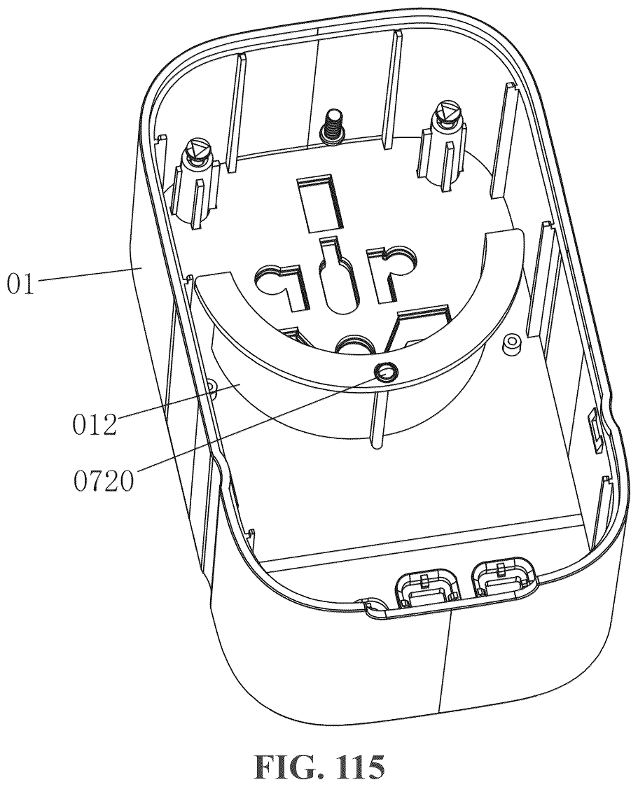

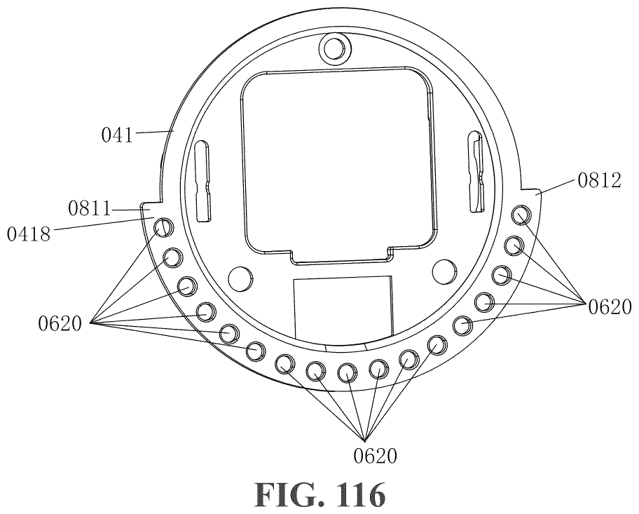

In order to prevent the rotary base 041 from rotating excessively, as shown in FIGS. 114 and 116, the present pin rotation structure further includes a rotation limit assembly 08 disposed between the upper cap 01 and the lower cap 02. The rotation limit assembly 08 includes a rotation limit step 081 and a rotation limit block (not shown in the figure). The rotation restricting step 081 is disposed on the outer edge of the rotary base 041. The rotation limit block is disposed at the edge of the rotation avoidance hole 021. After the rotation limit step 081 is rotated until pressed against the rotation limit block, the rotation limit block prevents the rotation limit step 081 from continuing to rotate, so as to prevent the plug assembly 04 disposed on the rotary base 041 from over-rotating, resulting in the problem of knotting or breaking of the internal connection structure, etc., thus ensuring the safety of the present pin rotation structure.

With regard to the specific structure of the rotation limit step 081, as shown in FIGS. 114 and 116, the rotation limit step 081 includes a first rotation limit step 0811 and/or a second rotation limit step 0812 respectively disposed on the rotary base 041, and the symmetrically provided structure thereof is more consistent with the structure of a circular rotary base 041, so that the rotary base 041 can be limited during rotation regardless of whether the first rotation limit step 0811 or the second rotation limit step 0812 thereof is pressed against the rotation limit block. Therefore, the rotational stroke of the plug assembly 04 is better limited, preventing the problem that the internal connection structure is knotted or broken due to the excessive rotation of the plug assembly 04 disposed on the rotary base 041. This guarantees the safety of the pin rotary structure.

The specific structural arrangement of the plug body 042 is the same as that of the first embodiment.

With regard to the specific manner in which the feel limit mechanism 07 and the feel limit portion 06 interfere with each other and are matched with each other, as shown in FIGS. 114 and 116, a twentieth step 0418 is disposed on the outer periphery of the rotary base 041 in an upper ring. The feel limit portion 06 includes a plurality of twentieth feel limit portions 0620 disposed on the circular ring surface of the twentieth step 0418 facing towards the direction of the upper cap 01. A twentieth boss 012 protruding towards the direction of the rotary base 041 is formed on the upper cap 01. The feel limit mechanism 07 includes a twentieth feel limit block 0720 which is disposed on the twentieth boss 012 and protrudes towards the twentieth feel limit portion 0620. The twentieth feel limit block 0720 and the twentieth feel limit portion 0620 interfere with each other and are matched with each other when the rotary base 041 rotates. The twentieth feel limit block 0720 is an elastic member. When in use, the twentieth feel limit block 0720 is pressed against the twentieth boss 012. When the twentieth feel limit portion 0620 on which the rotary base 041 is rotated is directly opposite to the twentieth feel limit block 0720, the twentieth feel limit block 0720 correspondingly extends into the twentieth feel limit portion 0620, so as to generate a different tactile sensation from that of pressing against the non-recessed part of the twentieth boss 012, and a sense of detent is generated between the two different hand feelings, so as to improve a user's good use feel and improve the use experience of the power converter. In addition, it is prompted that the user has rotated to a specific position, so as to facilitate the user to grasp the rotation condition of the plug assembly 04, and it is also feasible to limit the rotary base 041 and stop at this position without external force, so as to facilitate the user to use it.

### Twenty-Eighth Embodiment

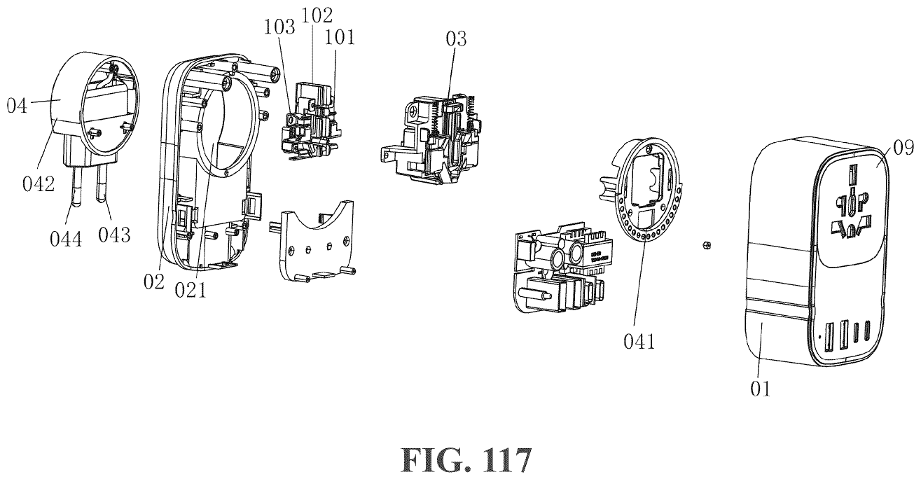

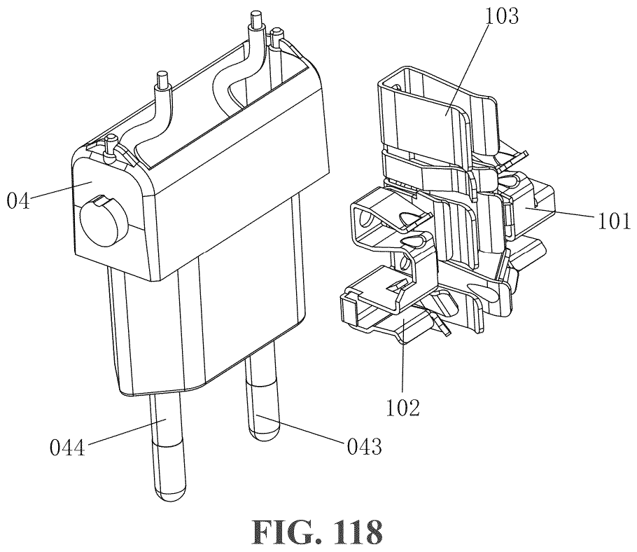

The present invention also includes a power converter, as shown in FIGS. 112 and 113 and FIGS. 117 and 118, including the pin rotation structure in the above-mentioned twenty-seventh embodiments, a socket panel 09 disposed on an upper cap 01, and a socket assembly 10 disposed between the upper cap 01 and the lower cap 02. The socket assembly 10 includes a socket live wire conductive clip 101 disposed on a support 03 and matched with the socket panel 09, and a socket neutral wire conductive clip 103 disposed on the support 03 and matched with the socket panel 09. The plug assembly 04 further includes a live wire pin 043 disposed between the upper cap 01 and the lower cap 02, and a neutral wire pin 044 disposed between the upper cap 01 and the lower cap 02. The socket neutral wire conductive clip 103 and the neutral wire pin 044 are electrically connected via a flexible neutral wire connecting line 11. The socket live wire conductive clip 101 and the live wire pin 043 are electrically connected via a flexible live wire connecting line 12. By providing the connection line between the above-mentioned two as a flexible conductive line structure, so as to be more matched with the rotating structure of the plug assembly 04, the plug assembly 04 can be rotated while ensuring a smooth degree of conduction, so as to facilitate the cooperation between various components.

Preferably, the specific structure of the socket assembly 10 is the same as that of Embodiment 22.

The specific structural arrangement of the socket panel 09 is the same as that of the third embodiment.

It should be noted that the pin rotation structure for the power converter and the power converter disclosed in the present invention are improved on the specific structure, but are not the innovative points of the present invention for the specific control mode. With regard to plugs, pins, springs, flexible wires and other components involved in the present invention, they can be common standard components or components known to a person skilled in the art, and the structure, principle and control method thereof are all known to a person skilled in the art by technical manuals or conventional experimental methods.

The above-mentioned features are merely preferred embodiments of the present invention and do not limit the technical scope of the present invention. Therefore, other structures obtained by adopting the same or similar technical features as the above-mentioned embodiments of the present invention are all within the scope of protection of the present invention.

1. A pin rotation structure for a power converter, comprising
an upper cap,
a lower cap covered to the upper cap, and
a support disposed between the upper cap and the lower cap,
wherein the pin rotation structure further comprises a plug assembly rotatably disposed on the lower cap, wherein the plug assembly comprises a rotary base rotatably disposed on the lower cap, and a plug body disposed on the rotary base; at least one feel limit portion is formed on the rotary base; a rotation avoidance hole for placing the rotary base in rotation is disposed on the lower cap; wherein the pin rotation structure further comprises a feel limit mechanism disposed on the support; and the feel limit mechanism and the at least one feel limit portion interfere with each other and are matched with each other when the rotary base rotates.

2. The pin rotation structure for the power converter according to claim 1, wherein the at least one feel limit portion is a groove; and the feel limit mechanism is an elastic limit bump matched with the groove.

3. (canceled)

4. The pin rotation structure for the power converter according to claim 1, further comprising a rotation limit assembly disposed between the upper cap and the lower cap, wherein the rotation limit assembly comprises a rotation limit step and a rotation limit block; the rotation limit step is provided at an outer edge of the rotary base; the rotation limit block is disposed at an edge of the rotation avoidance hole; and after the rotation limit step rotates to press against the rotation limit block, the rotation limit block prevents the rotation limit step from continuing to rotate.

5. The pin rotation structure for the power converter according to claim 4, wherein the rotation limit step comprises at least one of a first rotation limit step or a second rotation limit step symmetrically disposed on the rotary base.

6. The pin rotation structure for the power converter according to claim 1, wherein the plug body is any one of a European standard plug, a United Kingdom standard plug, an Australian standard plug, an American standard plug, an Italian standard plug, a Swiss standard plug or an Indian standard plug.

7. The pin rotation structure for the power converter according to claim 1, wherein; a first step protrudes from the rotary base in a direction towards the support; a first fixing portion with an opening facing in the direction of the first step is disposed on the support; the feel limit mechanism comprises a first feel limit block disposed in the first fixing portion and having a top end extending in a direction of an inner circumference of the first step; the at least one feel limit portion comprises at least one first feel limit portion formed on the inner circumference of the first step and matched with the first feel limit block; wherein the first feel limit block is an elastic member, and the first feel limit block and the at least one first feel limit portion interfere with each other and are matched with each other when the rotary base rotates.

8-29. (canceled)

30. The pin rotation structure for the power converter according to claim 7, wherein the first feel limit block is an elastic limit bump.

31. The pin rotation structure for the power converter according to claim 1, wherein a first step protrudes from the rotary base in a direction towards the support; a first fixing portion is disposed on the support and opens in the direction towards the first step; the feel limit mechanism comprises a first feel limit block which is disposed in the first fixing portion and has a top end extending in an inner circumferential direction of the first step; the at least one feel limit portion comprises at least one first feel limit portion formed on an inner circumference of the first step and matched with the first feel limit block; and the first feel limit block and the at least one first feel limit portion interfere with each other and are matched with each other when the rotary base rotates.

32. A power converter, comprising the pin rotation structure according to claim 1.
